(19) United States
(12) Patent Application Publication
(10) Pub. No.: US 2024/0052871 A1
(43) Pub. Date: Feb. 15, 2024

(54) FIXING STRUCTURE, FIXING MEMBER, AND ASSEMBLY METHOD

(71) Applicant: DAIWA KASEI INDUSTRY CO.,LTD., Okazaki-shi (JP)

(72) Inventors: Makoto KATO, Okazaki-shi (JP); Atsushi TOKUNAGA, Okazaki-shi (JP)

(21) Appl. No.: 18/366,262

(22) Filed: Aug. 7, 2023

(30) Foreign Application Priority Data
Aug. 10, 2022 (JP) 2022-128486
Jul. 31, 2023 (JP) 2023-124368

(51) Int. Cl. F16B 21/08

(52) U.S. Cl. CPC F16B 21/086

(57) ABSTRACT

Provided is a fixing member that can fix a base and a fixing target member such that the fixation between the base and the fixing target member can be released and formation of a gap between the base and the fixing target member is suppressed. The fixing member includes a shaft portion and an elastic piece formed integrally with the shaft portion. The shaft portion is provided so as to be movable between an advance position at which the distal end portion thereof is engageable with a hole of the fixing target member and a retraction position at which the engagement is released, in an assembled state to the base. The elastic piece biases the shaft portion to the advance position, and is elastically deformable so as to permit movement of the shaft portion to the retraction position.

### CROSS REFERENCE TO RELATED APPLICATIONS

This application claims priority on Patent Application No. 2022-128486 filed in JAPAN on Aug. 10, 2022 and Patent Application No. 2023-124368 filed in JAPAN on Jul. 31, 2023. The entire contents of these Japanese Patent Applications are hereby incorporated by reference.

### BACKGROUND OF THE INVENTION

### Field of the Invention

This disclosure relates to a fixing member for fixing a fixing target member to a base, and specifically relates to a fixing member capable of releasing this fixation.

### Description of Related Art

For example, there is a proposal in Japanese Patent No. 4634816 as a fixing member that fixes a base and a fixing target member and is capable of releasing this fixation. Japanese Patent No. 4634816 discloses, as a fixing member, a connector that fixes a to-be-retrofitted equipment component (tray or the like) as a fixing target member to the back surface of a vehicle seat or the like as a base. The connector of Japanese Patent No. 4634816 includes a male member that is mounted on the to-be-retrofitted equipment component, and a female member that is mounted on the back surface of the seat or the like and into which the male member is inserted. The male member has a shaft body, leg pieces extending obliquely from both side surfaces of the shaft body, and pushing pieces projecting from distal end portions of the leg pieces in a direction orthogonal to the shaft body. In a state where the male member is inserted into the female member, projecting portions formed on the leg pieces of the male member are inserted into slide holes formed in the female member, whereby the equipment component (fixing target member), on which the male member is mounted, and the back surface of the seat or the like (base), on which the female member is mounted, are fixed to each other. From this state, when the pushing pieces are pushed in a direction of diameter reduction, the leg pieces become elastically deformed in the direction of diameter reduction. Accordingly, the projecting portions of the leg pieces are disengaged from the slide holes of the female member, thereby releasing the fixation between the female member and the male member, that is, the fixation between the back surface of the seat or the like (base) and the to-be-retrofitted equipment component (fixing target member).

In the structure of Japanese Patent No. 4634816, in a state where the base and the fixing target member are fixed to each other, the pushing pieces of the male member and a coupling portion, of the male member, coupled to the fixing target member are exposed between the base and the fixing target member, whereby a gap is formed between the base and the fixing target member due to the pushing pieces and the coupling portion.

In view of the above circumstances, a first object of this disclosure is to provide a fixing structure, a fixing member, or an assembly method that allows a base and a fixing target member to be fixed to each other such that formation of a gap between the base and the fixing target member is suppressed. In addition, a second object of this disclosure is to provide a fixing structure, a fixing member, or an assembly method that allows a fixing member to be easily assembled to a base or a fixing target member.

### SUMMARY OF THE INVENTION

A fixing structure of this disclosure includes:
a base;
a fixing target member fitted to the base; and
a fixing member, wherein
one of the base and the fixing target member has a fitting hole, and another of the base and the fixing target member has a portion fitted into the fitting hole,
the one, of the base and the fixing target member, having the fitting hole is defined as an assembly counterpart member, and the fixing member is assembled to the assembly counterpart member,
the fixing member includes
   a prevention portion configured to project into the fitting hole in a fitting perpendicular direction which is a direction perpendicular to a fitting direction of the base and the fixing target member, to prevent the fixing target member from being pulled out from the base, and
   an operation portion which is formed integrally with the prevention portion and on which an operation of moving the prevention portion from a projection position at which the prevention portion projects into the fitting hole to a withdrawn position at which the prevention portion is withdrawn from the fitting hole is performed, an operating direction of the operation being defined as the fitting perpendicular direction,
the other, of the base and the fixing target member, which is not the assembly counterpart member has a recess into which the prevention portion at the projection position is fitted, and
the fixing structure includes an elastic deformation portion formed integrally with the fixing member or the assembly counterpart member, and configured to become elastically deformed so as to permit movement of the fixing member to the withdrawn position when the operation is performed, and to return the fixing member to the projection position by a repulsive force of the elastic deformation of the elastic deformation portion when the operation is released.

A fixing member of this disclosure is a fixing member for fixing a fixing target member to a base, wherein
one of the base and the fixing target member has a fitting hole, and another of the base and the fixing target member has a portion fitted into the fitting hole,
the one, of the base and the fixing target member, having the fitting hole is defined as an assembly counterpart member, and the fixing member is assembled to the assembly counterpart member, and
the fixing member includes
   a prevention portion configured to project into the fitting hole in a fitting perpendicular direction which is a direction perpendicular to a fitting direction of the base and the fixing target member, and be fitted into a recess formed on the other, of the base and the fixing target member, which is not the assembly counterpart member, to prevent the fixing target member from being pulled out from the base,
   an operation portion which is formed integrally with the prevention portion and on which an operation of moving the prevention portion from a projection position at which the prevention portion projects into the fitting hole to a withdrawn position at which the prevention portion is withdrawn from the fitting hole is performed, an operating direction of the operation being defined as the fitting perpendicular direction, and
   an elastic deformation portion formed integrally with the prevention portion and the operation portion, and configured to become elastically deformed so as to permit movement of the prevention portion to the withdrawn position when the operation is performed, and to return the prevention portion to the projection position by a repulsive force of the elastic deformation of the elastic deformation portion when the operation is released.

In the fixing structure or the fixing member of this disclosure, in a state where the fixing member is assembled to the assembly counterpart member, the projecting direction of the prevention portion into the fitting hole and the operating direction of the operation portion are directed in the fitting perpendicular direction which is the direction perpendicular the fitting direction of the base and the fixing target member. Since the projecting direction of the prevention portion and the operating direction of the operation portion are directed in a direction different from (perpendicular to) the fitting direction of the base and the assembly counterpart member, a portion of the fixing member can be inhibited from being interposed between the base and the fixing target member in the fitting direction. Accordingly, formation of a gap between the base and the fixing target member in the fitting direction can be suppressed.

Also, an assembly method of this disclosure is a method for assembling the fixing member to the assembly counterpart member in the fixing structure of this disclosure, wherein
the fixing member has a shaft portion extending along the operating direction,
the prevention portion is provided at one end in an axial direction of the shaft portion, and the operation portion is provided at another end in the axial direction of the shaft portion,
the operating direction is defined as a direction in which the operation portion is pulled,
the shaft portion has, on a distal end side thereof, a distal-end-side projection portion projecting laterally,
the prevention portion is provided on the distal end side with respect to the distal-end-side projection portion of the shaft portion,
a hole into which the distal end side with respect to the distal-end-side projection portion of the shaft portion is fitted is formed in the assembly counterpart member,
the hole is formed such that the distal end side with respect to the distal-end-side projection portion of the shaft portion can be inserted into the hole in a direction oblique to the fitting perpendicular direction and the distal-end-side projection portion cannot be inserted into the hole, and
the method includes:
   a positioning step of positioning the distal-end-side projection portion of the shaft portion at a portion surrounding the hole of the assembly counterpart member, while inserting the distal end side with respect to the distal-end-side projection portion of the shaft portion into the hole in a direction oblique to the fitting perpendicular direction; and
   a rotation step of rotating the fixing member such that the axial direction of the shaft portion is the same as the fitting perpendicular direction, in a state where the distal-end-side projection portion is positioned at the portion surrounding the hole.

According to this, since the distal-end-side projection portion is positioned at the portion of the assembly counterpart member when the fixing member is rotationally assembled to the assembly counterpart member, the fixing member can be easily rotated. Accordingly, the fixing member can be easily assembled to the assembly counterpart member.

Also, another assembly method of this disclosure is a method for assembling the fixing member to the assembly counterpart member in the fixing structure of this disclosure, wherein
the fixing member has a body portion forming a cavity between the prevention portion and the operation portion,
the prevention portion projects from the body portion toward the cavity side,
the fixing member is assembled to the assembly counterpart member such that a hole-forming portion, forming the fitting hole, of the assembly counterpart member is fitted into the cavity,
the operating direction is defined as a direction in which the operation portion is pushed,
the assembly counterpart member has an engagement projection configured to engage the fixing member in an assembled state to prevent the fixing member from being detached from the assembly counterpart member,
a recess is formed on the body portion, and
the method includes
   assembling the fixing member so as to rotate the fixing member in the fitting perpendicular direction while inserting the fixing member into the assembly counterpart member in a direction oblique to the fitting perpendicular direction, and fitting the engagement projection into the recess of the body portion during the rotation to cause the recess and the engagement projection to guide the rotation.

According to this, since the recess formed in the fixing member is fitted to the engagement projection which is a functional portion formed in the assembly counterpart member and rotation of the fixing member is guided by the recess and the engagement projection when the fixing member is rotationally assembled to the assembly counterpart member, the fixing member can be easily assembled to the assembly counterpart member. In addition, since the engagement projection has both an engagement function of preventing detachment of the assembled fixing member and a guide function of guiding assembly, the configuration of the assembly counterpart member can be simplified as compared to the case where a portion having an engagement function and a portion having a guide function are separately provided.

### BRIEF DESCRIPTION OF THE DRAWINGS

FIG. 1 is a perspective view of a fixing structure of a first embodiment;

FIG. 2 is a cross-sectional view of the fixing structure of the first embodiment, taken along a line II-II in FIG. 1, in a state where a fixing member is at an advance position;

FIG. 3 is a cross-sectional view of the fixing structure of the first embodiment, taken along a line III-III in FIG. 1, as viewed in a visual line direction rotated by 90° about an axis from the visual line direction of FIG. 2;

FIG. 4 is a cross-sectional view of the fixing structure of the first embodiment, as viewed in the same direction as in FIG. 2, in a state where the fixing member is at a retraction position;

FIG. 5 is a perspective view of a base and the fixing member mounted thereon of the first embodiment as viewed from the back side of the base;

FIG. 6 is a perspective view of the fixing member of the first embodiment;

FIG. 7 is a side view (left side view) of the fixing member of the first embodiment;

FIG. 8 is a front view of the fixing member of the first embodiment as viewed in a visual line direction rotated by 90° about the axis from the visual line direction of FIG. 7;

FIG. 9 is a bottom view of the base, including a plan view of a near-side mounting hole formed in the base of the first embodiment and a connection hole connected to the near-side mounting hole in an in-plane direction;

FIG. 10 illustrates a state where the fixing member is being assembled to the base in an oblique direction in the first embodiment;

FIG. 11 is a perspective view of a fixing structure including a closing member that closes a front surface opening of the base, as another example of a fixing target member;

FIG. 12 illustrates a fixing structure according to a second embodiment;

FIG. 13 is a diagram of a fixing structure of a comparative example;

FIG. 14 is an enlarged view of a part A in FIG. 13;

FIG. 15 is a perspective view of a fixing structure of a third embodiment;

FIG. 16 is a view of the fixing structure of the third embodiment, as viewed from the back side of a base, showing a state where a fixing member is located at a position at which a fixing target member is fixed;

FIG. 17 is a cross-sectional view of the fixing structure of the third embodiment taken along a line XVII-XVII in FIG. 16;

FIG. 18 is a view of the fixing structure of the third embodiment, as viewed from the back side of the base, showing a state where the fixing member is located at a position at which fixation of the fixing target member is released;

FIG. 19 is a cross-sectional view of the fixing structure of the third embodiment, taken along a line XIX-XIX in FIG. 18, showing a state where the fixing target member is being pulled out from the base;

FIG. 20 is a plan view of the fixing member of the third embodiment;

FIG. 21 is a right side view of the fixing member of the third embodiment;

FIG. 22 is a cross-sectional view of the fixing member of the third embodiment taken along a line XXII-XXII in FIG. 20;

FIG. 23 is a cross-sectional view of the fixing member of the third embodiment taken along a line XXIII-XXIII in FIG. 20;

FIG. 24 is a perspective view of the base of the third embodiment as viewed from the back side;

FIG. 25 is a plan view (back view) of the base of the third embodiment as viewed from the back side;

FIG. 26 is a cross-sectional view of the base of the third embodiment taken along a line XXVI-XXVI in FIG. 25;

FIG. 27 is a cross-sectional view of the base of the third embodiment taken along a line XXVII-XXVII in FIG. 25;

FIG. 28 is an enlarged cross-sectional view of the base of the third embodiment taken along a line XXVIII-XXVIII in FIG. 25;

FIG. 29 is a cross-sectional view of the base of the third embodiment taken along a line XXIX-XXIX in FIG. 25;

FIG. 30 illustrates a state where the fixing member is being assembled to the base in the third embodiment, and illustrates a state where the fixing member is being inserted into the base in an oblique direction;

FIG. 31 illustrates a state where the fixing member is being assembled to the base in the third embodiment, illustrates a state where the fixing member is being rotated toward a housing space of the base from FIG. 30, and illustrates a state where a second projecting portion of the fixing member has interfered with a portion of the base and has bent;

FIG. 32 illustrates a state where the fixing member is being assembled to the base in the third embodiment, illustrates a state where the fixing member is being further rotated from FIG. 31, and illustrates a state where the second projecting portion of the fixing member has returned to the original state;

FIG. 33 illustrates a state where the fixing member is being reversely assembled to the base in the third embodiment;

FIG. 34 is a view of a fixing structure of a fourth embodiment as viewed from the back side of a base;

FIG. 35 is a view of a fixing structure of a fifth embodiment as viewed from the back side of a base;

FIG. 36 is a view of a fixing structure of a sixth embodiment as viewed from the back side of a base;

FIG. 37 is a cross-sectional view of the fixing structure of the sixth embodiment taken along a line XXXVII-XXXVII in FIG. 36;

FIG. 38 is a front view of a fixing member of the sixth embodiment;

FIG. 39 is a back view of the fixing member of the sixth embodiment;

FIG. 40 is a right side view of the fixing member of the sixth embodiment;

FIG. 41 is a left side view of the fixing member of the sixth embodiment;

FIG. 42 is a top view (plan view) of the fixing member of the sixth embodiment;

FIG. 43 is a bottom view of the fixing member of the sixth embodiment;

FIG. 44 is an enlarged view of a part A in FIG. 36, showing a state where an operation portion is not operated;

FIG. 45 is an enlarged view of the same part as the part A in FIG. 36, showing a state where the operation portion is operated;

FIG. 46 illustrates a first example (FIG. 46A) and a second example (FIG. 46B) in which a base and a support member supporting the base are integrally formed;

FIG. 47 is a first perspective view (FIG. 47A) and a second perspective view (FIG. 47B) of a fixing member of a seventh embodiment;

FIG. 48 is a front view (FIG. 48A), a back view (FIG. 48B), a right side view (FIG. 48C), a plan view (top view) (FIG. 48D), and a bottom view (FIG. 48E) of the fixing member of the seventh embodiment;

FIG. 49 illustrates a first modification (FIG. 49A), a second modification (FIG. 49B), a third modification (FIG. 49C), a fourth modification (FIG. 49D), a fifth modification (FIG. 49E), and a sixth modification (FIG. 49F) of a crisp feeling-giving structure in a push-operated type (push type) fixing structure;

FIG. 50 illustrates a seventh modification (FIG. 50A) of the crisp feeling-giving structure in the push-operated type fixing structure; a perspective view (FIG. 50B) of a flexural deformation portion formed on a base side in FIG. 50A, an eighth modification (FIG. 50C), a ninth modification (FIG. 50D), a tenth modification (FIG. 50E), and a cross-sectional view (FIG. 50F) taken along a line V-V in FIG. 50E,

FIG. 51 illustrates an eleventh modification of the crisp feeling-giving structure in the push-operated type fixing structure;

FIG. 52 is a cross-sectional view taken along a line LII-LII in FIG. 51;

FIG. 53 illustrates a first modification of a crisp feeling-giving structure in a pull-operated type (pull type) fixing structure;

FIG. 54 is a cross-sectional view taken along a line LIV-LIV in FIG. 53;

FIG. 55 illustrates a second modification of the crisp feeling-giving structure in the pull-operated type fixing structure;

FIG. 56 is a view (plan view) of a flexural deformation portion formed in a counterpart member (base) in FIG. 55, as viewed from the bottom of FIG. 55;

FIG. 57 illustrates a third modification of the crisp feeling-giving structure in the pull-operated type fixing structure;

FIG. 58 illustrates a fourth modification of the crisp feeling-giving structure in the pull-operated type fixing structure; and

FIG. 59 illustrates a twelfth modification of the crisp feeling-giving structure in the push-operated type fixing structure, and is a view of the fixing structure as viewed from the back side (FIG. 59A), a cross-sectional view (FIG. 59B) taken along a line LIX-LIX in FIG. 59A, and an enlarged view (FIG. 59C) of a part B in FIG. 59B.

### DETAILED DESCRIPTION

### First Embodiment

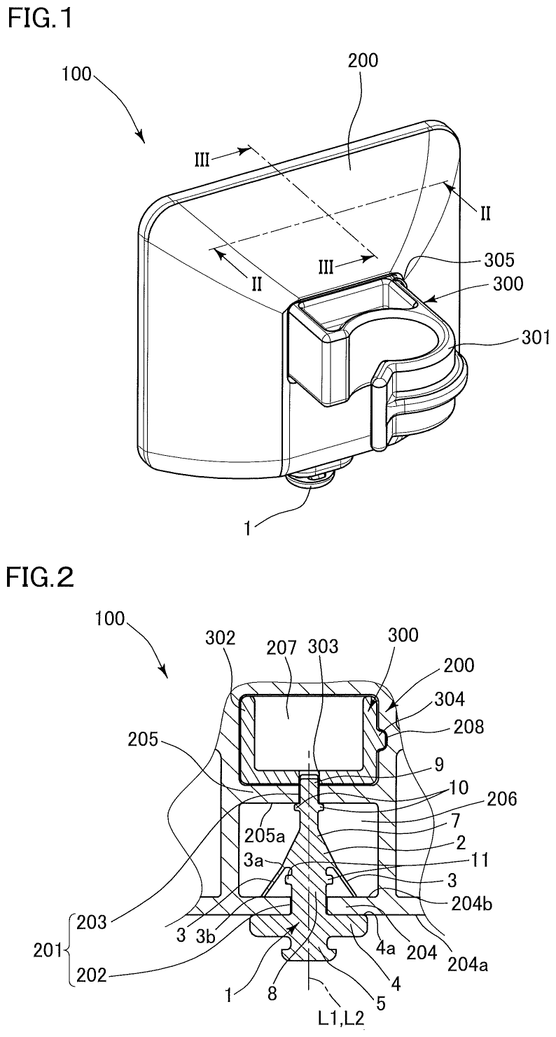

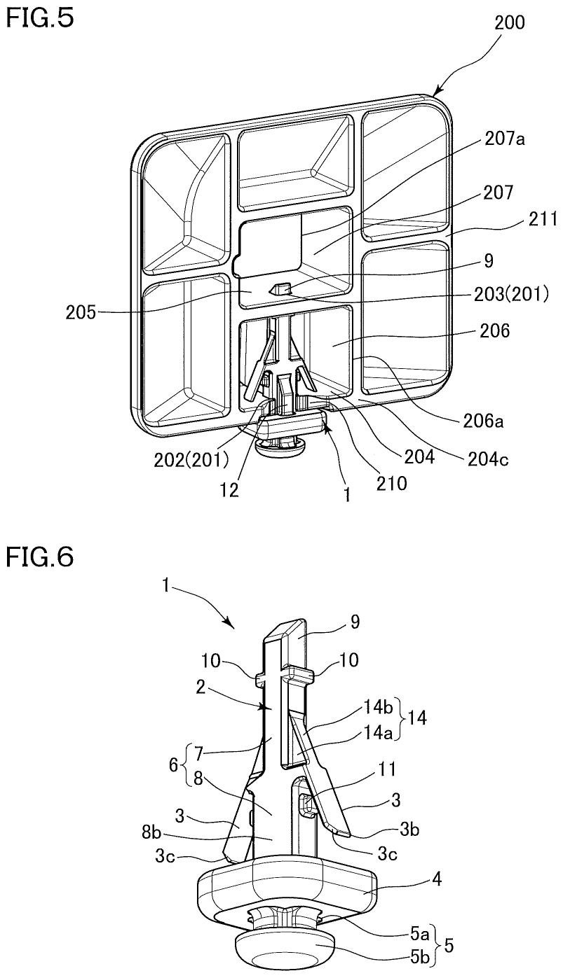

Hereinafter, a first embodiment of this disclosure will be described with reference to the drawings. FIG. 1 to FIG. 4 show a fixing structure 100 for fixing a fixing target member 300 to a base 200. The fixing structure 100 includes the base 200, the fixing target member 300 supported by the base 200, and a fixing member 1 for fixing the base 200 and the fixing target member 300 to each other. The fixing structure 100 is mounted, for example, in a vehicle (e.g., a vehicle cabin), but may be provided at a location other than in a vehicle. First, the fixing member 1 will be described also with reference to FIG. 6 to FIG. 8.

(Configuration of Fixing Member 1)

The fixing member 1 is a resin component formed entirely from a synthetic resin such as polypropylene or polyamide. The fixing member 1 is formed by injection molding, for example. The fixing member 1 is assembled to the base 200 as an assembly counterpart member. Specifically, the fixing member 1 is a component for, when being assembled to the base 200, detachably fixing the fixing target member 300 to the base 200 while maintaining this assembled state. The fixing member 1 includes a shaft portion 2, a pair of elastic pieces 3 formed integrally with the shaft portion 2, a seat portion 4 provided at a proximal end of the shaft portion 2, and a projecting portion 5 provided so as to project from the seat portion 4 toward the side opposite to the shaft portion 2. These portions 2, 3, 4, and 5 are integrally formed from the same resin material.

The shaft portion 2 is provided in a state of being fitted (inserted) into a mounting hole 201, which is formed in the base 200, in an assembled state where the fixing member 1 is assembled to the base 200 (see FIG. 2 to FIG. 4). Specifically, as shown in FIG. 6 to FIG. 8, the shaft portion 2 has a body portion 6 provided so as to rise straight from a seat surface 4a of the seat portion 4. The body portion 6 is a portion that defines a central axis L1 (hereinafter, sometimes referred to simply as axis) of the shaft portion 2, and is provided so as to extend from the seat surface 4a in a direction perpendicular to the seat surface 4a. The body portion 6 includes a first portion 7 forming a portion of the body portion 6 from a distal end portion 9, and a second portion 8 forming the remaining portion of the body portion 6. The second portion 8 forms a portion from the proximal end of the first portion 7 to the seat surface 4a.

The first portion 7 is formed in a shape in which a cross-section thereof perpendicular to the axis L1 is different from that of the second portion 8, specifically, smaller than the cross-section of the second portion 8. The cross-section of the first portion 7 is formed, for example, in a noncircular shape, and is formed in a square shape in this embodiment. The four corners of the square shape are chamfered. The cross-section of the first portion 7 may be a shape other than the square shape (e.g., a rectangular shape, an elliptical shape, etc.).

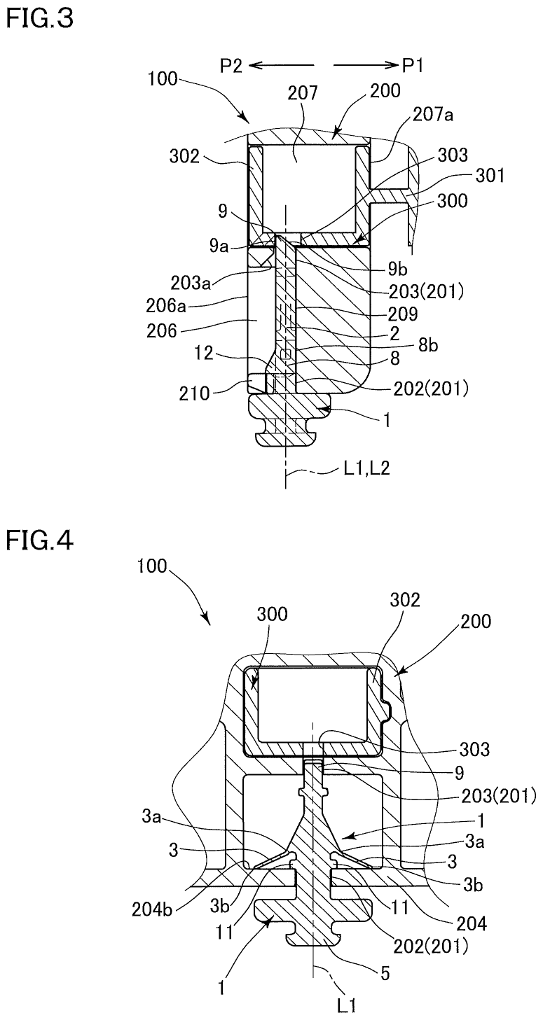

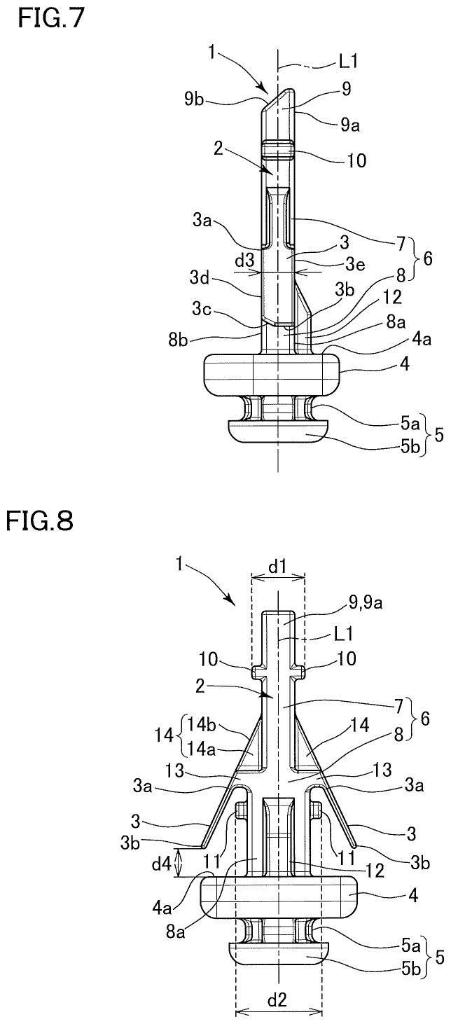

The distal end portion 9 of the first portion 7 serves as a prevention portion that engages the fixing target member 300 to be assembled to the base 200 to prevent movement of the fixing target member 300 in a predetermined direction P1 (specifically, a direction in which the fixing target member 300 is pulled out from the base 200) (see FIG. 3). The distal end portion 9 is located on the axis L1. The distal end portion 9 is also located on a line (same as the axis L1) bisecting the interval between the pair of elastic pieces 3. A portion 9a (see FIG. 3, FIG. 7, and FIG. 8) of the side surface of the distal end portion 9 serves as a restriction surface (prevention portion) that restricts movement of the fixing target member 300 in the predetermined direction P1. The restriction surface 9a is formed as a surface parallel to the axis L1. In other words, the restriction surface 9a is formed as a surface perpendicular to the predetermined direction P1. The restriction surface 9a is provided such that, in a state where the fixing member 1 is assembled to the base 200, the restriction surface 9a faces in an opposite direction P2 (a direction in which the fixing target member 300 is inserted into the base 200) (see FIG. 3) opposite to the predetermined direction P1.

A surface 9b (see FIG. 3 and FIG. 7) of the distal end portion 9 on the side opposite to the restriction surface 9a in the circumferential direction is formed as a surface that permits movement of the fixing target member 300 in the opposite direction P2. Specifically, the surface 9b is formed such that, when a force in the opposite direction P2 is applied to the surface 9b, a force is generated to move the shaft portion 2 in a direction from the distal end side to the proximal end side of the shaft portion 2 (hereinafter, sometimes referred to as retraction direction) in the direction of the axis L1 (hereinafter, sometimes referred to as axial direction). More specifically, the surface 9b is formed as a surface that is inclined with respect to the axis L1 so as to gradually approach the restriction surface 9a as advancing in a direction from the proximal end side to the distal end side of the shaft portion 2 (hereinafter, sometimes referred to as advance direction) in the direction of the axis L1. In this embodiment, the surface 9b is formed as a flat surface inclined with respect to the axis L1, but may be formed in a curved shape (e.g., a spherical shape). The surface 9b is provided such that the surface 9b faces in the direction P1 in a state where the fixing member 1 is assembled to the base 200 (see FIG. 3). The surface 9b corresponds to an insertion permission portion of this disclosure.

A portion (including the distal end portion 9) of the first portion 7 on the distal end side with respect to a distal-end-side projection portion 10 described later is provided in a state of being fitted (inserted) into a far-side mounting hole 203, which is formed in the base 200, in a state where the fixing member 1 is assembled to the base 200 (see FIG. 2).

The second portion 8 of the body portion 6 is provided coaxially with the first portion 7, and is formed in a shape in which the cross-section thereof perpendicular to the axis L1 is larger than that of the first portion 7. The cross-section of the second portion 8 is formed, for example, in a noncircular shape, and is formed in a quadrangular shape having long sides and short sides, that is, a rectangular shape, in this embodiment. The four corners of the rectangular shape are chamfered. The cross-section of the second portion 8 may have a shape other than the quadrangular shape (e.g., a square shape, an elliptical shape, etc.).

The second portion 8 is provided in a state of being inserted into a near-side mounting hole 202, which is formed in the base 200, in a state where the fixing member 1 is assembled to the base 200 (see FIG. 2 and FIG. 3). The diameter of the second portion 8 is set so as to be equal to the diameter of the near-side mounting hole 202 (strictly speaking, slightly smaller than that of the near-side mounting hole 202). In addition, the cross-section, of the second portion 8, perpendicular to the axis L1 is formed in the same shape as the near-side mounting hole 202.

The shaft portion 2 has, on the distal end side thereof, the distal-end-side projection portion 10 which projects laterally (in a direction perpendicular to the axis L1) from the first portion 7 of the body portion 6. The distal-end-side projection portion 10 is provided at a position between the distal end portion 9 (prevention portion) of the body portion 6 and a connection portion of the body portion 6 with the elastic piece 3 (proximal end 3a of the elastic piece 3) among the positions along the axis L1 (axial direction). More specifically, the distal-end-side projection portion 10 is provided at a position between the distal end portion 9 and a triangular portion 14 described later in the axial direction.

As the distal-end-side projection portion 10, a pair of (two) projection portions are provided so as to project from the first portion 7 in directions opposite to each other. The pair of distal-end-side projection portions 10 are formed in a shape that is line-symmetrical with respect to the axis L1. Each distal-end-side projection portion 10 projects from a side surface on the same side as a side surface of the body portion 6 on which the elastic piece 3 and a proximal-end-side projection portion 11 described later are provided. A width d1 between the distal end of one distal-end-side projection portion 10 and the distal end of the other distal-end-side projection portion 10 (in other words, the width, in the direction perpendicular to the axis L1, of the shaft portion 2 at the position of the distal-end-side projection portions 10) (see FIG. 8) is larger than the diameter of the far-side mounting hole 203 of the base 200. That is, the pair of distal-end-side projection portions 10 are provided such that the distal-end-side projection portions 10 cannot be inserted into the far-side mounting hole 203. A portion of the shaft portion 2 on the distal end side with respect to the distal-end-side projection portions 10 is provided such that this portion can be inserted into the far-side mounting hole 203.

Each distal-end-side projection portion 10 serves as an advance pull-out prevention portion that prevents the shaft portion 2 from being pulled out from the base 200 in the advance direction in a state where the fixing member 1 is assembled to the base 200. That is, as shown in FIG. 2, in an assembled state to the base 200, when the distal end portion 9 of the shaft portion 2 is at an advance position at which the distal end portion 9 is engageable with the fixing target member 300, each distal-end-side projection portion 10 comes into contact with a portion 205, of the base 200, which forms the far-side mounting hole 203, thereby restricting further movement of the shaft portion 2 in the advance direction from the advance position. The advance position is a position at which the distal end portion 9 of the shaft portion 2 projects to the outside of the far-side mounting hole 203 (a fitting space 207 of the base 200 in which the fixing target member 300 is fitted) in a state where the fixing member 1 is assembled to the base 200.

Each distal-end-side projection portion 10 also serves as a distal end side positioning portion that positions the portion of the shaft portion 2 on the distal end side with respect to the distal-end-side projection portions 10 to be in a state where this portion is inserted into the far-side mounting hole 203, when the fixing member 1 is assembled to the base 200. Specifically, the fixing member 1 is assembled to the base 200 such that the fixing member 1 is inserted thereinto in a direction oblique to the direction of a center line L2 (see FIG. 2 and FIG. 3) of the mounting holes 202 and 203 of the base 200 (in other words, a fitting perpendicular direction which is a direction perpendicular to the pulling-out direction P1 of the fixing target member 300) and then rotated in the direction of the center line L2. Each distal-end-side projection portion 10 is provided such that the distal-end-side projection portion 10 comes into contact with a portion, surrounding the far-side mounting hole 203, of the base 200 at a position at which the insertion in the oblique direction ends during this assembly and serves as the center of the rotation in a state where the distal-end-side projection portion 10 is positioned at that portion.

As shown in FIG. 6 and FIG. 8, the shaft portion 2 has the proximal-end-side projection portion 11 which projects laterally (in the direction perpendicular to the axis L1) from the second portion 8 of the body portion 6, on the proximal end side of the shaft portion 2 with respect to the distal-end-side projection portion 10. The proximal-end-side projection portion 11 is provided at a position between a proximal end 3a and a distal end 3b of the elastic piece 3 in a natural state where the elastic piece 3 is not elastically deformed, among the positions along the axis L1 (axial direction).

As shown in FIG. 8, as the proximal-end-side projection portion 11, a pair of (two) projection portions are provided so as to project from the second portion 8 in directions opposite to each other. The pair of proximal-end-side projection portions 11 are formed in a shape that is line-symmetrical with respect to the axis L1. Each proximal-end-side projection portion 11 projects from a side surface on the same side as the side surface of the body portion 6 on which the elastic piece 3 and the distal-end-side projection portion 10 are provided. When viewed in the direction of FIG. 8, one proximal-end-side projection portion 11 is located in a space between one elastic piece 3 and the second portion 8. The other proximal-end-side projection portion 11 is located in a space between the other elastic piece 3 and the second portion 8.

A width d2 between the distal end of one proximal-end-side projection portion 11 and the distal end of the other proximal-end-side projection portion 11 (in other words, the width, in the direction perpendicular to the axis L1, of the shaft portion 2 at the position of the proximal-end-side projection portions 11 (see FIG. 8)) is larger than the diameter of the near-side mounting hole 202 of the base 200. That is, the pair of proximal-end-side projection portions 11 are provided such that the proximal-end-side projection portions 11 cannot be inserted into and taken out from the near-side mounting hole 202 in the direction of the center line L2 of the near-side mounting hole 202.

Each proximal-end-side projection portion 11 serves as a retraction pull-out prevention portion that prevents the shaft portion 2 from being pulled out from the base 200 in the retraction direction in a state where the fixing member 1 is assembled to the base 200. Specifically, in an assembled state to the base 200, each proximal-end-side projection portion 11 permits the distal end portion 9 of the shaft portion 2 to move from the advance position to a retraction position at which the distal end portion 9 is disengaged from the fixing target member 300, and also restricts further movement of the shaft portion 2 in the retraction direction from the retraction position. That is, each proximal-end-side projection portion 11 is provided such that, when the shaft portion 2 is at the advance position, the proximal-end-side projection portion 11 is not in contact with a portion 204, of the base 200, which forms the near-side mounting hole 202, and a gap is formed in the axial direction between the portion 204 and the proximal-end-side projection portion 11 (see FIG. 2). Each proximal-end-side projection portion 11 is provided so as to be in contact with the portion 204 when the shaft portion 2 is at the retraction position (see FIG. 4).

The retraction position is a position at which the distal end portion 9 of the shaft portion 2 retracts into the far-side mounting hole 203 (withdrawn position at which the distal end portion 9 is withdrawn from the fitting space 207 of the base 200) in a state where the fixing member 1 is assembled to the base 200. In addition, the retraction position is a position at which a state where the distal end portion 9 is inserted into the far-side mounting hole 203 is maintained. That is, each proximal-end-side projection portion 11 defines the retraction position at which a state where the distal end portion 9 is inserted into the far-side mounting hole 203 is maintained while the distal end portion 9 is withdrawn from the fitting space 207 of the base 200.

Each proximal-end-side projection portion 11 also serves as a portion that prevents excessive deformation of the elastic piece 3. That is, in a state where the fixing member 1 is assembled to the base 200, each proximal-end-side projection portion 11 permits the elastic piece 3 to become elastically deformed to the extent that the elastic resilience of the elastic piece 3 is not lost, but prohibits the elastic piece 3 from becoming deformed excessively to the extent that the elastic resilience of the elastic piece 3 is lost.

As shown in FIG. 7 and FIG. 8, the shaft portion 2 has an additional portion 12 added to the second portion 8. The additional portion 12 is provided so as to rise from the side surface of the second portion 8 in the direction perpendicular to the axis L1. The additional portion 12 is provided on one side surface 8a out of two side surfaces 8a and 8b, of the second portion 8, including the long sides of the rectangular cross-section. The additional portion 12 is not provided on the other side surface 8b. When viewed in the direction of FIG. 8, the additional portion 12 is located at the center of the width (width in the direction perpendicular to the axis L1) of the side surface 8a, and is provided so as to extend in the axial direction from the proximal end of the second portion 8 (in other words, the seat portion 4). In the example of FIG. 8, the additional portion 12 extends from the proximal end of the second portion 8 (seat portion 4) to the same axial position as that of the proximal-end-side projection portion 11.

The additional portion 12 is provided on the side surface 8a of the body portion 6 which is at an angular position of 90° around the axis L1 with respect to the side surface of the body portion 6 on which the elastic piece 3, the distal-end-side projection portion 10, and the proximal-end-side projection portion 11 are provided. That is, the projecting direction of the additional portion 12 from the body portion 6 (second portion 8) has an angular difference of 90° from the projecting direction of the distal-end-side projection portion 10 and the proximal-end-side projection portion 11.

The additional portion 12 serves as an assembly direction limiting portion that limits the assembly direction of the shaft portion 2 (fixing member 1) to the base 200 around the axis L1 to one specific direction. That is, the additional portion 12 is provided such that the additional portion 12 permits assembly of the fixing member 1 to the base 200 (in other words, fitting of the shaft portion 2 into the mounting holes 202 and 203 of the base 200) when the direction (assembly direction) of the shaft portion 2 (fixing member 1) with respect to the base 200 around the axis L1 is the one specific direction, but prohibits assembly of the fixing member 1 to the base 200 (in other words, fitting of the shaft portion 2 into the mounting holes 202 and 203) when the assembly direction is a direction other than the one specific direction.

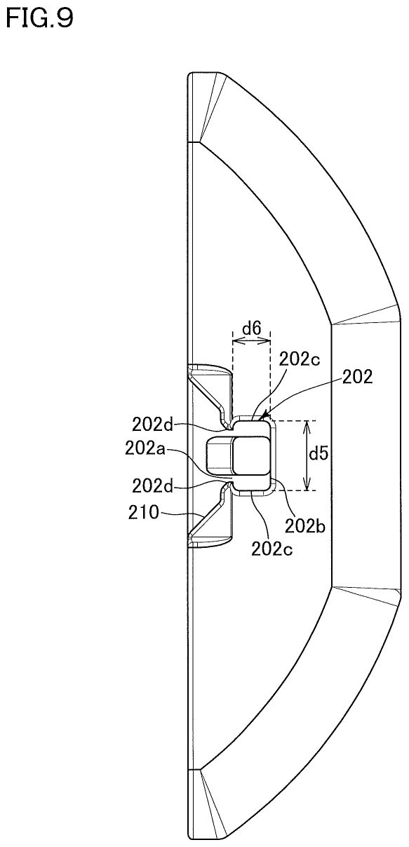

Specifically, the near-side mounting hole 202 of the base 200 is formed in a shape in which a part in the circumferential direction around the center of the near-side mounting hole 202 is open when viewed in a plan view shown in FIG. 9. When the fixing member 1 is assembled to the base 200 in a state where the side surface 8b of the shaft portion 2 on the side opposite to the side surface 8a on which the additional portion 12 is provided faces a portion 202b, of the inner surface of the near-side mounting hole 202, opposing an open portion 202a of the near-side mounting hole 202, this assembly (in other words, fitting of the shaft portion 2 into the mounting holes 202 and 203) is permitted. On the other hand, even when an attempt is made to assemble the fixing member 1 to the base 200 in a state where the side surface of the shaft portion 2 other than the side surface 8b (e.g., the side surface 8a on which the additional portion 12 is provided) faces the inner surface 202b of the near-side mounting hole 202, the additional portion 12 comes into contact with the inner surface 202b, whereby the axis L1 of the shaft portion 2 cannot be caused to coincide with the center line L2 of the mounting hole 202. That is, it is impossible to assemble the fixing member 1 to the base 200 (in other words, to fit the shaft portion 2 into the mounting holes 202 and 203).

The assembly direction of the shaft portion 2 (fixing member 1) to the base 200 around the axis L1 will be described further. The base 200 has an extension surface 209 (see FIG. 3) which is continuous with the inner surface 202b of the near-side mounting hole 202 and extends to the far-side mounting hole 203 so as to be parallel to the center line L2 of the mounting hole 202. When the side surface 8b of the shaft portion 2 on the side opposite to the side where the additional portion 12 is provided opposes the extension surface 209, assembly of the fixing member 1 to the base 200 is permitted. On the other hand, when the side surface of the shaft portion 2 other than the side surface 8b faces the extension surface 209, the additional portion 12 makes it impossible to assemble the fixing member 1 to the base 200.

Giving a further description, when the restriction surface 9a of the distal end portion 9 faces in a forward direction which is the opposite direction P2 (see FIG. 3) opposite to the movement restriction direction P1 of the fixing target member 300 (pulling-out direction from the base 200), assembly of the fixing member 1 to the base 200 is permitted. On the other hand, when the restriction surface 9a faces in a wrong direction (reverse direction) which is the movement restriction direction P1 of the fixing target member 300, the additional portion 12 makes it impossible to assemble the fixing member 1 to the base 200. In other words, assembly of the fixing member 1 to the base 200 is permitted when the inclined surface 9b of the distal end portion 9 faces in the movement restriction direction P1, but this assembly is impossible when the inclined surface 9b faces in the opposite direction P2 opposite to the movement restriction direction P1. The additional portion 12 corresponds to a reverse assembly prevention portion of this disclosure.

As shown in FIG. 8, the shaft portion 2 has a support portion 13 which supports the elastic piece 3. As the support portion 13, two (a pair of) support portions are provided so as to match the number of elastic pieces 3. The pair of support portions 13 are formed in a shape that is line-symmetrical with respect to the axis L1 of the shaft portion 2. Each support portion 13 is provided at the boundary position between the first portion 7 and the second portion 8 of the shaft portion 2 in the axial direction. More specifically, each support portion 13 is provided on the distal end side with respect to the proximal-end-side projection portion 11, and is provided at a distance in the axial direction from the proximal-end-side projection portion 11. Each support portion 13 is provided on the proximal end side with respect to the distal-end-side projection portion 10 and the triangular portion 14 described later. Each support portion 13 is also connected to the bottom side of the triangular portion 14.

Each support portion 13 is provided so as to project laterally (in the direction perpendicular to the axis L1) from the body portion 6 of the shaft portion 2. The projecting direction of the support portion 13 is the same as the projecting direction of the distal-end-side projection portion 10 and the proximal-end-side projection portion 11.

As shown in FIG. 6 and FIG. 8, the shaft portion 2 has a pair of (two) triangular portions 14. Each triangular portion 14 is provided at a position between the distal-end-side projection portion 10 and the support portion 13 in the axial direction. Each triangular portion 14 is provided so as to project laterally (in the direction perpendicular to the axis L1) from the side surface of the first portion 7 of the shaft portion 2. Each triangular portion 14 is provided on the side surface of the first portion 7 on which the distal-end-side projection portion 10 is provided. That is, the projecting direction of the triangular portion 14 from the shaft portion 2 is the same as the projecting direction of the distal-end-side projection portion 10 and the proximal-end-side projection portion 11. In addition, the pair of triangular portions 14 are formed in a shape that is line-symmetrical with respect to the axis L1.

Each triangular portion 14 serves as a reinforcing rib that reinforces the first portion 7 and the support portion 13. Specifically, each triangular portion 14 has a plate portion 14a having a right-angled triangle shape, and an oblique side portion 14b provided so as to coincide with an oblique side of the right-angled triangle formed by the plate portion 14a. The bottom side of the plate portion 14a is connected to the support portion 13. The side, of the plate portion 14a, perpendicular to the bottom side is connected to the side surface of the first portion 7.

The oblique side portion 14b is provided so as to project from the surface of the plate portion 14a in a direction perpendicular to this surface (direction perpendicular to the drawing sheet of FIG. 8). The inclination angle of the oblique side portion 14b with respect to the axis L1 is set so as to be equal to the inclination angle, with respect to the axis L1, of the elastic piece 3 in a natural state where the elastic piece 3 is not elastically deformed. In other words, the oblique side portion 14b and the elastic piece 3 draw a straight line when viewed in the direction of FIG. 8.

The shaft portion 2 is provided so as to be movable in the axial direction between the advance position (projection position) at which the distal end portion 9 projects from the far-side mounting hole 203 of the base 200 to the fitting space 207 and the retraction position (withdrawn position) at which the distal end portion 9 retracts into the far-side mounting hole 203 while an assembled state to the base 200 is maintained by the elastic pieces 3, and the seat portion 4 and the distal-end-side projection portions 10 which serve as an advance pull-out prevention portion. Also, the shaft portion 2 is provided such that, in an assembled state to the base 200, the axis L1 thereof is directed in the direction (fitting perpendicular direction) perpendicular to the pulling-out direction P1 of the fixing target member 300 from the base 200. FIG. 2 to FIG. 4 illustrate an example in which the axis L1 is directed in the up-down direction of the vehicle in an assembled state, but the axis L1 may be directed in another direction (e.g., horizontal direction).

Each elastic piece 3 is formed so as to bias the shaft portion 2 in the advance direction in a state where the fixing member 1 is assembled to the base 200. Specifically, in an assembled state to the base 200, each elastic piece 3 holds the shaft portion 2 at the advance position when an external force in the retraction direction is not applied to the shaft portion 2, but becomes elastically deformed so as to permit movement of the shaft portion 2 in the retraction direction when the external force is applied. When the external force is released, each elastic piece 3 returns the shaft portion 2 to the advance position by the repulsive force of the elastic deformation thereof. Each elastic piece 3 also serves a retraction pull-out prevention portion that prevents the shaft portion 2 from being pulled out from the base 200 in the retraction direction.

The pair of (two) elastic pieces 3 are provided. The pair of elastic pieces 3 are located on sides opposite to each other by 180° in the circumferential direction around the axis L1. The pair of elastic pieces 3 are formed in a stabilizer shape. Specifically, each elastic piece 3 is formed in a shape in which the one end 3a thereof is connected to the support portion 13 of the shaft portion 2 and the other end 3b thereof is a free end. The pair of elastic pieces 3 oppose each other across the shaft portion 2 therebetween with an interval in the direction perpendicular to the axis L1. This interval gradually increases as the distance to the seat portion 4 decreases. In addition, each elastic piece 3 is formed in a plate shape having a predetermined width d3 in the right-left direction in the drawing sheet of FIG. 7. The predetermined width d3 is equal to the width, in the direction perpendicular to the axis L1, of the body portion 6 (the first portion 7 and the second portion 8) of the shaft portion 2 when viewed in the direction of FIG. 7.

Hereinafter, the one end 3a of each elastic piece 3 is sometimes referred to as proximal end, and the other end 3b of each elastic piece 3 is sometimes referred to as distal end. The proximal end 3a is connected to the distal end of the support portion 13 in the projecting direction of the support portion 13 from the shaft portion 2 (body portion 6) (the direction perpendicular to the axis L1). Each elastic piece 3 is provided such that the direction from the proximal end 3a to the distal end 3b is oblique to the direction of the axis L1. Specifically, each elastic piece 3 is provided so as to be inclined with respect to the axial direction (axis L1) such that the elastic piece 3 gradually approaches the proximal end side of the shaft portion 2 (the seat portion 4 side) and becomes farther away from the shaft portion 2 as advancing from the proximal end 3a toward the distal end 3b. The inclination angle of one elastic piece 3 with respect to the shaft portion 2 (axis L1) and the inclination angle of the other elastic piece 3 with respect to the shaft portion 2 (axis L1) are equal to each other. In addition, the inclination angles are each equal to the inclination angle of the oblique side portion 14b of the triangular portion 14 with respect to the axis L1. Moreover, the length from the proximal end 3a to the distal end 3b of one elastic piece 3 and the length from the proximal end 3a to the distal end 3b of the other elastic piece 3 are equal to each other. Moreover, the projecting direction of one elastic piece 3 from the shaft portion 2 and the projecting direction of the other elastic piece 3 from the shaft portion 2 in the direction perpendicular to the axis L1 are opposite to each other.

The distal end 3b is provided such that an interval d4 (see FIG. 8) is formed in the axial direction between the distal end 3b and the seat surface 4a of the seat portion 4. The interval d4 is set so as to be not greater than the thickness of a portion 204 (see FIG. 2), of the base 200, which forms the near-side mounting hole 202.

Each elastic piece 3 is formed such that the distal end 3b can be displaced with the proximal end 3a as a base point in a direction further away from the shaft portion 2 and a direction opposite thereto (a direction approaching the shaft portion 2). That is, each elastic piece 3 is formed so as to be elastically deformable with the proximal end 3a as a base point, and generates an elastic repulsive force that returns the elastic piece 3 to the original state, when the elastic piece 3 becomes elastically deformed.

As shown in FIG. 7, each elastic piece 3 has two sides 3d and 3e which extend in a straight manner in the extension direction from the proximal end 3a to the distal end 3b. These sides 3d and 3e are provided parallel to each other. The elastic piece 3 has a tapered portion 3c on the distal end side of one side 3d. The tapered portion 3c is provided so as to connect the side 3d and the distal end 3b obliquely with respect to the extension direction of the elastic piece 3. That is, the tapered portion 3c is formed in a shape in which the tapered portion 3c approaches the side 3e on the opposite side as the distance to the distal end 3b decreases. The tapered portion 3c is formed in each of the pair of elastic pieces 3.

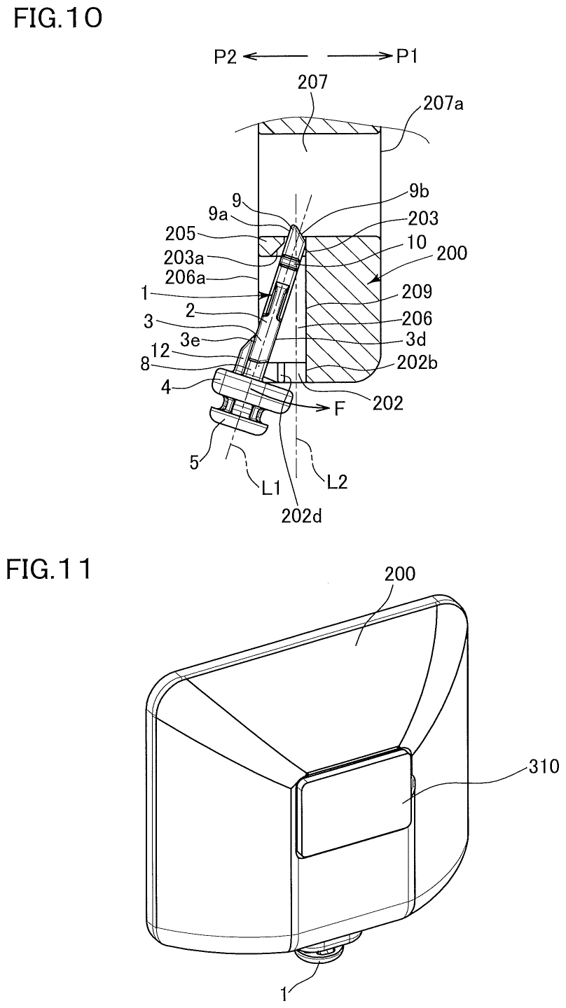

As shown in FIG. 7, the tapered portion 3c is formed at the side 3d on the same side as the inclined surface 9b of the distal end portion 9 of the shaft portion 2, out of the two sides 3d and 3e. In other words, the tapered portion 3c is formed at the side 3d on the side opposite to the side where the additional portion 12 is provided. In still other words, the tapered portion 3c is provided at the side 3d which, when the fixing member 1 is assembled to the base 200 while rotating the fixing member 1 in a state where the portion of the shaft portion 2 on the distal end side with respect to the distal-end-side projection portion 10 is positioned by the base 200 (see FIG. 10), is located in the forward direction side of that rotation. No tapered portion is formed at the side 3e which is located on the rear side of that rotation. That is, the side 3e and the distal end 3b are connected to each other at a right angle.

The tapered portion 3c serves as an interference suppression portion that suppresses interference of the elastic piece 3 with a portion of the base 200 before the elastic piece 3 enters a housing space 206 (see FIG. 10) of the base 200 when the fixing member 1 is assembled to the base 200 while rotating the fixing member 1.

As shown in FIG. 2, each elastic piece 3 is provided in the housing space 206, which is formed in the base 200, in an assembled state where the fixing member 1 is assembled to the base 200. In the assembled state, each elastic piece 3 does not project into the fitting space 207 for the base 200 and the fixing target member 300. In a state where the elastic piece 3 is housed in the housing space 206, the distal end 3b of the elastic piece 3 is in contact with a back surface 204b of the portion 204 (hereinafter, sometimes referred to as first plate portion), of the base 200, which forms the near-side mounting hole 202. In addition, the elastic piece 3 is provided in a state where the elastic piece 3 is slightly elastically deformed in a direction in which the shaft portion 2 is biased in the advance direction, in a state where the elastic piece 3 is housed in the housing space 206 and the seat portion 4 is in contact with the first plate portion 204 of the base 200 (that is, the state in FIG. 2). That is, the pair of elastic pieces 3 are provided in a state where the pair of elastic pieces 3 are slightly more open (each distal end 3b is farther away laterally from the shaft portion 2) than in a natural state. The shaft portion 2 is held at the advance position by a reaction force, from the back surface 204b of the first plate portion 204, due to the elastic repulsive force of each elastic piece 3.

As shown in FIG. 4, in a state where the pair of elastic pieces 3 are housed in the housing space 206, the pair of elastic pieces 3 become elastically deformed so as to become further open from the state in FIG. 2 as the shaft portion 2 moves in the retraction direction. At this time, the distal end 3b of each elastic piece 3 moves in a direction laterally away from the shaft portion 2 (direction perpendicular to the operating direction of the fixing member 1 (direction of the axis L1)), while being in contact with (sliding on) the back surface 204b of the first plate portion 204, as the shaft portion 2 moves in the retraction direction.

Each elastic piece 3 then returns to the state in FIG. 2 by the reaction force, from the back surface 204b of the first plate portion 204, due to the elastic repulsive force when the external force that moves the shaft portion 2 in the retraction direction is released. When the elastic piece 3 returns from the state in FIG. 4 to the state in FIG. 2, the distal end 3b thereof moves in the direction approaching the shaft portion 2, while being in contact with (sliding on) the back surface 204b of the first plate portion 204.

The seat portion 4 is provided at the proximal end of the second portion 8 of the shaft portion 2 and supports the shaft portion 2. The seat portion 4 is formed as a stand having a larger diameter than the shaft portion 2 and the projecting portion 5 (handle, operation portion). In other words, the seat portion 4 is formed in a shape in which the seat portion 4 projects laterally from the shaft portion 2 and the projecting portion 5 over the entire circumference around the axis L1. The width, in the direction perpendicular to the axis L1, of the seat portion 4 is set so as to be larger than a combined hole of the near-side mounting hole 202 of the base 200 and a connection hole 210 (see FIG. 5 and FIG. 9) connected to the near-side mounting hole 202 in the in-plane direction. That is, the width of the seat portion 4 is set to a width that allows both the near-side mounting hole 202 and the connection hole 210 to be hidden in a state where the fixing member 1 is assembled to the base 200.

The seat portion 4 serves as an advance pull-out prevention portion that prevents the shaft portion 2 from being pulled out from the base 200 in the advance direction. A surface 4a (see FIG. 2) of the seat portion 4 on the shaft portion 2 side serves as an advance restriction surface that comes into contact with a front surface 204a of the first plate portion 204 of the base 200 when the shaft portion 2 is at the advance position, thereby restricting advance of the shaft portion 2. The advance restriction surface 4a is formed as a flat surface perpendicular to the axis L1.

The projecting portion 5 is provided so as to project from a surface of the seat portion 4 on the side opposite to the advance restriction surface 4a toward the side opposite to the shaft portion 2. The projecting portion 5 is located on the axis L1. The projecting portion 5 is also located on a line (same as the axis L1) bisecting the interval between the pair of elastic pieces 3. The projecting portion 5 serves as an operation portion for operating the fixing member 1, specifically, for example, as a handle to be grasped by a user when moving the shaft portion 2 assembled to the base 200 in the retraction direction. The operating direction of the projecting portion 5 is defined as a direction in which the projecting portion 5 is pulled. As shown in FIG. 6 to FIG. 8, the projecting portion 5 has a small-diameter portion 5a connected to the seat portion 4, and a large-diameter portion 5b having a larger diameter than the small-diameter portion 5a. The large-diameter portion 5b is connected to an end portion of the small-diameter portion 5a on the side opposite to the side where the seat portion 4 is connected thereto. A recess based on the small-diameter portion 5a is formed between the seat portion 4 and the large-diameter portion 5b. The user can pick up the large-diameter portion 5b by putting their finger in this recess. The shape of the handle is not limited to that of the projecting portion 5, and may be any shape.

(Configuration of Base 200)

Next, the base 200 will be described. The base 200 is a member to which the fixing member 1 is assembled and which is for supporting the fixing target member 300. The base 200 is made of a synthetic resin, for example. As shown in FIG. 2, FIG. 4, and FIG. 5, the base 200 has the first plate portion 204 and a second plate portion 205 which are provided so as to oppose each other with an interval in a predetermined direction. The predetermined direction is a direction perpendicular to the fitting direction P2 of the fixing target member 300 into the base 200 and the pulling-out direction P1 (FIG. 3) opposite to the direction P2.

The first plate portion 204 and the second plate portion 205 each have the mounting hole 201 in which the fixing member 1 is mounted. The mounting hole 201 is formed as a hole penetrating the plate portions 204 and 205 in a direction perpendicular to the pulling-out direction P1 (see FIG. 3). Specifically, the mounting hole 201 has the near-side mounting hole 202 formed such that the portion 8 (second portion) on the proximal end side of the shaft portion 2 is fitted (inserted) thereinto, and the far-side mounting hole 203 formed such that the portion of the shaft portion 2 on the distal end side with respect to the distal-end-side projection portion 10 is fitted (inserted) thereinto. These mounting holes 202 and 203 are formed on the same center line L2 perpendicular to the pulling-out direction P1. The mounting holes 202 and 203 are also formed so as to be spaced apart in the direction of the center line L2.

The near-side mounting hole 202 is formed in the same shape (noncircular shape) as the cross-section (rectangular cross-section), perpendicular to the axis L1, of the second portion 8 of the shaft portion 2. Specifically, as shown in FIG. 9, the near-side mounting hole 202 includes one long side 202b which defines the longitudinal direction of the hole 202, and two short sides 202c which are provided perpendicular to the long side 202b and define the transverse direction of the hole 202. A width d5 of the long side 202b is longer than a width d6 of each short side 202c. The width d5 of the long side 202b is set to a width equal to the width in the longitudinal direction of the rectangular cross-section of the second portion 8 of the shaft portion 2 (strictly speaking, slightly larger than this width in the longitudinal direction). The width d6 of the short side 202c is set to a width equal to the width in the transverse direction of the rectangular cross-section of the second portion 8 (strictly speaking, slightly larger than this width in the transverse direction). In addition, the width d6 is set to a width shorter than the width in the longitudinal direction of the rectangular cross-section of the second portion 8.

The near-side mounting hole 202 is also formed in a shape in which a portion in the circumferential direction around the center thereof is open (see FIG. 9). The open portion 202a is formed on the side opposite to the long side 202b when viewed from the center of the mounting hole 202, in other words, at a position opposing the long side 202b.

Furthermore, the near-side mounting hole 202 has an engagement portion 202d at an end portion of each short side 202c on the side opposite to the side where the short side 202c is connected to the long side 202b. The open portion 202a is formed between the engagement portion 202d formed at one short side 202c and the engagement portion 202d formed at the other short side 202c. The interval between the pair of engagement portions 202d (width of the open portion 202a) is slightly smaller than the width in the longitudinal direction of the rectangular cross-section of the second portion 8 of the shaft portion 2. In addition, the engagement portion 202d is formed in a shape that allows the second portion 8 to go over the engagement portion 202d to be fitted into the mounting hole 202 when the fixing member 1 is assembled to the base 200.

The pair of engagement portions 202d serve as a pull-out prevention portion that engages the side surface 8a (see FIG. 7 and FIG. 8), on the side where the additional portion 12 is provided, of the second portion 8 fitted into the mounting hole 202, thereby preventing the second portion 8 from being pulled out from the open portion 202a of the mounting hole 202.

As shown in FIG. 3, FIG. 5, and FIG. 9, the first plate portion 204 has the connection hole 210 which is connected to the near-side mounting hole 202 through the open portion 202a of the near-side mounting hole 202. The connection hole 210 is formed so as to penetrate the first plate portion 204 in the same plane as the near-side mounting hole 202. The connection hole 210 is formed in a shape in which the width (width in a direction parallel to the long side 202b of the mounting hole 202) thereof gradually increases from the near-side mounting hole 202 toward an end portion 204c (see FIG. 5) in the in-plane direction of the first plate portion 204. In other words, the connection hole 210 is formed in a shape in which the width thereof gradually decreases from the end portion 204c of the first plate portion 204 toward the mounting hole 202. The connection hole 210 is formed in a shape in which the side opposite to the side where the near-side mounting hole 202 is provided (portion connected to the end portion 204c of the first plate portion 204) is open. The end portion 204c forms a part of a back surface 211 of the base 200.

The first plate portion 204 has the back surface 204b which forms a part of a wall surface of the housing space 206 described later (see FIG. 2). The back surface 204b is formed as a flat surface perpendicular to the center line L2 of the mounting holes 202 and 203. The back surface 204b serves as a sliding surface for the distal end 3b of each elastic piece 3, by bringing the distal end 3b into contact therewith. The first plate portion 204 also has the front surface 204a which faces the side opposite to the back surface 204b (see FIG. 2). The front surface 204a is formed as a flat surface perpendicular to the center line L2 of the mounting holes 202 and 203. The front surface 204a serves as an advance restriction surface that restricts movement of the shaft portion 2 in the advance direction, by bringing the seat portion 4 into contact therewith.

The far-side mounting hole 203 is formed in a noncircular shape as in the cross-section, perpendicular to the axis L1, of the portion of the shaft portion 2 on the distal end side. Specifically, the cross-section, perpendicular to the center line L2, of the mounting hole 203 is formed in a quadrangular shape. More specifically, the width of the mounting hole 203 in a direction perpendicular to the center line L2 when viewed in the direction of FIG. 2 is set to be the same as the width of the first portion 7 of the shaft portion 2 in the direction perpendicular to the axis L1 when viewed from the direction of FIG. 2 (strictly speaking, slightly larger than the width of the first portion 7). The width of the mounting hole 203 in the direction perpendicular to the center line L2 when viewed in the direction of FIG. 3 gradually decreases as the distance to the fitting space 207 into which the fixing target member 300 is fitted decreases. That is, the mounting hole 203 has an inner surface 203a which is inclined with respect to the center line L2.

The inclined inner surface 203a is formed on the side where a back surface opening 206a (see FIG. 3 and FIG. 5) of the housing space 206 described later is provided. The inner surface of the mounting hole 203 on the side opposite to the inclined inner surface 203a is formed as a surface parallel to the center line L2 when viewed in the direction of FIG. 3. In addition, the inner surfaces on both of the right and left sides of the mounting hole 203 are formed as surfaces parallel to the center line L2 when viewed in the direction of FIG. 2. That is, in the mounting hole 203, only the inner surface 203a on the back surface opening 206a side of the housing space 206 is formed as an inclined surface, and the other inner surfaces are formed as surfaces parallel to the center line L2. The far-side mounting hole 203 is formed in a shape in which the entire circumference thereof in the circumferential direction around the center line L2 is closed.

The second plate portion 205 is provided so as to form a part of a wall surface of the fitting space 207 described later. The far-side mounting hole 203 is formed such that an opening of the hole 203 is formed in the fitting space 207 to provide communication between the housing space 206 and the fitting space 207. The second plate portion 205 also has a surface 205a (see FIG. 2 and FIG. 3) which forms a part of the wall surface of the housing space 206. The surface 205a serves as an advance restriction surface that restricts movement of the shaft portion 2 in the advance direction, by bringing the distal-end-side projection portion 10 of the shaft portion 2 into contact therewith. The surface 205a also serves as a positioning portion that positions the distal-end-side projection portion 10 such that the distal end side of the shaft portion 2 is inserted into the far-side mounting hole 203 when the fixing member 1 is assembled to the base 200.

In the base 200, the housing space 206 for housing the shaft portion 2 and the pair of elastic pieces 3 is formed between the first plate portion 204 and the second plate portion 205. The housing space 206 has the opening 206a formed in the direction perpendicular to the center line L2 of the mounting holes 202 and 203 (see FIG. 3 and FIG. 5). The inside and the outside of the housing space 206 communicate with each other through the opening 206a. The opening 206a is formed in the back surface 211 (see FIG. 5) of the base 200. When a surface in which a front surface opening 207a (see FIG. 5) of the fitting space 207 (fitting hole) into which the fixing target member 300 is fitted is formed is defined as a front surface of the base 200, the back surface 211 is a portion on the side opposite to the front surface. The back surface opening 206a is formed on the same side as the above-described connection hole 210 when viewed from the center line L2.

The base 200 has, in the housing space 206, the extension surface 209 parallel to the center line L2 of the mounting holes 202 and 203 (see FIG. 3). The extension surface 209 is continuous with the inner surface forming the long side 202b (see FIG. 9) of the near-side mounting hole 202 and extends to the far-side mounting hole 203. The extension surface 209 is provided so as to face and support the side surface (side surface on the side opposite to the side where the additional portion 12 is provided) of the shaft portion 2 assembled to the base 200.

The base 200 has the fitting space 207 as a fitting hole into which the fixing target member 300 is fitted. The fitting space 207 is provided at a position adjacent to the housing space 206 across the second plate portion 205. The fitting space 207 forms a space that allows the fixing target member 300 to be inserted thereinto or taken out therefrom in the directions P1 and P2 (see FIG. 3) perpendicular to the center line L2 of the mounting holes 202 and 203. The fitting space 207 has the front surface opening 207a through which a hook portion 301 (see FIG. 1) which is a part of the fixing target member 300 is exposed from the base 200 (see FIG. 3 and FIG. 5).

The fitting space 207 has, on an inner wall thereof, a recess 208 (see FIG. 2) which extends parallel to the directions P1 and P2 (see FIG. 3). As shown in FIG. 2, the recess 208 serves as a guide portion that is fitted to a projection portion 304, which is formed on the fixing target member 300, guides the fixing target member 300 in the direction P2 when the fixing target member 300 is assembled to the base 200, and guides the fixing target member 300 in the direction P1 when the fixing target member 300 is pulled out from the base 200.

As described above, the fitting space 207 is provided so as to permit movement of the fixing target member 300 in the directions P1 and P2 and restrict movement of the fixing target member 300 in directions other than the directions P1 and P2.

The base 200 is provided, for example, as a part of the interior of the vehicle. The base 200 is provided, for example, such that the center line L2 of the mounting holes 202 and 203 is directed in the up-down direction of the vehicle, but may be provided such that the center line L2 is directed in a direction other than the up-down direction (e.g., the horizontal direction).

(Configuration of Fixing Target Member 300)

Next, the fixing target member 300 will be described. The fixing target member 300 is made of a synthetic resin, for example, and is a member that provides a predetermined function to the user. Specifically, the fixing target member 300 is formed as a hook member on which an object (e.g., an umbrella handle, a smartphone holder, etc.) can be hooked. In addition, the fixing target member 300 is provided, for example, as a part of the interior of the vehicle. Furthermore, the fixing target member 300 is provided so as to be attachable to and detachable from the base 200 by the fixing member 1. That is, the fixing target member 300 can be attached to the base 200 in the direction P2 (see FIG. 3), and can be pulled out from the base 200 in the direction P1 (see FIG. 3). The fixing target member 300 may be a hard member assumed not to be deformed during use, not a soft member (thread, wire, sheet, etc.) assumed to be deformed during use.

Specifically, the fixing target member 300 has the hook portion 301 and a fitting portion 302 which is formed so as to be fitted to the base 200 (see FIG. 1 to FIG. 3). The hook portion 301 is formed in a hook shape that allows an object to be hooked thereon. FIG. 1 illustrates an example in which the bending direction of the hook portion 301 is the horizontal direction, but the bending direction of the hook portion 301 may be another direction (e.g., the up-down direction). The hook portion 301 is provided so as to project from the front surface opening 207a of the fitting space 207 of the base 200, for example, in the horizontal direction, and be exposed to the outside of the base 200 (the inside of the vehicle cabin).

The fitting portion 302 is provided so as to be inserted into the fitting space 207 through the front surface opening 207a of the base 200. A hole 303 (recess) is formed in the fitting portion 302. The hole 303 is formed at a position at which the hole 303 is connected to (opposes) the far-side mounting hole 203 of the base 200 in a state where the fitting portion 302 is fitted into the fitting space 207 of the base 200. In a state where the fixing target member 300 is fixed to the base 200, the distal end portion 9 of the fixing member 1 is fitted into the hole 303 (see FIG. 2 and FIG. 3). The hole 303 has an inner surface that faces and is parallel to the restriction surface 9a when the distal end portion 9 is fitted thereinto.

The fitting portion 302 also has the projection portion 304 (see FIG. 2). The projection portion 304 extends parallel to the directions P1 and P2 (see FIG. 3). The projection portion 304 is fitted into the recess 208 of the fitting space 207 in a state where the fitting portion 302 is fitted into the fitting space 207 of the base 200.

The fixing target member 300 has a restriction portion 305 (see FIG. 1) which restricts the fitting portion 302 from further moving in the insertion direction P2 (see FIG. 3) from a state where the fitting portion 302 is fitted into the fitting space 207 of the base 200. The restriction portion 305 is formed so as to project outward at the boundary position of the fitting portion 302 on the hook portion 301 side. The restriction portion 305 is also provided so as to come into contact with the periphery of the front surface opening 207a of the base 200. The portion (fitting portion 302) of the fixing target member 300 on the side opposite to the hook portion 301 is a portion that is hidden by the base 200 and is not visible to the user in a state where the fixing target member 300 is supported by the base 200.

(Method for Assembling Fixing Member 1)

Next, a method for assembling (mounting) the fixing member 1 to the base 200 will be described. A person who performs the assembly may, for example, hold the handle 5 and perform an operation of assembling the fixing member 1. As shown in FIG. 10, the fixing member 1 is put into the housing space 206 through the back surface opening 206a (see FIG. 5) of the base 200 in a state where the fixing member 1 is inclined obliquely with respect to the center line L2 of the mounting holes 202 and 203 of the base 200 (in other words, the direction perpendicular to the pulling-out direction P1 of the fixing target member 300). At this time, the orientation of the shaft portion 2 around the axis L1 is directed in a predetermined direction (forward direction). Specifically, the orientation of the fixing member 1 around the axis L1 is controlled such that the longitudinal width of the portion 8 on the proximal end side (second portion) of the shaft portion 2 out of the widths perpendicular to the axis L1 is parallel to the long side 202b (see FIG. 9) of the near-side mounting hole 202. In other words, the orientation of the fixing member 1 around the axis L1 is controlled such that the inclined surface 9b of the distal end portion 9 of the shaft portion 2 faces in the direction P1 and the restriction surface 9a of the distal end portion 9 faces in the direction P2. In still other words, the orientation of the fixing member 1 around the axis L1 is controlled such that the side surface of the shaft portion 2 on the side opposite to the side where the additional portion 12 is provided faces the extension surface 209 in the housing space 206.

Then, the distal-end-side projection portion 10 is positioned at the periphery of the far-side mounting hole 203 (surface of the second plate portion 205 on the housing space 206 side) while the portion of the shaft portion 2 on the distal end side with respect to the distal-end-side projection portion 10 is inserted obliquely into the far-side mounting hole 203 (positioning step). Then, the fixing member 1 is rotated in a direction F in FIG. 10 about the positioned distal-end-side projection portion 10 such that the axis L1 is parallel to the center line L2 of the mounting holes 202 and 203 (rotation step). Then, the portion 8 on the proximal end side of the shaft portion 2 is fitted into the near-side mounting hole 202, and the pair of elastic pieces 3 are housed in the housing space 206. In addition, the seat portion 4 is brought into contact with the front surface 204a of the first plate portion 204. Thus, the fixing member 1 is assembled to the base 200.

The fixing target member 300 may be assembled to the base 200 after the fixing member 1 is assembled to the base 200. In this case, the fitting portion 302 of the fixing target member 300 may be inserted into the fitting space 207 through the front surface opening 207a of the base 200. At this time, a portion, of the fitting portion 302, located at an end in the direction of insertion into the base 200 comes into contact with the inclined surface 9b of the distal end portion 9 of the shaft portion 2, whereby the fixing member 1 moves in the retraction direction against the elastic repulsive force of each elastic piece 3, and the distal end portion 9 retracts into the far-side mounting hole 203. Thereafter, when the fitting portion 302 moves to a position where the hole 303 of the fixing target member 300 is connected to the far-side mounting hole 203, the fixing member 1 moves in the advance direction by the elastic repulsive force of each elastic piece 3, and the distal end portion 9 is fitted into the hole 303. Accordingly, the fixing target member 300 is fixed to the base 200.

In a state where the distal end portion 9 is fitted into the hole 303, movement of the base member 300 in the direction P1, that is, pulling-out of the fixing target member 300 from the base 200, is restricted. To pull out the fixing target member 300 from the base 200, the handle 5 may be held and the fixing member 1 may be moved in the retraction direction. When the fixing member 1 is moved in the retraction direction, the distal end portion 9 and the hole 303 are disengaged from each other (see FIG. 4). This allows the fixing target member 300 to be moved in the direction P1 and further allows the fixing target member 300 to be pulled out from the base 200. When the external force in the retraction direction is released, the fixing member 1 automatically returns to the original state (state where the distal end portion 9 of the shaft portion 2 projects into the fitting space 207 of the base 200) by the elastic repulsive force of each elastic piece 3.

Hereinafter, the effects of this embodiment will be described. Since the fixing member 1 includes the elastic pieces 3, the fixing target member 300 can be attached to and detached from the base 200 while a state where the fixing member 1 is assembled to the base 200 is maintained. Accordingly, depending on the situation, depending on the user who uses the vehicle, or depending on the type of vehicle, the fixing target member 300 can be pulled out from the base 200, and another fixing target member can be attached to the base 200.

For example, if functions such as hooking an object are not required, a member 310 which closes the front surface opening 207a (see FIG. 5) of the support member 200 may be fixed to the base 200 as another fixing target member as shown in FIG. 11. As in the fixing target member 300 in FIG. 1, the closing member 310 is provided so as to be inserted into the fitting space 207 of the base 200, and has an engagement portion (hole) which engages the distal end portion 9 of the fixing member 1 assembled to the base 200. The fixing target member may be a member having both a functional portion such as for hooking an object, and a closing portion for closing the front surface opening 207a of the base 200. In this case, the fixing target member may be a member having a functional portion at one end in a linear direction and having a closing portion at another end in the linear direction. To enable the functional portion, the closing portion may be inserted into the fitting space 207 of the base 200, and the functional portion may be exposed from the base 200. To enable the closing portion, the functional portion may be inserted into the fitting space 207, and the front surface opening 207a of the base 200 may be closed by the closing portion.

Since each elastic piece 3 is provided integrally with the shaft portion 2 which prevents the fixing target member 300 from being pulled out from the base 200, man-hours for assembling the fixing member 1 to the base 200 can be reduced, and the manufacturing cost of the fixing member 1 can also be reduced.

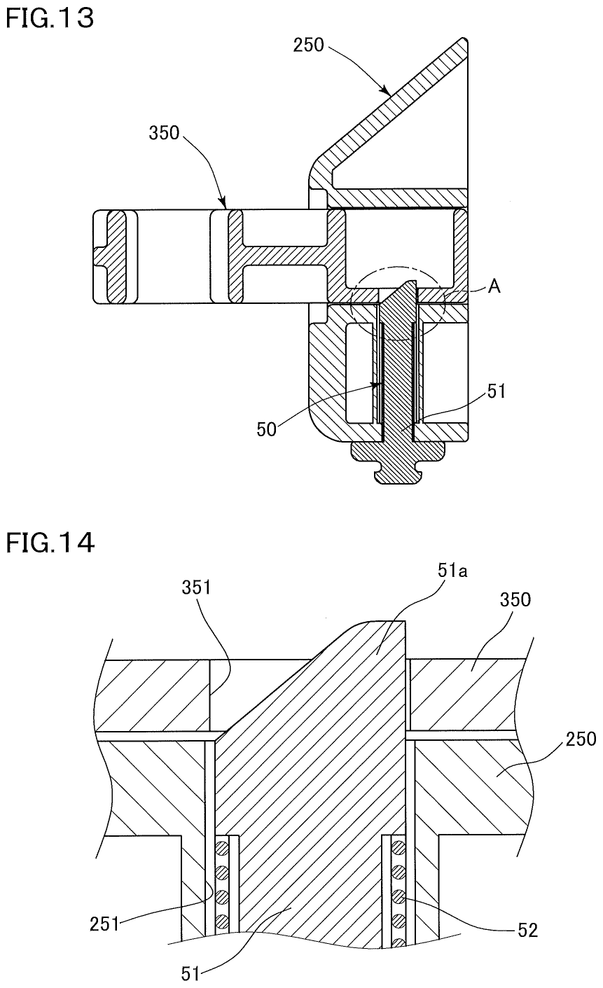

In contrast, as a comparative example, a structure in which a shaft portion and an elastic member for biasing the shaft portion in the advance direction are separate members is conceivable. FIG. 13 and FIG. 14 illustrate this structure. A fixing member 50 in FIG. 13 is a component for detachably fixing a fixing target member 350 to a base 250, and includes a shaft portion 51 made of a resin and a metal spring 52 as an elastic member for biasing the shaft portion 51 in the advance direction. The shaft portion 51 is inserted into a mounting hole 251 of the base 250, and is provided so as to be movable in the axial direction between an advance position at which a distal end portion 51a thereof is fitted into a hole 351 of the fixing target member 350 and a retraction position at which the distal end portion 51a is pulled out from the hole 351. The metal spring 52 is a metal coil spring provided separately from the shaft portion 51. The metal spring 52 is assembled to the base 250 so as to bias the shaft portion 51 in the advance direction, in a state where the shaft portion 51 is inserted into the inside of the metal spring 52.

In the structure in FIG. 13 and FIG. 14, it is necessary to bring the metal spring 52 into engagement with the shaft portion 51 when assembling the fixing member 50 to the base 250, which increases man-hours for the assembly. In addition, the metal spring 52 is required separately from the resin member 51, which increases the cost.

Returning to the description of the effects of this embodiment. Since the shaft portion 2 has the proximal-end-side projection portion 11, which restricts retraction of the shaft portion 2, at a position between the proximal end 3a and the distal end 3b of each elastic piece 3 in the axial direction, while elastic deformation of the elastic piece 3 within a certain range is permitted, the elastic deformation of the elastic piece 3 can be stopped at a position before the proximal end 3a comes into contact with the first plate portion 204 of the base 200. Accordingly, excessive deformation of the elastic piece 3 can be suppressed, thereby suppressing loss of the elastic repulsive force of the elastic piece 3.

The distal end side of the shaft portion 2 can be positioned to be in a state of being obliquely inserted in the far-side mounting hole 203 by the distal-end-side projection portion 10 of the shaft portion 2 when the fixing member 1 is assembled to the base 200 in an oblique direction. In a state where the distal end side of the shaft portion 2 is positioned, the fixing member 1 can be rotationally operated in the direction of the center line L2 of the mounting holes 202 and 203, so that this operation is easily performed, and the operation force can be reduced.

Since the shape of the cross-section, perpendicular to the axis L1, of the shaft portion 2 (the first portion 7 and the second portion 8) is a noncircular shape, and the mounting holes 202 and 203 each have a shape corresponding to this shape of the cross-section, the shaft portion 2 can be inhibited from rotating around the axis L1 in a state where the fixing member 1 is mounted on the base 200. Accordingly, the orientations of the restriction surface 9a and the inclined surface 9b of the distal end portion 9 of the shaft portion 2 can be inhibited from deviating from the directions P1 and P2.

Since the shape of the cross-section, perpendicular to the axis L1, of the first portion 7 of the shaft portion 2 is different from that of the second portion 8, the fixing member 1 can be inhibited from being assembled to the base 200 in a wrong orientation around the axis L1. That is, if the orientation of the second portion 8 around the axis L1 with respect to the near-side mounting hole 202 is a wrong orientation, the distal end side of the first portion 7 cannot be fitted into the far-side mounting hole 203. For example, if an attempt is made to perform assembly such that a short side of the rectangular cross-section of the second portion 8 faces the long side 202b of the near-side mounting hole 202, the distal end side of the first portion 7 cannot be fitted into the far-side mounting hole 203. Accordingly, the orientations of the restriction surface 9a and the inclined surface 9b of the distal end portion 9 of the shaft portion 2 can be inhibited from deviating from the directions P1 and P2.

Furthermore, since the additional portion 12 is provided on the proximal end side of the shaft portion 2, the fixing member 1 can be inhibited from being assembled to the base 200 in a wrong orientation around the axis L1. That is, if an attempt is made to perform assembly such that the side surface of the shaft portion 2 on which the additional portion 12 is provided faces the long side 202b of the near-side mounting hole 202, the second portion 8 cannot be fitted into the near-side mounting hole 202, and the distal end side of the first portion 7 cannot be fitted into the far-side mounting hole 203. Accordingly, when the fixing member 1 is assembled to the base 200, the inclined surface 9b of the distal end portion 9 of the shaft portion 2 can be caused to face in the direction P1 (see FIG. 3), and the restriction surface 9a can be caused to face in the direction P2 (see FIG. 3).

Since the distal end 3b of each elastic piece 3 has the tapered portion 3c, a situation in which the elastic piece 3 interferes with a portion of the base 200 (e.g., the connection hole 210 (see FIG. 5) connected to the near-side mounting hole 202) and thus cannot enter the housing space 206 when assembly to the base 200 is performed in an oblique direction can be prevented.

Since the distal end portion 9 of the shaft portion 2 has the inclined surface 9b, and the inclined surface 9b faces in the direction P1 opposite to the insertion direction P2 of the fixing target member 300 into the base 200 (see FIG. 3), the fixing member 1 can be caused to retract in conjunction with an operation of inserting the fixing target member 300 into the base 200, even without pulling the handle 5 of the fixing member 1 in the retraction direction. Accordingly, the fixing target member 300 can be easily assembled to the base 200.

Since the inner surface 203a of the far-side mounting hole 203 on the back surface opening 206a side of the housing space 206 is formed as an inclined surface, it is easy to insert the distal end side of the shaft portion 2 into the far-side mounting hole 203 in an oblique direction when assembling the shaft portion 2 in the oblique direction. Since the inner surfaces of the far-side mounting hole 203 on the sides other than the back surface opening 206a side of the housing space 206 are formed as surfaces parallel to the center line L2, the distal end side of the shaft portion 2 can be inhibited from rattling in the far-side mounting hole 203 even when the shaft portion 2 is at the retraction position.

### Second Embodiment

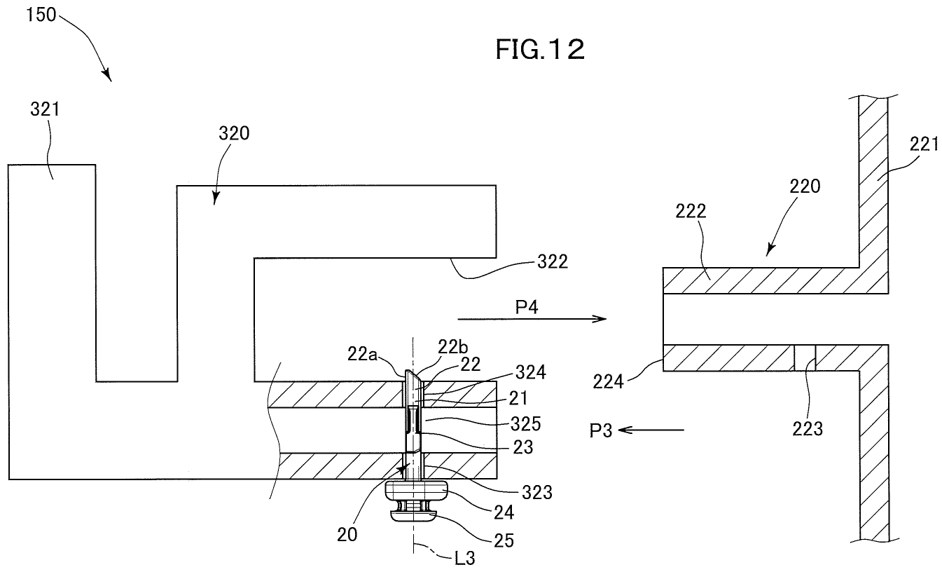

Next, a second embodiment of this disclosure will be described focusing on the differences from the above embodiment. In the above first embodiment, the example in which the fixing member is assembled to the base is shown, but the fixing member may be assembled to the fixing target member. FIG. 12 shows an example in which a fixing member is assembled to a fixing target member. A fixing structure 150 in FIG. 12 includes a base 220, a fixing target member 320 supported by the base 220, and a fixing member 20, made of a resin, for fixing the base 220 and the fixing target member 320 to each other. The fixing structure 150 is mounted, for example, in a vehicle (e.g., a vehicle cabin), but may be provided at a location other than in a vehicle.

The fixing member 20 is formed in the same shape as the above-described fixing member 1, but is assembled to the fixing target member 320. Specifically, the fixing member 20 includes a shaft portion 21, a pair of elastic pieces 23 formed integrally with the shaft portion 21, a seat portion 24 provided at the proximal end of the shaft portion 21, and a projecting portion 25 (handle) as an operation portion projecting from the seat portion 24 toward the side opposite to the side where the shaft portion 21 is located. The shaft portion 21 is formed in the same manner as the above-described shaft portion 2. The shaft portion 21 is inserted into mounting holes 323 and 324 of the fixing target member 320, and is provided so as to be movable between an advance position (projection position) at which a distal end portion 22 thereof projects into a fitting space 322 (fitting hole) of the fixing target member 320 and a retraction position (withdrawn position) at which the distal end portion 22 retracts into a far-side mounting hole 324. An axis L3 of the shaft portion 21 is directed in a direction (fitting perpendicular direction) perpendicular to a direction P3 in which the fixing target member 320 is pulled out from the base 220, in a state of being assembled to the fixing target member 320.

The distal end portion 22 includes a restriction surface 22a (prevention portion) which engages a hole 223 of the base 220, thereby restricting movement of the fixing target member 320 in the direction P3, and an inclined surface 22b which faces the side opposite to the restriction surface 22a. The restriction surface 22a is formed as a surface parallel to the axis L3 of the shaft portion 21, and is formed so as to face in the same direction as the pulling-out direction P3 of the fixing target member 320 in a state where the fixing member 20 is assembled to the fixing target member 320. The inclined surface 22b is formed as a surface inclined with respect to the axis L3, and is formed so as to face in a direction P4 (direction in which the fixing target member 320 is assembled to the base 220) opposite to the pulling-out direction P3 of the fixing target member 320 in a state where the fixing member 20 is assembled to the fixing target member 320.

As in the above-described shaft portion 2, the shaft portion 21 may have a distal-end-side projection portion which is formed on the distal end side thereof, by which the shaft portion 21 is positioned when assembled to the fixing target member 320, and by which the shaft portion 21 is prevented from being pulled out in the advance direction. The distal-end-side projection portion may be formed in the same shape as the above-described distal-end-side projection portion 10. In addition, as in the above-described shaft portion 2, the shaft portion 21 may have a proximal-end-side projection portion formed to suppress excessive deformation of each elastic piece 23. The proximal-end-side projection portion may be formed in the same shape as the above-described proximal-end-side projection portion 11.

Each elastic piece 23 is formed in the same shape as the above-described elastic piece 3. Each elastic piece 23 is housed in a housing space 325 between the near-side mounting hole 323 and the far-side mounting hole 324 in a state where the fixing member 20 is assembled to the fixing target member 320. Each elastic piece 23 becomes elastically deformed, while permitting movement of the shaft portion 21 to the retraction position, when an external force in the retraction direction is applied to the fixing member 20 assembled to the fixing target member 320, and returns the shaft portion 21 to the original advance position by the repulsive force of the elastic deformation of the elastic piece 23 when the external force is released.

The seat portion 24 and the handle 25 are formed in the same manner as the above-described seat portion 4 and handle 5. The seat portion 24 and the handle 25 are provided so as to be exposed to the outside of the near-side mounting hole 323 in a state where the fixing member 20 is assembled to the fixing target member 320.

The base 220 has a base portion 221 and a projecting portion 222 which projects from the base portion 221. The projecting portion 222 serves as a fitting portion that is fitted to the fixing target member 320. The projecting portion 222 is formed in a tubular shape. The hole 223 is formed in the side surface of the projecting portion 222 as a recess that is recessed in a direction perpendicular to the projecting direction of the projecting portion 222. The hole 223 is formed at a position where the hole 223 is connected to the far-side mounting hole 324 of the fixing target member 320 in a state where the fixing target member 320 is assembled to the base 220. The hole 223 serves as an engagement portion that engages the distal end portion 22 of the shaft portion 21.

The fixing target member 320 is an assembly counterpart member to which the fixing member 20 is assembled. The fixing target member 320 is formed, for example, as a hook member on which an object can be hooked. Specifically, the fixing target member 320 has a hook portion 321 on which an object can be hooked, and a fitting portion 322 as a fitting hole that is fitted to the projecting portion 222 of the base 220. The fitting portion 322 is formed in a recess shape that is recessed in a direction parallel to the directions P3 and P4 such that the fitting portion 322 is fitted to the outside of the projecting portion 222 (the projecting portion 222 is inserted thereinto).

Furthermore, the fixing target member 320 has the mounting holes 323 and 324 formed so as to be perpendicular to the recessed direction of the fitting portion 322 (direction parallel to the directions P3 and P4) and be connected to the fitting portion 322. The mounting holes 323 and 324 are formed coaxially. The proximal end side of the shaft portion 21 is fitted into the near-side mounting hole 323, and the distal end side of the shaft portion 21 is fitted into the far-side mounting hole 324. The housing space 325 for housing the pair of elastic pieces 23 is formed between the near-side mounting hole 323 and the far-side mounting hole 324.

The fixing target member 320 and the base 220 may be fixed to each other, for example, as follows. First, the fixing member 20 is assembled to the fixing target member 320 as shown in FIG. 12. At this time, as in the above-described fixing member 1, the fixing member 20 may be assembled in a direction oblique to center lines of the mounting holes 323 and 324.

Then, the fitting portion 322 of the fixing target member 320 to which the fixing member 20 has been assembled is fitted to the outside of the projecting portion 222 of the base 220. At this time, the inclined surface 22b of the distal end portion 22 of the shaft portion 21 comes into contact with a distal end surface 224 of the projecting portion 220, whereby the fixing member 20 moves in the retraction direction, and the distal end portion 22 retracts into the far-side mounting hole 324. Thereafter, when a position where the far-side mounting hole 324 is connected to the hole 223 of the base 220 is reached, the distal end portion 22 of the shaft portion 21 is fitted into the hole 223 by the elastic repulsive force of each elastic piece 23. Accordingly, the fixing target member 320 is fixed to the base 220.

To pull out the fixing target member 320 from the base 220, the handle 25 of the fixing member 20 may be pulled in the retraction direction. In this case, the shaft portion 21 moves in the retraction direction against the elastic repulsive force of each elastic piece 23, and the distal end portion 22 retracts into the far-side mounting hole 324. This allows the fixing target member 320 to be pulled out in the direction P3.

Thus, even with the structure in FIG. 12, the same effects as those of the above-described fixing structure 100 can be obtained.

### Third Embodiment

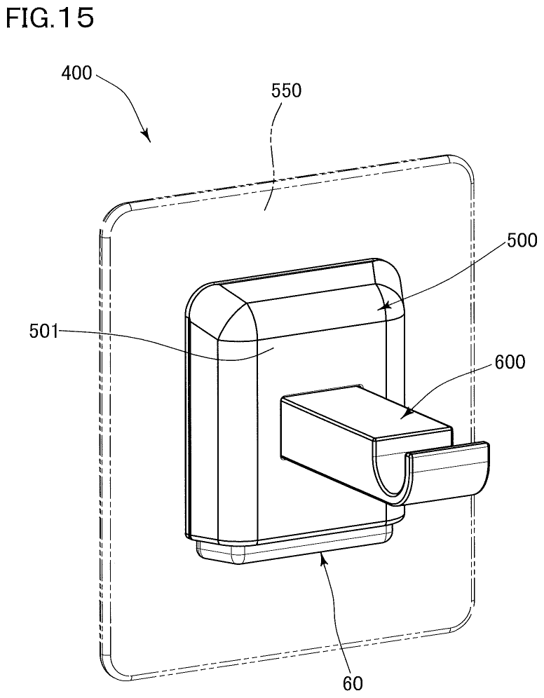

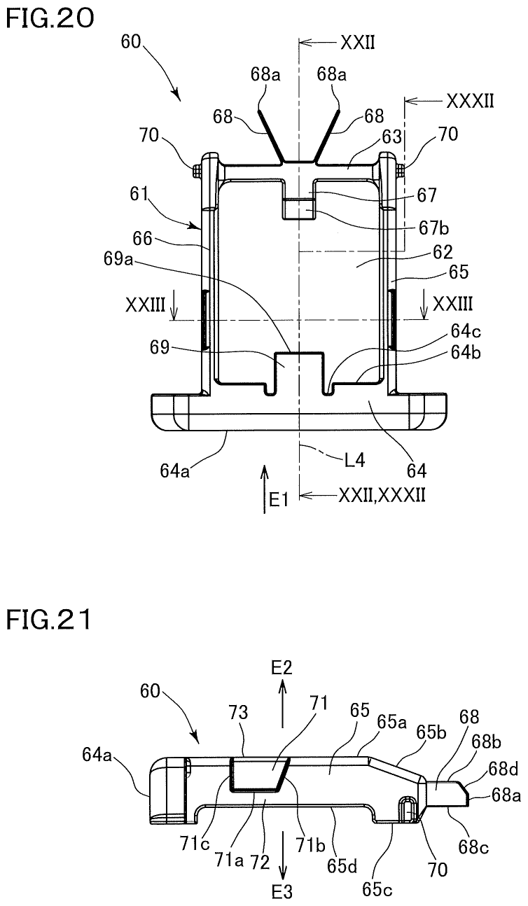

Next, a third embodiment of this disclosure will be described focusing on the differences from the above embodiments. FIG. 15 to FIG. 18 show a fixing structure 400 of this embodiment. The fixing structure 400 includes a base 500, a fixing target member 600 supported by the base 500, and a fixing member 60 for fixing the base 500 and the fixing target member 600 to each other. The fixing structure 400 is mounted, for example, in a vehicle (e.g., a vehicle cabin), but may be provided at a location other than in a vehicle. First, the fixing member 60 will be described also with reference to FIG. 20 to FIG. 23.

(Configuration of Fixing Member 60)

The fixing member 60 is a resin component formed entirely from a synthetic resin such as polypropylene or polyamide. The fixing member 60 is formed by injection molding, for example. That is, portions (portions 61, 66, 67, 68, 69, 70, etc., described later) of the fixing member 60 are integrally formed from the same resin material. The fixing member 60 is assembled to the base 500 as an assembly counterpart member. Specifically, the fixing member 60 is a member for, when assembled to the base 500, detachably fixing the fixing target member 600 to the base 500 while maintaining the assembled state.

As shown in FIG. 20, the fixing member 60 is formed in a frame shape. Specifically, the fixing member 60 includes a body portion 61 having substantially a quadrangular frame shape. The body portion 61 has a first portion 63 forming the upper side of the quadrangular shape, a second portion 64 forming the lower side of the quadrangular shape, a third portion 65 forming the right side of the quadrangular shape, and a fourth portion 66 forming the left side of the quadrangular shape in the drawing sheet of FIG. 20. A cavity 62 is formed inside these portions 63 to 66.

The first portion 63 is formed in a shape in which the right-left direction in the drawing sheet of FIG. 20 is the longitudinal direction thereof. One end portion in the longitudinal direction of the first portion 63 is connected to one end portion in the longitudinal direction of the third portion 65. Another end portion in the longitudinal direction of the first portion 63 is connected to one end portion in the longitudinal direction of the fourth portion 66.

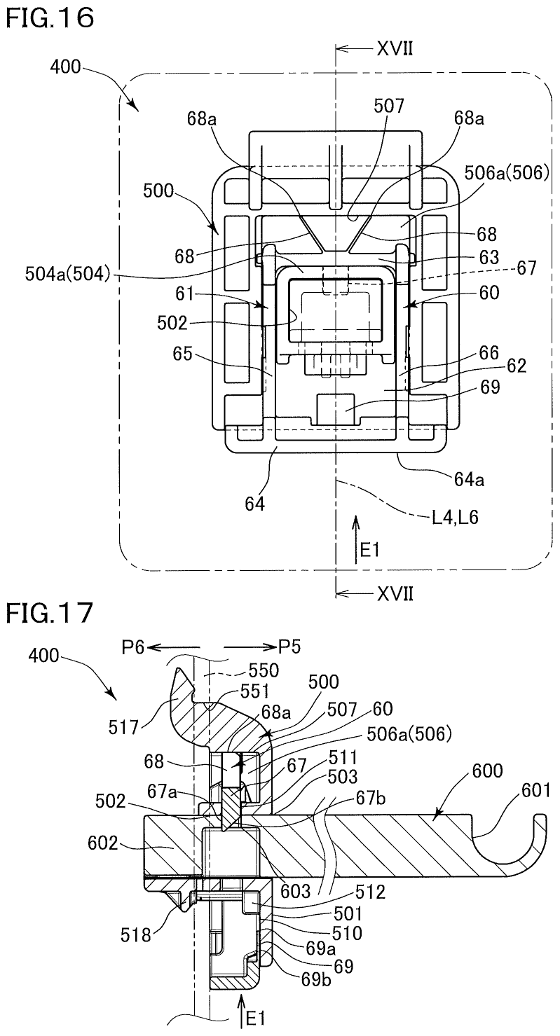

The first portion 63 serves as a pull-out prevention portion that prevents the fixing member 60 from being pulled out from the base 500 in a direction opposite to an operating direction E1 (see FIG. 20) of an operation surface 64a described later. That is, when the fixing member 60 is in the state in FIG. 16 (state where a first projecting portion 67 described later projects into a fitting space 502 of the base 500), the first portion 63 is in contact with a portion 504a of the base 500 facing in the direction opposite to the operating direction E1. In addition, the first portion 63 also serves as a support portion that supports the first projecting portion 67 and a pair of elastic pieces 68.

The second portion 64 is formed in a shape in which the right-left direction in the drawing sheet of FIG. 20 is the longitudinal direction thereof. The second portion 64 is provided at a position opposing the first portion 63 across the cavity 62. In addition, the longitudinal direction of the second portion 64 is parallel to the longitudinal direction of the first portion 63. One end portion in the longitudinal direction of the second portion 64 is connected to an end portion in the longitudinal direction of the third portion 65 on the side opposite to the side where the first portion 63 is connected to the third portion 65. Another end portion in the longitudinal direction of the second portion 64 is connected to an end portion in the longitudinal direction of the fourth portion 66 on the side opposite to the side where the first portion 63 is connected to the fourth portion 66.

The surface 64a of the second portion 64 on the side opposite to the cavity 62 side serves as an operation surface (operation portion) on which a pushing operation is performed by the user. The operation surface 64a is provided such that the direction E1 (see FIG. 20) opposite to the projecting direction of the first projecting portion 67 described later from the first portion 63 is the direction of the pushing operation. The operation surface 64a is provided at a position where the cavity 62 is interposed between the operation surface 64a, and the first projecting portion 67 and the elastic pieces 68.

The operating direction E1 of the operation surface 64a is parallel to a virtual straight line L4 (see FIG. 20) bisecting the interval between the pair of elastic pieces 68 described later. The operation surface 64a may be formed, for example, as a flat surface perpendicular to the operating direction E1. The virtual straight line L4 is orthogonal to the above operation surface 64a. In the example in FIG. 20, the operating direction E1 is directed upward (e.g., the upward direction of the vehicle or upward in the vertical direction), but may be directed in a direction other than the upward direction (specifically, the downward direction, the right-left direction, or an oblique direction). Hereinafter, the virtual straight line L4 is defined as a center line of the fixing member 60 and the body portion 61.

As shown in FIG. 16 and FIG. 17, the second portion 64 including the operation surface 64a projects downward (direction opposite to the operating direction E1) from the base 500 and is exposed to the outside when the first projecting portion 67 described later is at a projection position at which the first projecting portion 67 projects into the fitting space 502 (fitting hole) of the base 500. Thus, the second portion 64 is a portion that defines the operation portion 64a. The second portion 64 also serves as a support portion that supports a second projecting portion 69 (see FIG. 20) described later.

The third portion 65 and the fourth portion 66 are each formed in a shape in which the up-down direction in the drawing sheet of FIG. 20, in other words, a direction perpendicular to the longitudinal directions of the first portion 63 and the second portion 64, is the longitudinal direction thereof. The longitudinal direction of the third portion 65 and the longitudinal direction of the fourth portion 66 are parallel to each other. The third portion 65 and the fourth portion 66 are provided at positions opposing each other across the cavity 62.

Here, of directions E2 and E3 (see FIG. 21) perpendicular to both the longitudinal direction of the first portion 63 or the second portion 64 and the longitudinal direction of the third portion 65 or the fourth portion 66, the direction E2 directed upward in the drawing sheet of FIG. 21 is referred to as first direction, and the direction E3 directed downward is referred to as second direction. As shown in FIG. 21, an end portion on the first direction E2 side of the third portion 65 includes a parallel portion 65a which extends parallel to an end portion 65c on the second direction E3 side of the third portion 65 along the longitudinal direction of the third portion 65, and an inclined portion 65b angled to the parallel portion 65a. The inclined portion 65b is formed on the distal end side in a direction from the operation surface 64a side toward the elastic pieces 68 side (rightward direction in the drawing sheet of FIG. 21) in the longitudinal direction of the third portion 65. The inclined portion 65b is formed so as to gradually approach the end portion 65c on the second direction E3 side as advancing in the rightward direction in FIG. 21. The inclined portion 65b is a portion for facilitating assembly of the fixing member 60 to the base 500. In other words, the inclined portion 65b serves as an interference suppression portion that, when the fixing member 60 is assembled so as to rotate the fixing member 60 while inserting the fixing member 60 into a housing space 506 of the base 500 in an oblique direction, suppresses interference of the fixing member 60 with a portion of the base 500 that hinders the rotational assembly of the fixing member 60.

The first direction E2 is a direction directed toward the housing space 506 when the fixing member 60 is assembled into the housing space 506 from the back side of the base 500. Hereinafter, the first direction E2 is sometimes referred to as forward direction, and the second direction E3 is sometimes referred to as reverse direction. The inclined portion 65b is formed on the forward direction E2 side.

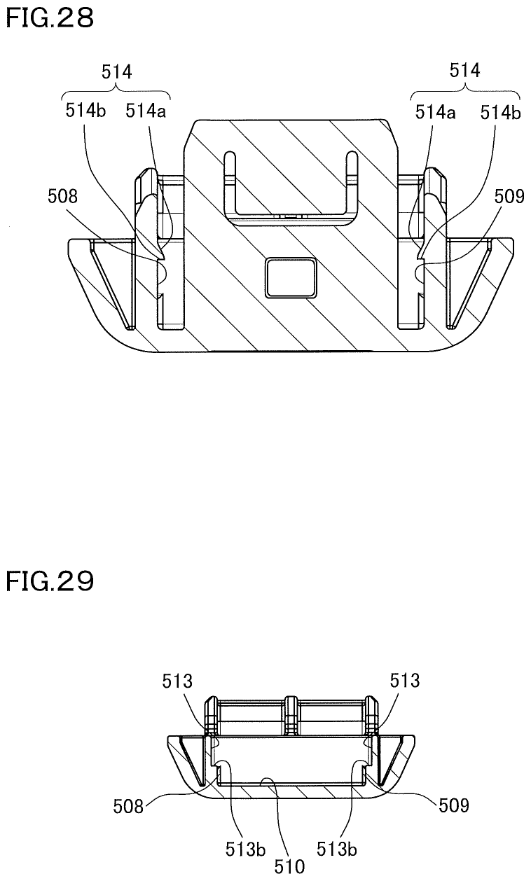

The end portion 65c on the second direction E3 (reverse direction) side of the third portion 65 is formed so as to extend parallel to the end portion 65a (parallel portion) on the first direction E2 side along the longitudinal direction of the third portion 65. A recess 65d is formed on the end portion 65c so as to be recessed on the end portion 65a side on the first direction E2 side. The recess 65d is a portion that is engaged with an engagement projection 514 (see FIG. 27 and FIG. 28), which is formed on the base 500, in a state of being assembled to the base 500. The fourth portion 66 is formed in the same shape as the third portion 65.

Furthermore, as shown in FIG. 23, a recess 71 is formed on each of outer surfaces 72 of the third portion 65 and the fourth portion 66 on the side opposite to the cavity 62 so as to be recessed on the cavity 62 side. Each recess 71 is formed in a shape connected to an end portion 73 of the third portion 65 or the fourth portion 66 on the forward direction E2 side. The recess 71 extends in the reverse direction E3 from the end portion 73 and forms a bottom portion 71a on the reverse direction E3 side. As described above, each recess 71 is formed in a shape in which the end portion 73 side (forward direction E2 side) thereof is open and the reverse direction E3 side thereof is closed.

More specifically, as shown in FIG. 21, the recess 71 is formed at a position between a projection portion 70 described later and the operation surface 64a. The bottom portion 71a extends along the longitudinal direction of the third portion 65 or the fourth portion 66. The recess 71 includes a first step portion 71b connecting one end portion in the extension direction of the bottom portion 71a and the end portion 73 of the third portion 65 or the fourth portion 66 on the forward direction E2 side. The recess 71 also includes a second step portion 71c connecting another end portion in the extension direction of the bottom portion 71a and the end portion 73 of the third portion 65 or the fourth portion 66 on the forward direction E2 side. These step portions 71b and 71c form a step recessed from the outer surface 72 (see FIG. 23) toward the cavity 62 side.

The first step portion 71b is located on the elastic pieces 68 side with respect to the second step portion 71c. The first step portion 71b extends in a direction oblique to the directions E2 and E3 so as to be gradually displaced to the operation surface 64a side as advancing toward the bottom portion 71a. The second step portion 71c is located on the operation surface 64a side with respect to the first step portion 71b. The second step portion 71c extends parallel to the directions E2 and E3.

The recess 71 is a portion for, when the fixing member 60 is rotated and assembled while being inserted into the housing space 506 of the base 500 in an oblique direction, receiving the engagement projection 514 (see FIG. 27 and FIG. 28) of the base 500 and assisting the rotational assembly of the fixing member 60. The above first step portion 71b of the recess 71 is formed at a position that allows the first step portion 71b to come into contact with the engagement projection 514 in the middle of assembly.

The body portion 61 is assembled to the base 500 so as to be housed in the housing space 506 of the base 500 (see FIG. 16 and FIG. 17). Specifically, the body portion 61 is assembled into the housing space 506 such that a fitting hole-forming portion 504 of the base 500 described later is inserted into the cavity 62. In other words, the body portion 61 is assembled to the base 500 so as to surround the fitting hole-forming portion 504 in the housing space 506.

The body portion 61 is provided so as to be movable in a direction parallel to the center line L4, or a direction parallel to the operating direction E1, or a direction parallel to the projecting direction of the first projecting portion 67 from the first portion 63 between a position at which the first projecting portion 67 as a prevention portion projects into the fitting space 502 and a position at which the first projecting portion 67 is withdrawn from the fitting space 502 while maintaining a state of being assembled to the base 500. The body portion 61 is restricted from moving in directions other than the direction parallel to the center line L4 by the base 500.

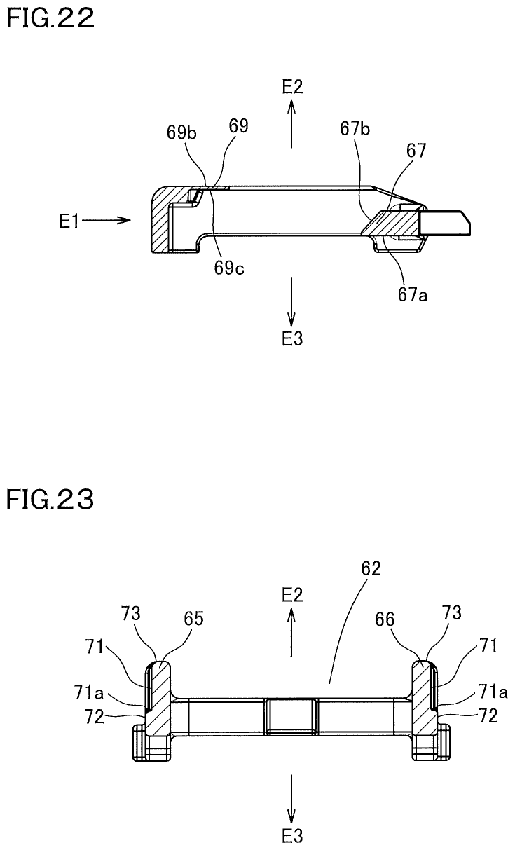

The fixing member 60 includes the first projecting portion 67 which serves as a prevention portion that prevents the fixing target member 600 from being pulled out from the base 500 (see FIG. 20 and FIG. 22). The first projecting portion 67 is formed in a shape in which the first projecting portion 67 projects from the above first portion 63 toward the cavity 62 side. The first projecting portion 67 is also formed at an intermediate position in the longitudinal direction of the first portion 63. Furthermore, the first projecting portion 67 is located on the center line L4 and projects in a direction in which the center line L4 extends. Moreover, the first projecting portion 67 projects in the direction opposite to the operating direction E1.

A portion 67a of the side surface of the first projecting portion 67 serves as a restriction surface that restricts movement of the fixing target member 600 in a predetermined direction P5 (see FIG. 17). The predetermined direction P5 is a direction of pulling out from the fitting hole 502 of the base 500. The restriction surface 67a serves as a prevention portion that prevents the fixing target member 600 from being pulled out from the base 500. The restriction surface 67a is formed as a surface parallel to the center line L4. In other words, the restriction surface 67a is formed as a surface perpendicular to the above pulling-out direction P5. The restriction surface 67a is provided so as to face in a direction P6 (direction of insertion into the fitting space 502) opposite to the pulling-out direction P5, in a state where the fixing member 60 is assembled to the base 500 (see FIG. 17).

A surface 67b (see FIG. 20 and FIG. 22) of the first projecting portion 67 on the side opposite to the restriction surface 67a is formed as a surface that permits insertion of the fixing target member 600 into the fitting space 502. Specifically, the surface 67b is formed such that a force that moves the fixing member 60 (body portion 61) in the direction (upward direction in the drawing sheets of FIG. 20 and FIG. 22) opposite to the projecting direction of the first projecting portion 67 in the direction of the center line L4 is generated when a force in the opposite direction P6 is applied to the surface 67b. More specifically, the surface 67b is formed as a surface inclined with respect to the center line L4 or the restriction surface 67a so as to gradually approach the restriction surface 67a as advancing in the direction from the proximal end side to the distal end side of the first projecting portion 67. In this embodiment, the surface 67b is formed as a flat surface inclined with respect to the center line L4, but may be formed in a curved shape (e.g., spherical shape). The surface 67b is provided so as to face in the pulling-out direction P5 in a state where the fixing member 60 is assembled to the base 500 (see FIG. 17). The surface 67b corresponds to the insertion permission portion of this disclosure.

The first projecting portion 67 is provided in a state of being fitted (inserted) into a mounting hole 511, which is formed in the base 500, in a state where the fixing member 60 is assembled to the base 500 (see FIG. 17 and FIG. 19). The first projecting portion 67 is also provided so as to be movable between the projection position (see FIG. 17) at which the first projecting portion 67 projects into the fitting space 502 (fitting hole) of the base 500 and a withdrawn position (see FIG. 19) at which the first projecting portion 67 is withdrawn from the fitting space 502, while maintaining a state of being fitted into the mounting hole 511 in a state where the fixing member 60 is assembled to the base 500.

As shown in FIG. 20, the fixing member 60 includes the pair of (two) elastic pieces 68. Each elastic piece 68 is formed in a shape in which the elastic piece 68 projects from the first portion 63 of the body portion 61 toward the side opposite to the cavity 62 (in the direction opposite to the projecting direction of the first projecting portion 67). The elastic piece 68 is provided on the side opposite to the operation surface 64a when viewed from the cavity 62. In other words, the elastic piece 68 is provided at a position where the cavity 62 is interposed between the operation surface 64a and the elastic piece 68. The elastic piece 68 is also provided on the same side as the first projecting portion 67 when viewed from the cavity 62. The elastic piece 68 is also provided at the distal end position of the fixing member 60 in the operating direction E1.

The pair of elastic pieces 68 are formed in a stabilizer shape as in the elastic pieces 3 of the above first embodiment. Specifically, each elastic piece 68 is formed in a shape in which one end thereof is connected to the first portion 63 and another end 68a thereof is a free end. Hereinafter, the free end 68a is sometimes referred to as distal end of the elastic piece 68. An end portion of the elastic piece 68 on the side connected to the first portion 63 is sometimes referred to as proximal end. The elastic piece 68 is provided such that the direction from the proximal end to the distal end 68a thereof is oblique to the operating direction E1 of the fixing member 60 (direction of the center line L4). The pair of elastic pieces 68 are provided so as to oppose each other with an interval in a direction perpendicular to the operating direction E1. The pair of elastic pieces 68 oppose each other with an interval in the same direction as the longitudinal direction of the first portion 63. This interval gradually increases toward the same direction as the operating direction E1 (in other words, the direction opposite to the projecting direction of the first projecting portion 67).

Each elastic piece 68 is formed so as to be elastically deformable with the proximal end of the elastic piece 68 as a base point such that the interval between the pair of elastic pieces 68 is increased. When each elastic piece 68 becomes elastically deformed, the elastic piece 68 generates an elastic repulsive force that returns the elastic piece 68 to the original state.

Each elastic piece 68 biases the fixing member 60 (the body portion 61, the first projecting portion 67, etc.) in the direction opposite to the operating direction E1 (in other words, in the projecting direction of the first projecting portion 67) in a state where the fixing member 60 is assembled to the base 500. Specifically, as shown in FIG. 16 and FIG. 17, each elastic piece 68 is provided in a space 506a (hereinafter, sometimes referred to as elastic piece housing space) between an end surface 507 located at the end in the same direction as the operating direction E1 and the fitting hole-forming portion 504 in the housing space 506 of the base 500 in an assembled state to the base 500. At this time, the distal end 68a of the elastic piece 68 is in contact with the end surface 507. In addition, the interval between the pair of elastic pieces 68 in a state where the first portion 63 of the body portion 61 is in contact with the fitting hole-forming portion 504 (state in FIG. 16 and FIG. 17) is slightly larger than the interval therebetween in a natural state before the fixing member 60 is assembled to the base 500. That is, the elastic piece 68 biases the fixing member 60 in the direction opposite to the operating direction E1 (in the direction in which the first projecting portion 67 is caused to project into the fitting space 502) by the reaction force, from the end surface 507, due to the elastic repulsive force thereof.

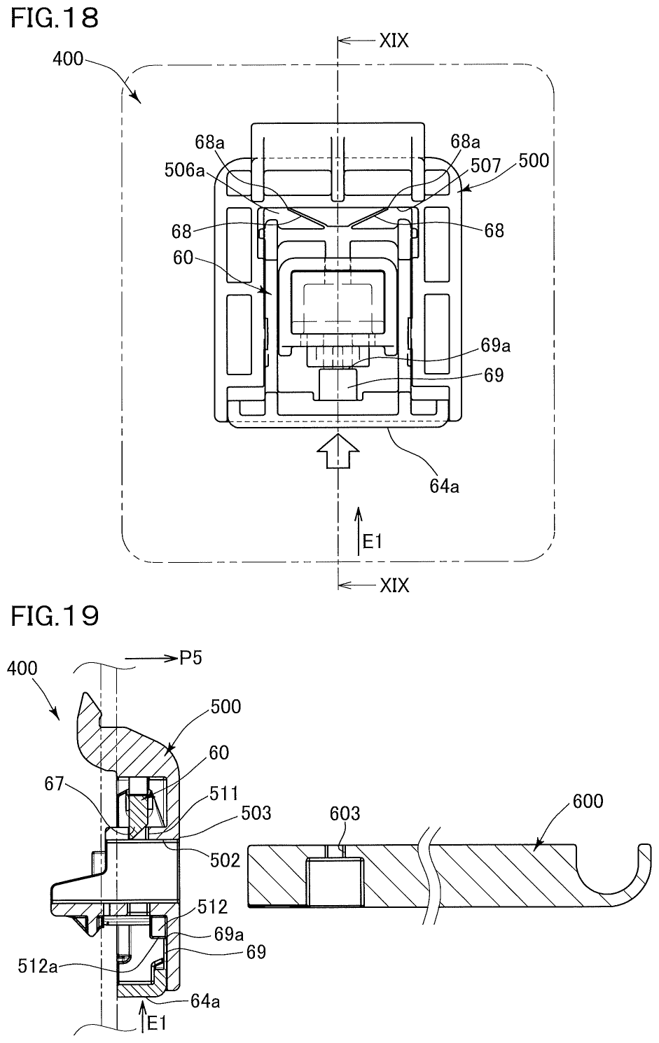

When an external force in the operating direction E1 is applied to the fixing member 60, each elastic piece 68 becomes elastically deformed such that the interval between the pair of elastic pieces 68 is further increased from the state in FIG. 16 (see FIG. 18). At this time, the distal end 68a of the elastic piece 68 moves in the direction in which the interval between the pair of elastic pieces 68 is increased (direction perpendicular to the operating direction E1) while being in contact with (sliding on) the end surface 507 of the elastic piece housing space 506a. Accordingly, movement of the fixing member 60 in the operating direction E1 is permitted. In addition, movement of the first projecting portion 67 to the position at which the first projecting portion 67 is withdrawn from the fitting space 502 is permitted (see FIG. 19).

When the external force in the operating direction E1 is then released, the elastic piece 68 returns to the state in FIG. 16 and FIG. 17 by the reaction force, from the end surface 507, due to the elastic repulsive force thereof. When the elastic piece 68 returns from the state in FIG. 18 and FIG. 19 to the state in FIG. 16 and FIG. 17 as well, the distal end 68a of the elastic piece 68 moves in a direction in which the interval between the pair of elastic pieces 68 is decreased, while being in contact with (sliding on) the end surface 507.

As shown in FIG. 21, the elastic piece 68 has two sides 68b and 68c which extend in a straight manner in the extension direction from the proximal end to the distal end 68a thereof. These sides 68b and 68c are provided parallel to each other. The elastic piece 68 has a tapered portion 68d on the distal end side of one side 68b. The tapered portion 68d is provided so as to connect the side 68c and the distal end 68a obliquely with respect to the extension direction of the elastic piece 68. That is, the tapered portion 68d is formed in a shape in which the tapered portion 68d gradually approaches the side 68c on the opposite side as approaching the distal end 68a. The tapered portion 68d is formed in each of the pair of elastic pieces 68.

The tapered portion 68d is formed at the side 68b on the above forward direction E2 side. No tapered portion is formed at the side 68c on the reverse direction E3 side. That is, the side 68c and the distal end 68a are connected to each other at a right angle.

The fixing member 60 includes the second projecting portion 69 which projects from the second portion 64 of the body portion 61 toward the cavity 62 side (in the same direction as the operating direction E1) (see FIG. 20 and FIG. 22). The second projecting portion 69 is located on the side opposite to the first projecting portion 67 and the elastic pieces 68 when viewed from the cavity 62. In other words, the second projecting portion 69 is provided at a position where the cavity 62 is interposed between the second projecting portion 69, and the first projecting portion 67 and the elastic pieces 68. The second projecting portion 69 is provided at an intermediate position in the longitudinal direction of the second portion 64. The second projecting portion 69 serves as an excessive movement prevention portion that prevents excessive movement of the fixing member 60 in the operating direction E1. In other words, the second projecting portion 69 serves as an excessive deformation prevention portion that prevents excessive deformation of the elastic piece 68. That is, the second projecting portion 69 permits the fixing member 60 to move by a predetermined amount in the operating direction E1, but prohibits the fixing member 60 to move by an amount exceeding the predetermined amount.

Specifically, as shown in FIG. 17, a distal end 69a, in the projecting direction from the second portion 64, of the second projecting portion 69 is provided at a position opposing a portion 512 of the base 500 in the same direction as the operating direction E1 with an interval in a state where the fixing member 60 is assembled to the base 500 and a state where no operation in the operating direction E1 is performed. This interval is smaller than the width of the elastic piece 68 in the direction parallel to the operating direction E1.

Movement of the fixing member 60 in the operating direction E1 is permitted until the distal end 69a and the portion 512 come into contact with each other, and movement of the fixing member 60 in the operating direction E1 is prohibited when the distal end 69a and the portion 512 come into contact with each other.

As shown in FIG. 22, the second projecting portion 69 includes a surface 69b facing in the above forward direction E2, and a surface 69c facing in the reverse direction E3. These surfaces 69b and 69c are parallel to each other. In addition, the surfaces 69b and 69c are parallel to the center line L4. The thickness between these surfaces 69b and 69c is set to be small (e.g., 1 mm or less). This thickness is set to a thickness that, when an external force in the thickness direction (direction E2 or direction E3) is applied to the second projecting portion 69, allows the second projecting portion 69 to become flexurally deformed (elastically deformed) in the direction of the external force (direction E2 or direction E3) with the connection portion between the second projecting portion 69 and the second portion 64 as a base point.

The thickness between the surfaces 69b and 69c is also set to a thickness with which the second projecting portion 69 does not bend or the bending of the second projecting portion 69 is minute even when an external force in the direction opposite to the projecting direction of the second projecting portion 69 (reaction force from the portion 512 (see FIG. 19) of the base 500) acts on the distal end 69a of the second projecting portion 69.

The thickness between the surfaces 69b and 69c is also smaller than the width (projecting amount), in the projecting direction from the second portion 64, of the second projecting portion 69. In addition, the thickness between the surfaces 69b and 69c is smaller than the width in the direction perpendicular to both the projecting direction and the thickness direction of the second projecting portion 69 (width of the second projecting portion 69 in the longitudinal direction of the second portion 64).

As described above, the second projecting portion 69 is formed so as to be flexurally deformable (elastically deformable) in a direction crossing the projecting direction of the second projecting portion 69, specifically, in the above small thickness direction (the above direction E2 or direction E3), with the connection portion between the second projecting portion 69 and the second portion 64 as a base point. When the external force that flexurally deforms the second projecting portion 69 is released, the second projecting portion 69 returns to the original state (state in FIG. 22).

The one surface 69b of the second projecting portion 69 is supported by a portion 510 (inner surface of the housing space 506) of the base 500 in a state of being assembled to the base 500 (see FIG. 17). At this time, the entire surface 69b is in contact with the portion 510. Accordingly, the bending of the second projecting portion 69 is suppressed when the distal end 69a comes into contact with the portion 512 of the base 500.

As shown in FIG. 20, a recess 64c is formed on an end portion 64b of the second portion 64 on the cavity 62 side so as to be recessed on the operation surface 64a side. The recess 64c is formed at the center in the longitudinal direction of the second portion 64. The second projecting portion 69 projects from the recess 64c toward the cavity 62 side. According to this, the distal end 69a of the second projecting portion 69 can be inhibited from being excessively close to the center side of the cavity 62. Thus, when the fixing member 60 is assembled to the base 500, the amount of interference between the second projecting portion 69 and a portion of the base 500 can be reduced. In addition, the projecting amount of the second projecting portion 69 can be increased as compared to the case where there is no recess 64c. Therefore, when the second projecting portion 69 interferes with a portion of the base 500 during assembly, it is easier to flexurally deform the second projecting portion 69.

The fixing member 60 includes projection portions 70 which project from the third portion 65 and the fourth portion 66 of the body portion 61, respectively (see FIG. 20 and FIG. 21). Each projection portion 70 projects from the third portion 65 or the fourth portion 66 in a direction away from the center line L4 and parallel to the direction in which the pair of elastic pieces 86 oppose each other (in other words, the longitudinal direction of the first portion 63). The projection portion 70 is formed at a position closer to the first portion 63 in the longitudinal direction of the third portion 65 or the fourth portion 66 than to the second portion 64. Specifically, the projection portion 70 is located on the longitudinal direction of the first portion 63 when viewed in a plan view in FIG. 20.

Furthermore, as shown in FIG. 21, the projection portion 70 of the third portion 65 is provided at a position closer to the end portion 65c on the reverse direction E3 side than to the end portions 65a and 65b of the third portion 65 on the forward direction E2 side. More specifically, the projection portion 70 is provided at a position adjacent to the end portion 65c on the reverse direction E3 side. In addition, the projection portion 70 is provided at a position spaced from the end portions 65a and 65b on the forward direction E2 side in the reverse direction E3. The projection portion 70 of the fourth portion 66 is provided in the same manner as the projection portion 70 of the third portion 65.

Each projection portion 70 serves as an assembly guide portion for, when the fixing member 60 is rotationally assembled to the base 500, entering a recess 513 (see FIG. 27 and FIG. 29) of the base 500 described later and guiding (assisting) the rotational movement of the fixing member 60 together with the recess 513. In addition, the projection portion 70 serves as a reverse assembly prevention portion that, when an attempt is made to assemble the fixing member 60 into the housing space 506 of the base 500 such that the fixing member 60 is directed in the reverse direction E3, interferes with the recess 513 of the base 500, thereby preventing the reverse assembly of the fixing member 60.

(Configuration of Base 500)

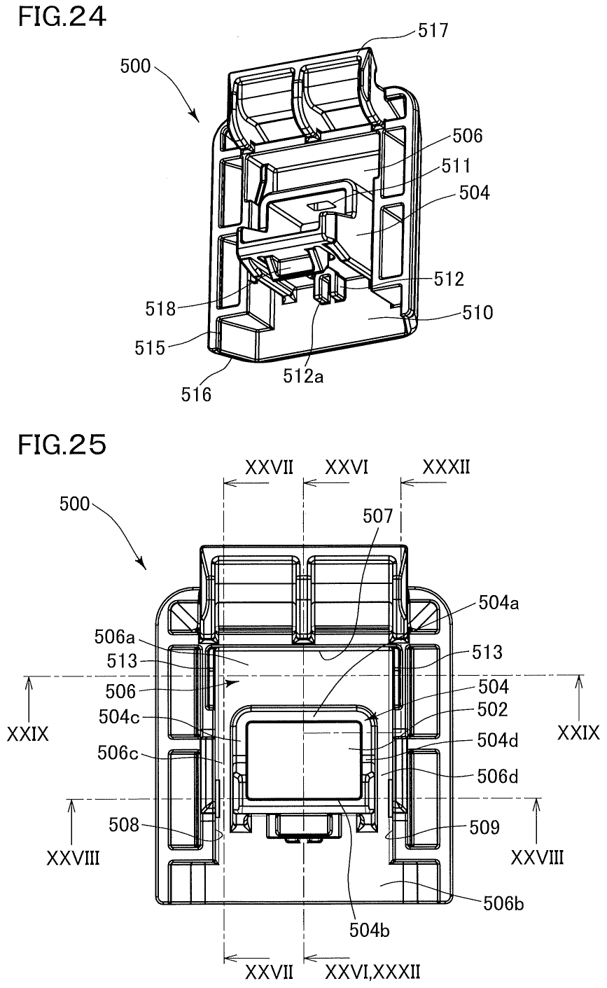

Next, the base 500 will be described. The base 500 is a member to which the fixing member 60 is assembled and which is for supporting the fixing target member 600. The base 500 is made of a synthetic resin, for example. As shown in FIG. 15 and FIG. 17, the base 500 is supported, for example, by an interior member 550 of the vehicle. The base 500 has engagement portions 517 and 518 which engage the interior member 550 (see FIG. 24 and FIG. 17). As shown in FIG. 17, the interior member 550 has a plate shape, for example, and has a hole 551 for fitting the base 550. The engagement portions 517 and 518 enter the back side of the interior member 550 through the hole 551 and engage the back surface of the interior member 500. The hole 551 of the interior member 550 is hidden by a front surface 501 of the base 500. The engagement portions 517 and 518 are formed on the back side of the base 500 (the housing space 506 side of the fixing member 60). The engagement portion 518 is located on the trajectory of the second projecting portion 69 of the fixing member 60 when the fixing member 60 is rotationally assembled to the base 500.

As shown in FIG. 24 to FIG. 26, the base 500 has the fitting hole-forming portion 504 which forms the fitting hole 502 for fitting the fixing target member 600. The fitting hole-forming portion 504 forms an opening 503 of the fitting hole 502 in the front surface 501 of the base 500. In addition, the fitting hole-forming portion 504 is formed so as to project from the back surface of the base 500 (surface on the side opposite to the front surface 501) toward the back side. The front surface 501 is provided so as to be exposed to the inside of the vehicle cabin, for example, that is, so as to be viewable by the user.

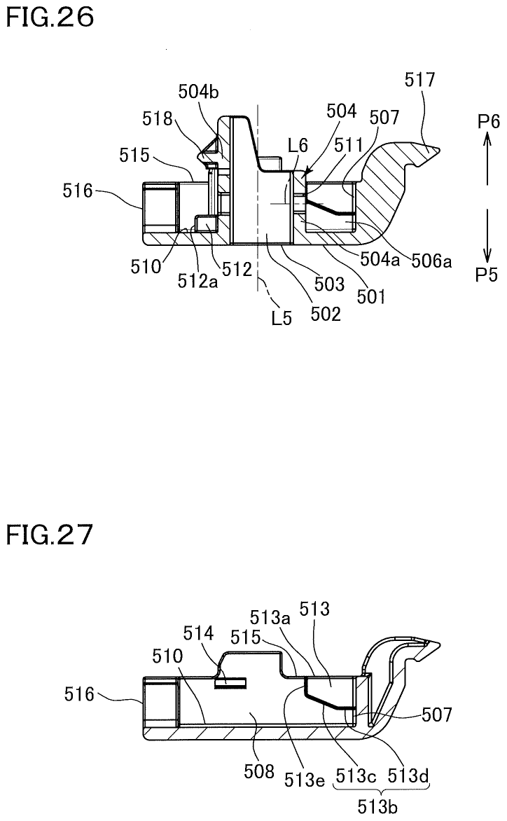

The mounting hole 511 for fitting the first projecting portion 67 (see FIG. 20, etc.) of the fixing member 60 is formed in the fitting hole-forming portion 504 (see FIG. 26). The mounting hole 511 is formed so as to penetrate between the fitting space 502 and the elastic piece housing space 506a for housing the elastic pieces 68. A center line L6 of the mounting hole 511 is directed in a direction perpendicular to a center line L5 of the fitting hole 502 (the pulling-out direction P5 from the fitting hole 502 or the insertion direction P6 into the fitting hole 502). Hereinafter, the center line L6 of the mounting hole 511 is sometimes referred to as base center line.

The fitting hole-forming portion 504 is formed in substantially a quadrangular frame shape when viewed in the direction of FIG. 25. The fitting hole-forming portion 504 has a first portion 504a forming the upper side of the quadrangular shape, a second portion 504b forming the lower side of the quadrangular shape, a third portion 504c forming the left side of the quadrangular shape, and a fourth portion 504d forming the right side of the quadrangular shape when viewed in FIG. 25. The first portion 504a forms the space 506a (elastic piece housing space) for housing the elastic pieces 68 and the first portion 63 of the body portion 61, between the first end surface 507 of the housing space 506 described later and the first portion 504a. The first portion 504a serves as a pull-out prevention portion that comes into contact with the first portion 63 of the body portion 61 in a state where the fixing member 60 is assembled, thereby preventing the fixing member 60 from being pulled out in the direction opposite to the operating direction E1 (see FIG. 16). The mounting hole 511 is formed in the first portion 504a.

The third portion 504c of the fitting hole-forming portion 504 forms a space 506c for housing the third portion 65 of the body portion 61, between the third portion 504c and a second end surface 508 of the housing space 506 described later. The fourth portion 504d forms a space 506d for housing the fourth portion 66 of the body portion 61, between the fourth portion 504d and a third end surface 509 of the housing space 506 described later.

The base 500 forms the housing space 506 for housing the fixing member 60, on the back side thereof. The housing space 506 is formed in a space surrounding the fitting hole-forming portion 504. In addition to the above spaces 506a, 506c, and 506d, the housing space 506 has a space 506b below the fitting hole-forming portion 504 in the drawing sheet of FIG. 25. The space 506b is a space for housing the second projecting portion 69 of the above-described fixing member 60, etc.

The side of the housing space 506 in the insertion direction P6 into the fitting hole 502 is open and connected to the outer space. That is, the base 500 forms an opening 515 (see FIG. 24 and FIG. 26) of the housing space 506 on the back side thereof. Hereinafter, the opening 515 is sometimes referred to as back side opening. In addition, the side of the housing space 506 in the direction from the mounting hole 511 to the fitting hole 502 in the direction of the base center line L6 (lower side in the drawing sheets of FIG. 25 and FIG. 26) is open and connected to the outer space. That is, the base 500 forms an opening 516 (see also FIG. 24) of the housing space 506 on the lower side in the drawing sheets of FIG. 25 and FIG. 26. The opening 516 is an opening for exposing the operation surface 64a from the base 500. Hereinafter, the opening 516 is sometimes referred to as operation portion opening. The back surface opening 515 and the operation portion opening 516 are continuous with each other.

The housing space 506 is closed except for the openings 515 and 516. That is, the base 500 has the first end surface 507 on the side of the housing space 506 in the direction from the fitting hole 502 to the mounting hole 511 in the direction of the base center line L6 (upper side in the drawing sheets of FIG. 25 and FIG. 26). The first end surface 507 is formed as a flat surface perpendicular to the base center line L6. The first end surface 507 forms the elastic piece housing space 506a, between the fitting hole-forming portion 504 and the first end surface 507. In addition, the first end surface 507 is a surface with or on which the distal end 68a of each elastic piece 68 is brought into contact or caused to slide when the fixing member 60 is housed in the housing space 506.

The base 500 has the second end surface 508 on one side of the housing space 506 in a direction perpendicular to both the center line L5 of the fitting hole 502 and the base center line L6 (the left side in the drawing sheet of FIG. 25). The second end surface 508 forms the space 506c for housing the third portion 65 of the body portion 61, between the fitting hole-forming portion 504 and the second end surface 508. The second end surface 508 also serves as a movement restriction surface that restricts movement of the fixing member 60 in the leftward direction in the drawing sheet of FIG. 25.

The base 500 has the third end surface 509 on the other side of the housing space 506 in the direction perpendicular to both the center line L5 of the fitting hole 502 and the base center line L6 (right side in the drawing sheet of FIG. 25). The third end surface 509 forms the space 506d for housing the fourth portion 66 of the body portion 61, between the fitting hole-forming portion 504 and the third end surface 509. The third end surface 509 also serves as a movement restriction surface that restricts movement of the fixing member 60 in the rightward direction in the drawing sheet of FIG. 25.

The base 500 has a fourth end surface 510 of the housing space 506 on the pulling-out direction P5 side (see FIG. 26). The fourth end surface 510 is formed as a surface perpendicular to the center line L5 of the fitting hole 502. The fourth end surface 510 serves as a movement restriction surface that restricts movement of the fixing member 60 in the pulling-out direction P5. The fourth end surface 510 also serves as a support portion that supports the one surface 69b of the second projecting portion 69 of the fixing member 60 as shown in FIG. 17.

The base 500 has the projection portion 512 which projects from the fourth end surface 510 into the housing space 506 (see FIG. 24 and FIG. 26). The projection portion 512 is formed at a position between the fitting hole-forming portion 504 and the operation portion opening 516. In this embodiment, the projection portion 512 is formed so as to project from the second portion 504b of the fitting hole-forming portion 504 toward the operation portion opening 516. Distal ends 512a (see FIG. 26), in the projecting direction from the second portion 504b toward the operation portion opening 516, of the projection portion 512 are formed as surfaces perpendicular to the base center line L6.

As shown in FIG. 17 and FIG. 19, the projection portion 512 is provided at a position opposing the second projecting portion 69 of the fixing member 60 in a direction parallel to the base center line L6 (in other words, in the operating direction E1 of the operation surface 64a) in a state where the fixing member 60 is assembled to the base 500. At this time, in the state in FIG. 17 in which no external force in the operating direction E1 acts, there is an interval between the projection portion 512 and the second projecting portion 69. In addition, in the state in FIG. 19 in which the fixing member 60 has moved to the maximum extent in the operating direction E1, the distal ends 512a of the projection portion 512 are in contact with the distal end 69a of the second projecting portion 69. As described above, the projection portion 512 serves as an excessive movement prevention portion that prevents excessive movement of the fixing member 60 in the operating direction E1 together with the second projecting portion 69. In other words, the projection portion 512 serves as an excessive deformation prevention portion that prevents excessive deformation of the elastic pieces 68.

The base 500 has the recess 513 (see FIG. 25, FIG. 27, and FIG. 29). The recess 513 is formed on each of end surfaces 508 and 509 (see FIG. 29) on the sides of the housing space 506 in the direction perpendicular to both the fitting hole center line L5 and the base center line L6. Each recess 513 is formed on the first end surface 507 (elastic piece housing space 506a) side of the end surface 508 or 509 with respect to the fitting through hole-forming portion 504 (see FIG. 25). More specifically, each recess 513 is formed so as to be connected to the first end surface 507 (see FIG. 27). The recess 513 is formed in a shape connected to the back side opening 515. The recess 513 extends from a connection portion 513a, which forms a part of the back side opening 515, toward the fourth end surface 510 of the housing space 506, and forms a bottom portion 513b (step portion) on the fourth end surface 510 side. As shown in FIG. 27, the bottom portion 513b includes an inclined portion 513c which gradually approaches the fourth end surface 510 as approaching the first end surface 507 of the housing space 506, and a parallel portion 513d which is located closer to the first end surface 507 than the inclined portion 513c is and extends in the direction parallel to the base center line L6. The parallel portion 513d is formed so as to be parallel to the fourth end surface 510. The parallel portion 513d is formed so as to connect the inclined portion 513c and the first end surface 507. The recess 513 includes a step portion 513e which connects the inclined portion 513c and the connection portion 513a.

The recess 513 is a portion for, when the fixing member 60 is rotated and assembled while being inserted into the housing space 506 of the base 500 in an oblique direction, receiving the projection portion 70, which is located on the assembly distal end side of the fixing member 60, and assisting (guiding) the rotational assembly of the fixing member 60. In particular, the bottom portion 513b serves as an assembly guide portion with which the projection portion 70 is brought into contact when the fixing member 60 is assembled, thereby guiding the projection portion 70 along the extension direction of the bottom portion 513b.

The bottom portion 513b also serves as a reverse assembly prevention portion that prevents the fixing member 60 from being assembled to the base 500 in the above reverse direction E3. Specifically, when an attempt is made to reversely assemble the fixing member 60, the projection portion 70 of the fixing member 60 interferes with the bottom portion 513b, whereby the fixing member 60 cannot be housed in the housing space 506.

The base 500 has the engagement projection 514 which engages the portion 65d (see FIG. 21) of the fixing member 60 housed in the housing space 506, thereby preventing the fixing member 60 from being detached from the base 500 (see FIG. 27 and FIG. 28). The engagement projection 514 is formed in a shape in which the engagement projection 514 projects from each of the second and third end surfaces 508 and 509 of the housing space 506 into the housing space 506. As shown in FIG. 27, the engagement projection 514 is formed at a position closer to the operation portion opening 516 than the above-described recess 513 is. In addition to the function of preventing the fixing member 60 from being pulled out from the base 500, the engagement projection 514 also has a function of assisting (guiding) rotational assembly of the fixing member 60. That is, when the fixing member 60 is rotationally assembled, each recess 71 of the fixing member 60 is fitted to the engagement projection 514, whereby the rotational assembly of the fixing member 60 is guided. As shown in FIG. 28, the engagement projection 514 also includes a first surface 514a facing upward in the drawing sheet of FIG. 28, and a second surface 514b facing downward in the drawing sheet of FIG. 28. The first surface 514a is formed as an inclined surface that faces toward the back surface opening 515 (see FIG. 27, etc.) of the housing space 506 and gradually approaches the second surface 514b as advancing toward the distal end, in the projecting direction from the second or third end surface 508 or 509, of the engagement projection 514. The first surface 514a is formed as a guide surface that guides a portion of the fixing member 60 to go over the engagement projection 514 when the fixing member 60 is assembled to the base 500. Meanwhile, the second surface 514b is formed as a prevention surface that faces toward the bottom surface 510 (see FIG. 27, etc.) of the housing space 506 and prevents the fixing member 60 from being pulled out from the base 500. The second surface 514b is formed as a surface perpendicular to the direction in which the fixing member 60 is pulled out from the base 500 (the direction from the bottom surface 510 of the housing space 506 to the back surface opening 515, the upward direction in the drawing sheet of FIG. 28).

(Configuration of Fixing Target Member 600)

Next, the fixing target member 600 will be described with reference to FIG. 17 and FIG. 18. The fixing target member 600 is made of a synthetic resin, for example, and is a member that provides a predetermined function to the user. Specifically, the fixing target member 600 is formed in the same manner as the fixing target member 300 of the first embodiment, that is, has a hook portion 601 on which an object can be hooked, and a fitting portion 602 which is fitted into the fitting hole 502 of the base 500. The hook portion 601 is provided so as to project from a front surface opening 503 of the base 500, for example, in the horizontal direction, and be exposed to the outside of the base 500 (the inside of the vehicle cabin).

The fitting portion 602 has an engagement portion 603 for engaging the first projecting portion 67 of the fixing member 60. The engagement portion 603 is formed as a hole for inserting the first projecting portion 67. In the state in FIG. 17 in which the first projecting portion 67 has entered the hole 603, the fixing target member 600 is fixed to the base 500. In this state, movement of the fixing target member 600 in the direction P5 is restricted. In the state in FIG. 19 in which the first projecting portion 67 has come out from the hole 603, movement of the fixing target member 600 in the direction P5 is permitted. As a result, the fixing target member 600 can be pulled out from the base 500.

(Method for Assembling Fixing Member 60)

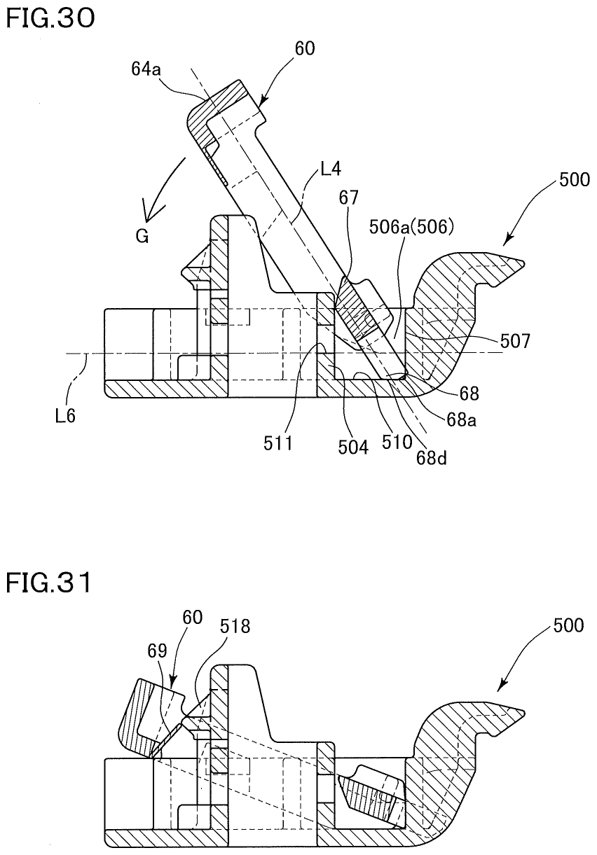

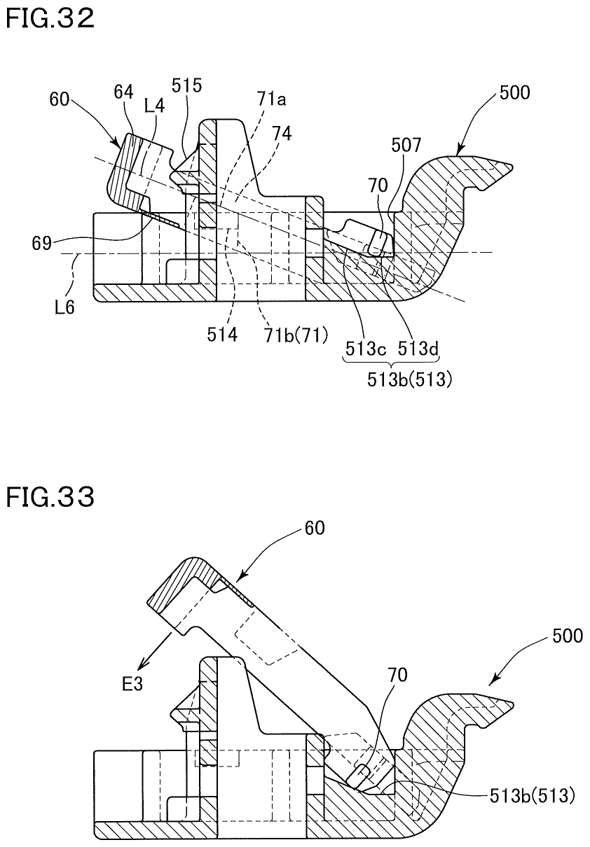

Next, a method for assembling the fixing member 60 to the base 500 will be described with reference to FIG. 30 to FIG. 33. The fixing member 60 in FIG. 30 and FIG. 31 is shown in a cross-section along a line XXII-XXII in FIG. 20. The base 500 in FIG. 30 and FIG. 31 is shown in a cross-section along a line XXVI-XXVI in FIG. 25. The fixing member 60 in FIG. 32 and FIG. 33 is shown in a cross-section along a line XXXII-XXXII in FIG. 20. The base 500 in FIG. 32 and FIG. 33 is shown in a cross-section along a line XXXII-XXXII in FIG. 25.

First, the orientation of the fixing member 60 is controlled such that the center line L4 of the fixing member 60 is inclined with respect to the base center line L6 at a position opposing the housing space 506 on the back side of the base 500. In this inclined state, the forward direction E2 (see FIG. 21) side of the fixing member 60 is directed toward the housing space 506. Furthermore, in this inclined state, each elastic piece 68 is directed toward the elastic piece housing space 506a of the housing space 506.

Then, the fixing member 60 in the above inclined state is put into the elastic piece housing space 506a from the elastic piece 68 side. At this time, the fixing member 60 is put into the housing space 506 obliquely until the distal end 68a of each elastic piece 68 comes into contact with the bottom surface 510 (fourth end surface) of the housing space 506 (see FIG. 30). As shown in FIG. 30, the direction of the fixing member 60 (direction of the center line L4) can be made oblique to the bottom surface 510 by bringing the tapered portion 68d of the distal end 68a of each elastic piece 68 into contact with the bottom surface 510.

When the distal end 68a of each elastic piece 68 comes into contact with the bottom surface 510, the operation surface 64a side, opposite to the oblique assembly direction, of the fixing member 60 is moved in a direction approaching the housing space 506, that is, a direction G (see FIG. 30) in which the direction of the center line L4 of the fixing member 60 approaches the direction of the base center line L6. At this time, each elastic piece 68 is kept in contact with the inner surface (the bottom surface 510 and the first end surface 507) of the elastic piece housing space 506a. In this manner, the fixing member 60 is rotated with the elastic piece 68 side as a rotation center until the center line L4 of the fixing member 60 is directed in the same direction as the base center line L6 (until the center lines L4 and L6 coincide with each other) (rotation step).

In the rotation step, with the center lines L4 and L6 kept in the same direction, the fixing member 60 is rotated while bending each elastic piece 68 in the housing space 506a in a direction in which the interval between the pair of elastic pieces 68 is increased, such that the first projecting portion 67 is located at a position facing the mounting hole 511 of the base 500. To locate the first projecting portion 67 at a position facing the mounting hole 511 of the base 500, it is necessary to locate the fixing member 60 at a more frontward position (closer to the first end surface 507 of the housing space 506). Therefore, in the rotation step, the fixing member 60 is rotated while being moved slightly frontward.

Moreover, in the rotation step, each projection portion 70, located on the distal end side in the oblique assembly direction, of the fixing member 60 is received in the recess 513 of the base 500. Then, the projection portion 70 is brought into contact with the bottom portion 513b of the recess 513. Then, the fixing member 60 is rotated such that the projection portion 70 moves along the bottom portion 513b (see FIG. 32). At this time, the projection portion 70 first moves along the inclined portion 513c (see also FIG. 27) of the bottom portion 513b and then moves along the parallel portion 513d (see also FIG. 27). As the projection portion 70 moves along the bottom portion 513b, the center line L4 of the fixing member 60 approaches the direction of the base center line L6.

Furthermore, in the rotation step, each recess 71, located on the proximal end side in the oblique assembly direction, of the fixing member 60 is temporarily fitted to the engagement projection 514 of the base 500. Then, the fixing member 60 is rotated such that the engagement projection 514 approaches the bottom portion 71a of the recess 71 while bringing the engagement projection 514 into contact with the first step portion 71b of the recess 71 (see FIG. 32). Accordingly, the center line L4 of the fixing member 60 approaches the direction of the base center line L6. The rotational guidance by each recess 71 and each engagement projection 514 and the rotational guidance by each projection portion 70 and each recess 513 may be performed simultaneously.

When the rotation of the fixing member 60 is advanced, each engagement projection 514 comes into contact with the bottom portion 71a of the recess 71 (see FIG. 32). The rotation of the fixing member 60 is further advanced from this state. Then, each engagement projection 514 goes over a portion 74 (see FIG. 32), adjacent to the bottom portion 71a of the recess 71, of the fixing member 60. In other words, the portion 74 of the fixing member 60 goes over the engagement projection 514. In this manner, each engagement projection 514 and each recess 71 are temporarily fitted to each other during assembly, and this fitting is cancelled when the assembly is completed.

During rotation of the fixing member 60, the second projecting portion 69 of the fixing member 60 comes into contact with the portion 518 (engagement portion) of the base 500. At this time, since the second projecting portion 69 is formed thinly, the second projecting portion 69 bends (see FIG. 31). Then, the second projecting portion 69 returns to the original state when the contact thereof with the portion 518 is released (see FIG. 32).

When the rotation of the fixing member 60 is advanced until the center line L4 of the fixing member 60 is directed in the same direction as the base center line L6, the fixing member 60 is housed in the housing space 506. In this state, outside the mounting hole 511 of the base 500, the first projecting portion 67 of the fixing member 60 faces the hole 511. Then, the fixing member 60 is moved in the direction opposite to the operating direction E1 (in the projecting direction of the first projecting portion 67), thereby fitting the first projecting portion 67 into the hole 511 and causing the first projecting portion 67 to project into the fitting space 502 of the base 500 (movement step). At this time, the distal end 68a of each elastic piece 68 slides on the end surface 507 of the housing space 506 in the direction in which the interval between the pair of elastic pieces 68 is decreased. In the movement step, the fixing member 60 may be moved only by the elastic repulsive force of each elastic piece 68, or an operation by the user in the direction opposite to the operating direction E1 may be added. Thus, the assembly of the fixing member 60 is completed.

As shown in FIG. 33, when an attempt is made to assemble the fixing member 60 to the base 500 such that the fixing member 60 is directed toward the reverse direction E3 side, the projection portion 70 of the fixing member 60 interferes with the step portion 513b of the recess 513 of the base 500, whereby the fixing member 60 cannot be assembled.

The fixing target member 600 may be assembled to the base 500 after the fixing member 60 is assembled to the base 500. In this case, the fitting portion 602 of the fixing target member 600 may be inserted into the fitting hole 502 through the front surface opening 503 of the base 500. At this time, a portion, located at the end in the direction of insertion into the base 500, of the fitting portion 602 comes into contact with the inclined surface 68b of the fixing member 60 projecting into the fitting hole 502, whereby the fixing member 60 moves in the same direction as the operating direction E1 against the elastic repulsive force of each elastic piece 68, and the first projecting portion 67 is withdrawn from the fitting hole 502. Then, when the fixing target member 600 moves to a position at which the mounting hole 603 of the fixing target member 600 is connected to the mounting hole 511 of the base 500, the fixing member 60 moves in the direction opposite to the operating direction E1 by the elastic repulsive force of each elastic piece 68, and the first projecting portion 67 is fitted into the mounting hole 603. Accordingly, the fixing target member 600 is fixed to the base 500. To pull out the fixing target member 600 from the base 500, the operation surface 64a may be pushed.

As described above, the same effects as those of the above first and second embodiments can be obtained in this embodiment. In addition, in this embodiment, the fixation between the base 500 and the fixing target member 600 can be released by a pushing operation. Moreover, excessive deformation of the elastic piece 68 can be suppressed by the second projecting portion 69 of the fixing member 60 and the projection portion 512 of the base 500. Since the excessive deformation prevention portions 69 and 512 are provided to both the fixing member 60 and the base 500, the projecting amount of the second projecting portion 69 toward the projection portion 512 side and the projecting amount of the projection portion 512 toward the second projecting portion 69 side can be reduced. Accordingly, during assembly of the fixing member 60, the amount by which the second projecting portion 69 interferes with a portion of the base 500 can be reduced, so that this interference can be cancelled in a short time. In addition, during assembly of the fixing member 60, the projection portion 512 can be inhibited from interfering with a portion of the fixing member 60.

During rotational assembly of the fixing member 60, each projection portion 70 of the fixing member 60 and each recess 513 of the base 500 are fitted to each other, whereby the rotational assembly of the fixing member 60 can be guided. Accordingly, the fixing member 60 can be easily assembled to the base 500. In particular, each projection portion 70 is first guided along the inclined portion 513c of the bottom portion 513b (see FIG. 27) of the recess 513 and then guided along the parallel portion 513d of the bottom portion 513b, whereby the fixing member 60 can be moved more frontward while being rotated. Accordingly, it can be easier to fit the first projecting portion 67 into the mounting hole 511 of the base 500.

During rotational assembly of the fixing member 60, each recess 71 of the fixing member 60 and each engagement projection 514 of the base 500 are fitted to each other, whereby the rotational assembly of the fixing member 60 can be guided. In particular, since the first step portion 71b (see FIG. 21) of each recess 71 is formed so as to be gradually displaced toward the operation surface 64a as advancing toward the bottom portion 71a, the fixing member 60 can be moved more frontward while being rotated, by sliding each engagement projection 514 along the first step portion 71b. Accordingly, it can be easier to fit the first projecting portion 67 into the mounting hole 511 of the base 500.

Since assembly guidance is performed on both the distal end side (each projection portion 70 and each recess 513) and the proximal end side (each recess 71 and each engagement projection 514) in the oblique assembly direction of the fixing member 60 to the base 500, rotational assembly is made even easier.

### Fourth Embodiment

Next, a fourth embodiment of this disclosure will be described focusing on the differences from the above embodiments. This embodiment is a modification of the third embodiment. In the third embodiment, the example in which the pair of elastic pieces 68 are provided on the side opposite to the operation portion 64a (the same side as the first projecting portion 67) in the frame-shaped body portion 61, is shown. In this embodiment, an example in which a pair of elastic pieces are provided on the same side as an operation portion (side opposite to a first projecting portion) in a frame-shaped body portion, is shown.

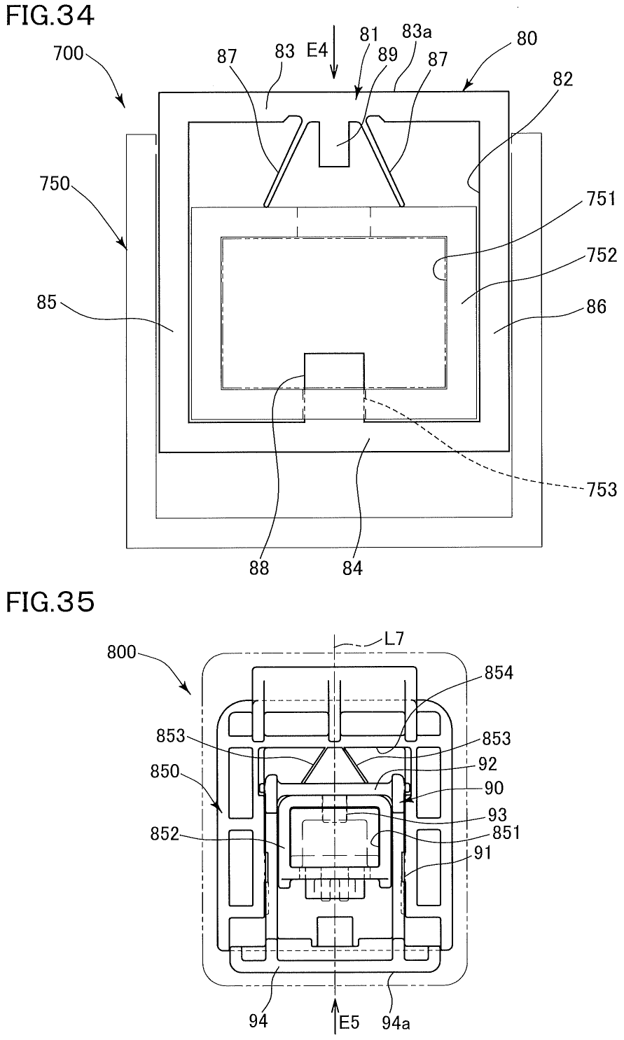

FIG. 34 shows a fixing structure 700 of this embodiment. The fixing structure 700 includes a base 750, a fixing target member (not shown) supported by the base 750, and a fixing member 80 for fixing the base 750 and the fixing target member to each other. FIG. 34 is a view from the back side of the base 750. The fixing member 80 includes a frame-shaped body portion 81, a pair of elastic pieces 87, a first projecting portion 88, and a second projecting portion 89.

The body portion 81 forms a cavity 82 therein. The body portion 81 includes a first portion 83 and a second portion 84 which oppose each other across the cavity 82. The body portion 81 also includes a third portion 85 and a fourth portion 86 which have a longitudinal direction perpendicular to the longitudinal directions of the first and second portions 83 and 84 and oppose each other across the cavity 82. An outer surface 83a of the first portion 83 is defined as an operation surface (operation portion) for performing a pushing operation in a direction E4.

The pair of elastic pieces 87 project from a surface of the first portion 83 on the side opposite to the operation surface 83a toward the cavity 82 side. The pair of elastic pieces 87 are formed in a stabilizer shape that is the same as that of the elastic pieces 68 of the third embodiment. That is, each elastic piece 87 is formed in a shape in which one end thereof is connected to the first portion 83 and another end thereof is a free end. The interval between the pair of elastic pieces 87 gradually increases toward the same direction as the operating direction E4. Each elastic piece 87 biases the fixing member 80 in a direction opposite to the operating direction E4 (in a direction in which the first projecting portion 88 is caused to project into a fitting hole 751 of the base 750).

The first projecting portion 88 is a portion having the same shape and the same function as the first projecting portion 67 of the third embodiment. The first projecting portion 88 projects from the fourth portion 84 toward the cavity 82 side. In a state where the operation surface 83a is not operated (state in FIG. 34), the first projecting portion 88 projects into the fitting hole 751 of the base 750. When the operation surface 83a is operated, the first projecting portion 88 is withdrawn from the fitting hole 751.

The second projecting portion 89 serves as an excessive deformation prevention portion that prevents excessive deformation of each elastic piece 87. The second projecting portion 89 projects from a position, between the pair of elastic pieces 87, on the first portion 83 toward the cavity 82 side. The projecting amount of the second projecting portion 89 from the first portion 83 is smaller than the projecting amount of each elastic piece 87 from the first portion 83 when the elastic piece 87 is in a natural state (state where the elastic piece 87 is not elastically deformed).

In a state where the operation surface 83a is not operated (state in FIG. 34), the second projecting portion 89 is located so as to be spaced apart from a fitting hole-forming portion 752 of the base 750. When the fixing member 80 moves in the operating direction E4, the second projecting portion 89 and the fitting hole-forming portion 752 come into contact with each other, thereby preventing excessive deformation of each elastic piece 87. The body portion 81 is provided so as to surround the fitting hole-forming portion 752 of the base 750. The configuration of the fixing member 80 other than the above is the same as that of the fixing member 60 of the third embodiment.

The base 750 has the fitting hole-forming portion 752 which forms the fitting hole 751 into which the fixing target member is fitted. The fitting hole-forming portion 752 is formed so as to project from the back side of the base 750. Amounting hole 753 into which the first projecting portion 88 is fitted is formed in the fitting hole-forming portion 752. The configuration of the base 750 other than the above is the same as that of the base 500 of the third embodiment. In addition, the fixing target member is the same as the fixing target member 600 of the third embodiment.

As described above, in this embodiment as well, the same effects as those of the third embodiment can be obtained.

### Fifth Embodiment

Next, a fifth embodiment of this disclosure will be described focusing on the differences from the above embodiments. In each of the above embodiments, the example in which each elastic piece (elastic deformation portion) is provided to the fixing member is shown. In this embodiment, an example in which each elastic piece is provided to an assembly counterpart member is shown. This embodiment is a modification of the third embodiment.

FIG. 35 shows a fixing structure 800 of this embodiment. The fixing structure 800 includes a base 850, a fixing target member (not shown) supported by the base 850, and a fixing member 90 for fixing the base 850 and the fixing target member to each other. FIG. 35 is a view from the back side of the base 850.

The fixing member 90 is different from the fixing member 60 of the third embodiment in that a pair of elastic pieces are not included, and is the same as the fixing member 60 except for this. That is, the fixing member 90 includes a frame-shaped body portion 91 and a first projecting portion 93 which projects from a first portion 92 of the body portion 91 toward a cavity side. An outer surface 94a of a second portion 94, of the body portion 91, opposing the first portion 92 across the cavity is defined as an operation surface on which a pushing operation is performed in a direction E5. The configuration of the fixing member 90 other than the above is the same as that of the fixing member 60 of the third embodiment.

The base 850 is different from the base 500 of the third embodiment in that a pair of elastic pieces 853 are included, and is the same as the base 500 except for this. The base 850 includes a fitting hole-forming portion 852 which forms a fitting hole 851 for fitting the fixing target member. The fitting hole-forming portion 852 projects on the back side of the base 850.

Each elastic piece 853 biases the first projecting portion 93 (corresponding to the first projecting portion 67 of the third embodiment) of the fixing member 90 in a direction in which the first projecting portion 93 is caused to project from the fitting hole 851 of the base (direction opposite to the operating direction E5). Each elastic piece 853 projects from an inner surface 854 of a housing section in which the fixing member 90 is housed. Each elastic piece 853 is formed in a shape in which one end thereof is connected to the inner surface 854 and another end thereof is a free end. A virtual straight line L7 passing through the middle between the pair of elastic pieces 853 is directed in a direction parallel to the projecting direction of the first projecting portion 93 of the fixing member 90. In addition, each elastic piece 853 is provided between the first portion 92 of the body portion 91 of the fixing member 90 and the inner surface 854 of the housing space opposing the first portion 92 in a state where the fixing member 90 is assembled.

The interval between the pair of elastic pieces 853 gradually increases toward the projecting direction thereof from the inner surface 854. The distal end of each elastic piece 853 is in contact with the first portion 92 of the fixing member 90.

As in the third embodiment, the pair of elastic pieces 853, the first projecting portion 93, and the operation surface 94a are located in this order from the upper side in the drawing sheet of FIG. 35. The above virtual straight line L7 and the center line of the first projecting portion 93 coincide with each other. The virtual straight line L7 is orthogonal to the operation surface 94a.

The configuration of the base 850 other than the above is the same as that of the base 500 of the third embodiment. In addition, the fixing target member is the same as the fixing target member 600 of the third embodiment.

As described above, in this embodiment as well, the same effects as those of the third embodiment can be obtained.

### Sixth Embodiment

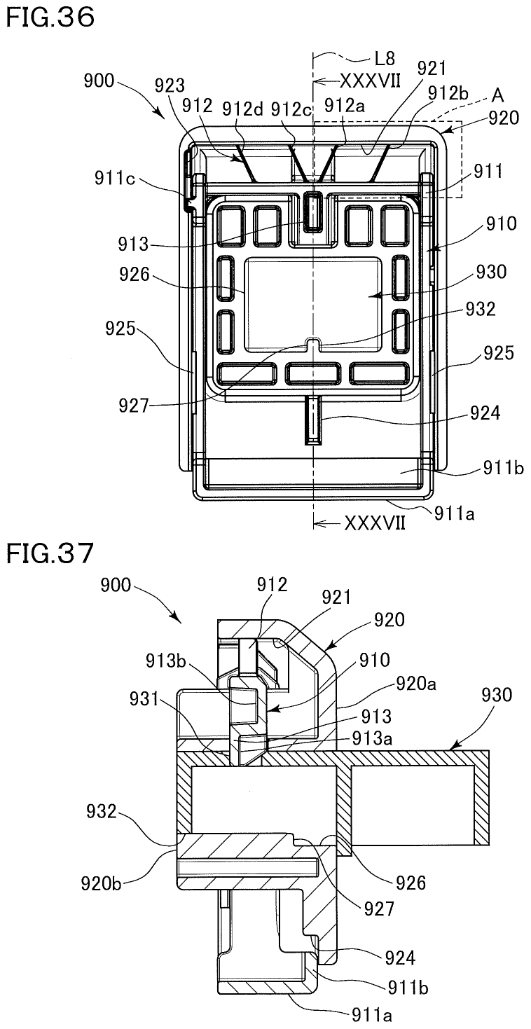

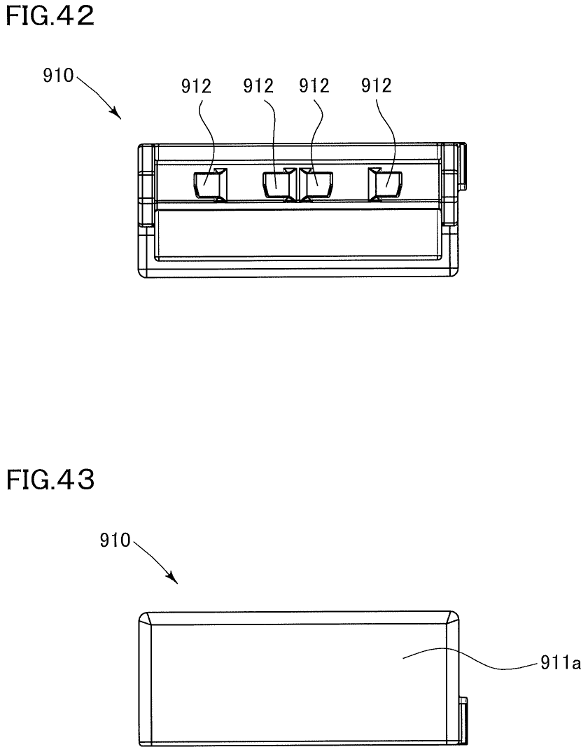

Next, a sixth embodiment of this disclosure will be described focusing on the differences from the above embodiments. A fixing structure 900 shown in FIG. 36 and FIG. 37 includes a fixing member 910, a base 920 to which the fixing member 910 is assembled, and a fixing target member 930 supported by the base 920. The fixing member 910 is formed in a frame shape as in the fixing member 60 of the third embodiment. That is, as shown in FIG. 36 to FIG. 43, the fixing member 910 includes a frame-shaped body portion 911, an elastic piece 912 supported by the body portion 911, and a projecting portion 913 as a prevention portion that prevents the fixing target member 930 from being pulled out from the base 920. These portions 911, 912, and 913 are formed integrally with each other, that is, are an integrally molded article.

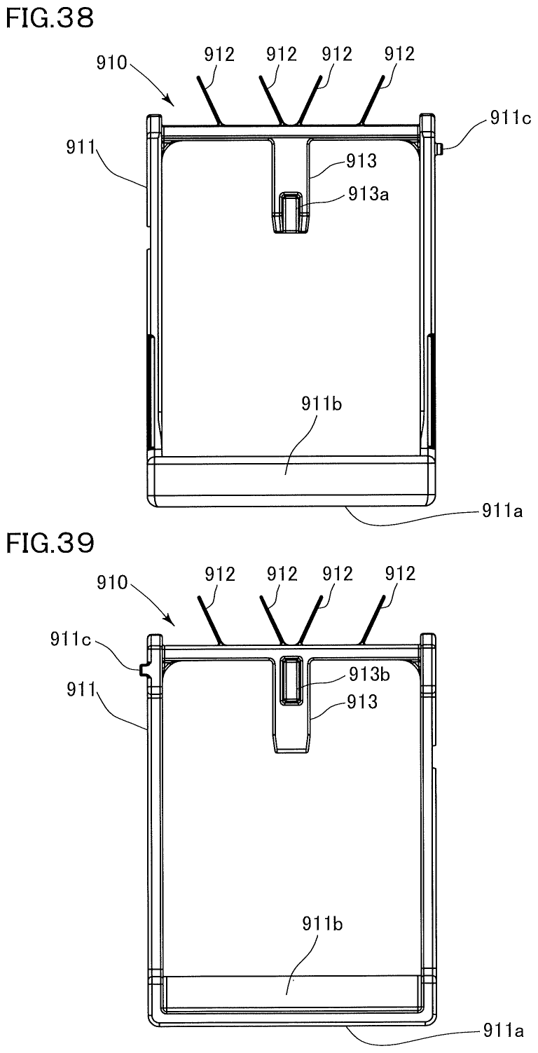

The body portion 911 has an operation portion 911a which is located at an end portion in a direction opposite to an operating direction of the fixing member 910 (the upper direction in the drawing sheets of FIG. 36 to FIG. 41), and a wall portion 911b which rises from the operation portion 911a toward the operating direction side of the fixing member 910. The wall portion 911b is provided so as to connect a left side portion and a right side portion of the body portion 9111. The distal end of the wall portion 911b serves as an excessive movement prevention portion (interference portion) that comes into contact (interferes) with a portion 924 of the base 920 when the fixing member 910 is operated, thereby preventing excessive movement of the fixing member 910 (excessive deformation of the elastic piece 912). Also, the body portion 911 has a projection portion 911c which is provided on the right side portion or the left side portion thereof. In the example of FIG. 38, the projection portion 911c is provided on the right side portion of the body portion 911, and is not provided on the left side portion of the body portion 911. However, the projection portion 911c may be provided on the left side portion instead of the right side portion, or may be provided on both the right side portion and the left side portion. As in the projection portion 70 of the third embodiment, the projection portion 911c serves as a reverse assembly prevention portion that prevents the fixing member 910 from being reversely assembled to the base 920.

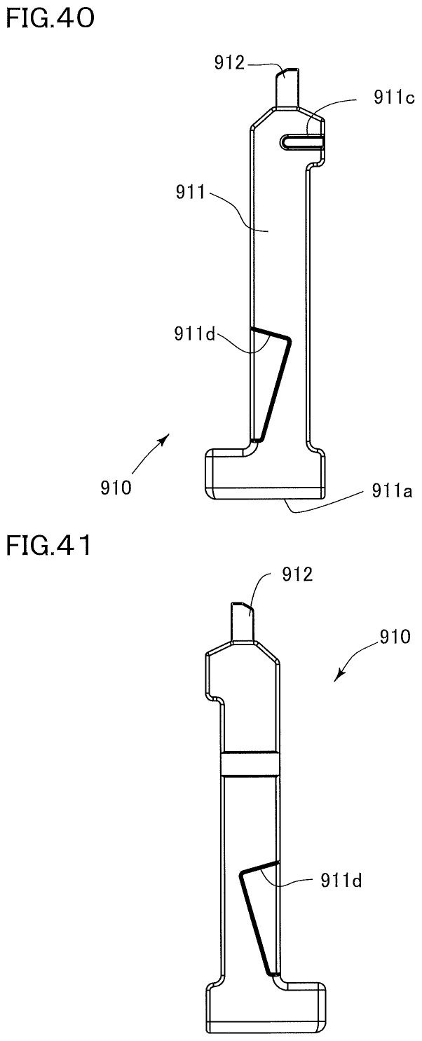

As shown in FIG. 40 and FIG. 41, the body portion 911 has a recess 911d on each of the right and left side portions. Each recess 911d is slightly different in shape from the recess 71 of the third embodiment but has the same function as the recess 71. That is, each recess 911d is a portion for, when the fixing member 910 is rotated and assembled while being inserted into the base 920 in an oblique direction, receiving an engagement projection 925 of the base 920 and assisting the rotational assembly of the fixing member 910.

The elastic piece 912 is different in number from the elastic pieces 68 of the third embodiment, and is formed in the same manner as the elastic pieces 68 except for this. The elastic piece 912 includes four elastic pieces 912a, 912b, 912c, and 912d. The two elastic pieces 912a and 912b are provided in a region on the right side with respect to a center line L8 of the body portion 911 in the drawing sheet of FIG. 36. The positions of the elastic pieces 912a and 912b gradually change in a first direction (the rightward direction in the drawing sheet of FIG. 36) perpendicular to the operating direction of the fixing member 910, from the proximal end toward the distal end thereof. The remaining two elastic pieces 912c and 912d are provided in a region on the left side with respect to the center line L8 of the body portion 911 in the drawing sheet of FIG. 36. The positions of the elastic pieces 912c and 912d gradually change in a second direction (the leftward direction in the drawing sheet of FIG. 36) perpendicular to the operating direction of the fixing member 910 and opposite to the first direction, from the proximal end toward the distal end thereof. The elastic pieces 912a and 912b on the right side with respect to the center line L8 and the elastic pieces 912c and 912d on the left side with respect to the center line L8 are formed in a shape that is line-symmetrical with respect to the center line L8. In addition, the number of elastic pieces 912a and 912b inclined in the first direction and the number of elastic pieces 912c and 912d inclined in the second direction are equal to each other.

Hereinafter, the elastic pieces 912a and 912c provided closer to the center line L8 are sometimes referred to as inner elastic pieces, and the elastic pieces 912b and 912d provided farther from the center line L8 are sometimes referred to as outer elastic pieces. The pair of inner elastic pieces 912a and 912c are provided such that the interval between the inner elastic pieces 912a and 912c gradually increases from the proximal end toward the distal end thereof. Similarly, the pair of outer elastic pieces 912b and 912d are provided such that the interval between the outer elastic pieces 912b and 912d gradually increases from the proximal end toward the distal end thereof. In addition, a line L8 bisecting the interval between the inner elastic pieces 912a and 912c and a line L8 bisecting the interval between the outer elastic pieces 912b and 912d coincide with each other.

As shown in FIG. 37, in a state where the operation portion 911a is not operated, the projecting portion 913 is fitted into a hole 931 of the fixing target member 930, thereby preventing the fixing target member 930 from being pulled out from the base 920. The projecting portion 913 is formed in the same manner as the projecting portion 67 of the third embodiment, except that recesses 913a and 913b (see FIG. 37 to FIG. 39) for thinning are formed.

The fixing member 910 does not have a portion corresponding to the flexurally deformable second projecting portion 69 of the third embodiment. The fixing member 910 is formed in the same manner as the fixing member 60 of the third embodiment except for the above.

As in the base 500 of the third embodiment, the base 920 forms a recess-like space (housing space for the fixing member 910) into which the fixing member 910 is assembled, on the back surface side thereof. As in the base 500 of the third embodiment, the base 920 has, on a wall surface of the recess-like space, a recess 923 which receives the projection portion 911c of the fixing member 910, a projection portion 924 as a prevention portion (interference portion) that prevents excessive movement of the fixing member 910 (excessive deformation of each elastic piece 912) during operation, and the engagement projection 925 which prevents the fixing member 910 from being pulled out from the recess-like space of the base 920 (see FIG. 36 and FIG. 37).

A fitting hole 926 for fitting the fixing target member 930 is formed in the base 920. The base 920 has a projection portion 927 on the inner surface of the fitting hole 926 (specifically, the lower surface of the fitting hole 926). The projection portion 927 is a portion that prevents the fixing target member 930 from being assembled upside down. In the example of FIG. 37, the fitting hole 926 is formed in a shape penetrating from a front surface 920a to a back surface 920b of the base 920, but may be formed in a shape in which the back surface 920b side is closed. According to this, the back side of the base 920 can be inhibited from being seen through the fitting hole 926. In addition, foreign matter such as water and dust can be inhibited from entering the back side of the base 920 through the fitting hole 926.

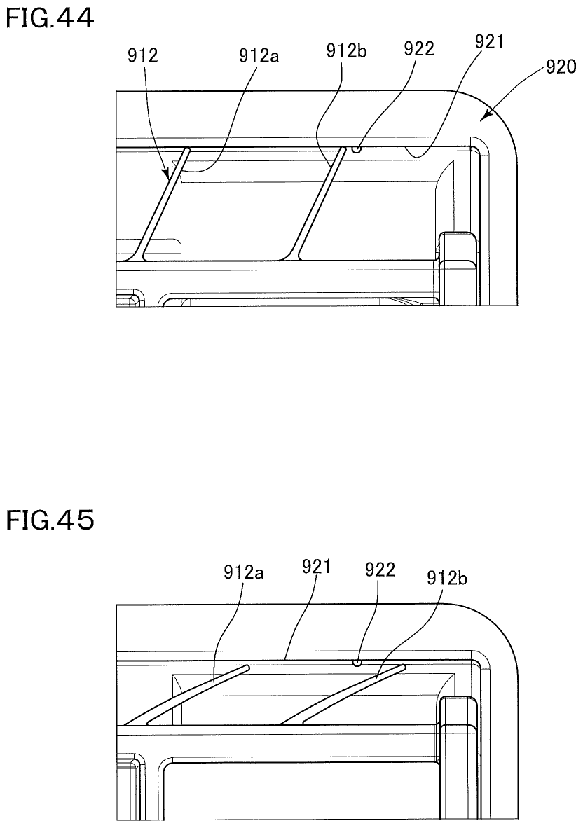

The base 920 has a surface 921 with which the distal end of each elastic piece 912 comes into contact. The surface 921 has a projection 922 as shown in FIG. 44. The projection 922 is a portion that interferes with the distal end of the elastic piece 912 sliding on the surface 921 and causes the distal end of the elastic piece 912 to go thereover when the operation portion 911a (see FIG. 36) of the fixing member 910 is pushed and operated in the upward direction in the drawing sheet of FIG. 36. The projection 922 is provided on a movement path of the distal end of the outer elastic piece 912b and 912d moved when the operation portion 911a is operated. The projection 922 is located on the outer side (side away from the center line L8) with respect to the outer elastic piece 912b and 912d in a state where the operation portion 911a is not operated (state in FIG. 44). In FIG. 44, the projection 922 for interfering with the outer elastic piece 912b is shown, but a projection (not shown) for interfering with the other outer elastic piece 912d is also provided. The distal ends of the outer elastic pieces 912b and 912d interfere with the projections 922 and then go over the projections 922 when the operation portion 911a is operated (see FIG. 45). In a state where the operation portion 911a is operated (state in FIG. 45), the projections 922 are located between the outer elastic pieces 912b and 912d and the inner elastic pieces 912a and 912c.

The timing when the outer elastic pieces 912b and 912d go over the projections 922 may be at or later than the moment when the projecting portion 913 shown in FIG. 37 becomes detached from the hole 931 of the fixing target member 930.

As described above, the outer elastic pieces 912b and 912d serve as going-over portions that interfere with and go over the projections 922 when the operation portion 911a is operated. The projections 922 serve as gone-over portions over which the outer elastic pieces 912b and 912d are caused to go. In addition, the body portion 911 serves as a transmission portion that transmits, to the operation portion 911a, a feeling (crisp feeling) generated when the outer elastic pieces 912b and 912d go over the projections 922.

In this embodiment, projections over which the inner elastic pieces 912a and 912c are caused to go are not provided, but may be provided instead of or in addition to the projections 922.

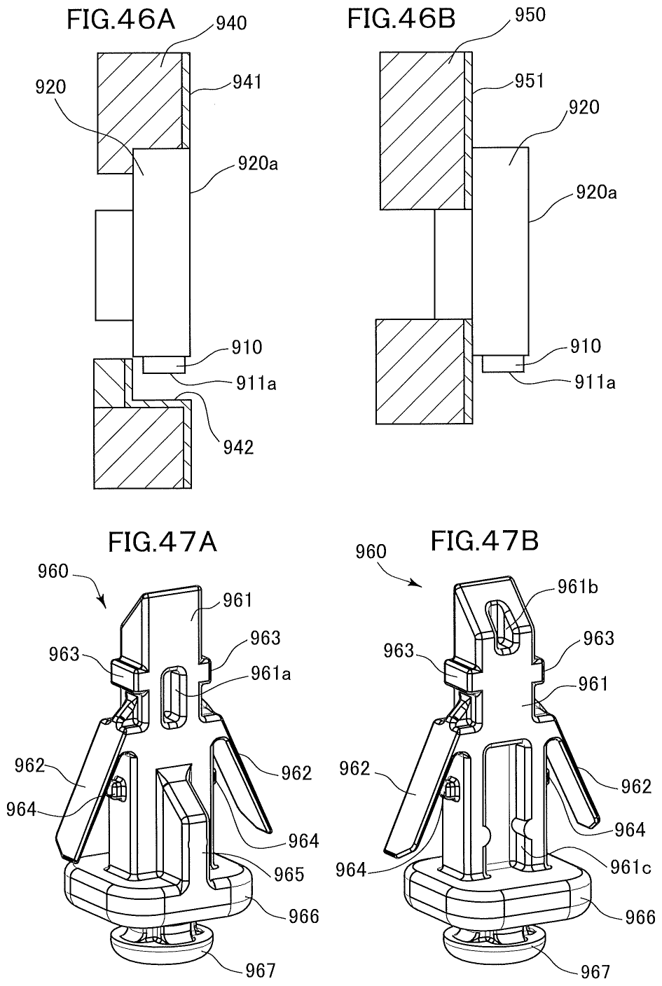

As shown in FIG. 46A or FIG. 46B, the base 920 may be formed integrally with a support member 940 or 950 (e.g., an interior member of a vehicle) which supports the base 920. That is, the base 920 and the support member 940 or 950 may be an integrally molded article. In the example of FIG. 46A, the front surface 920a of the base 920 and a surface 941 of the support member 940 are flush with each other. The support member 940 in FIG. 46A has a recess 942, formed on the surface 941, for inserting the operation portion 911a of the fixing member 910. The recess 942 is formed with a size that allows a finger of the user to be put therein.

In the example of FIG. 46B, the front surface 920a of the base 920 and the operation portion 911a of the fixing member 910 are provided at a position outside of a surface 951 of the support member 950. Since the base 920 is integral with the support member 940 or 950, the base 920 does not have portions corresponding to the engagement portions 517 and 518 (see FIG. 17) of the base 500 of the third embodiment. As in the base 500 of the third embodiment, the base 920 may be provided separately from the support member 940 or 950.

The base 920 is formed in the same manner as the base 500 of the third embodiment except for the above.

As shown in FIG. 36 and FIG. 37, the fixing target member 930 has a recess 932 for fitting the projection portion 927 of the base 920. The recess 932 is provided on the lower surface of the fixing target member 930. A recess into which the projection portion 927 of the base 920 can be fitted is not formed on the upper surface of the fixing target member 930. Accordingly, the fixing target member 930 is prevented from being assembled upside down.

The fixing target member 930 is the same as the fixing target member 300 of the first embodiment or the fixing target member 600 of the third embodiment except for the above.

According to this embodiment, the following effects are achieved in addition to the effects of the above first to fifth embodiments. Specifically, the outer elastic pieces 912b and 912d go over the projections 922 when the operation portion 911a is operated. When the outer elastic pieces 912b and 912d go over the projections 922, the operation load rises, and then falls. This load fall can produce a crisp feeling. In addition, it is also possible to generate a sound when the outer elastic pieces 912b and 912d go over the projections 922. Accordingly, the user is allowed to easily grasp that the projecting portion 913 has been detached from the hole 931 of the fixing target member 930, that is, the fixing target member 930 has become detachable from the base 920. In addition, since the crisp feeling can be produced, the operation portion 911a can be inhibited from being excessively pushed, and excessive deformation (loss of elasticity) of the elastic piece 912 can be suppressed.

Since the four elastic pieces 912 are provided, the elastic repulsive force of the elastic pieces 912 can be increased. Accordingly, it is easier to return the fixing member 910 to the original state (state in FIG. 36 and FIG. 37) by the elastic repulsive force of the elastic pieces 912 when the operation of the operation portion 911a is released.

### Seventh Embodiment

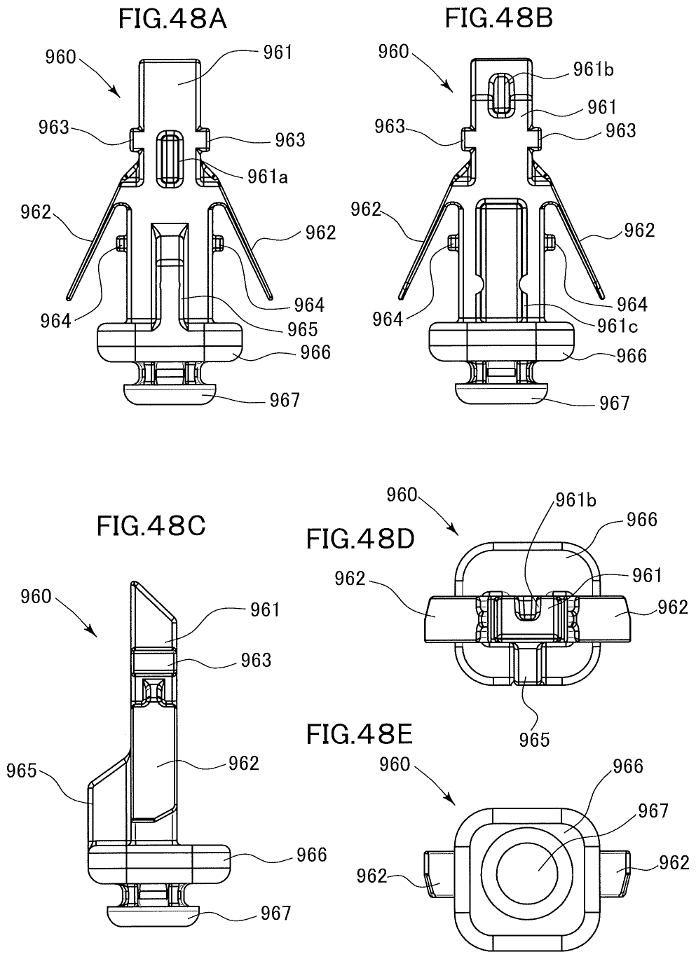

Next, a seventh embodiment of this disclosure will be described focusing on the differences from the above embodiments. This embodiment is a modification of the first embodiment. FIG. 47 and FIG. 48 show a fixing member 960 of this embodiment. A left side view of the fixing member 960 is represented symmetrically with a right side view in FIG. 48C. The fixing member 960 has a shaft portion 961, a pair of elastic pieces 962, a distal-end-side projection portion 963, a proximal-end-side projection portion 964, an additional portion 965, a seat portion 966, and an operation portion 967. The shaft portion 961 is formed such that a width thereof in a direction perpendicular to an operating direction is slightly wider than that of the shaft portion 2 of the first embodiment. In the shaft portion 961, recesses 961a, 961b, and 961c for thinning are formed. The shaft portion 961 is formed in the same manner as the shaft portion 2 of the first embodiment, except that the shaft portion 961 is formed wider and the recesses 961a, 961b, and 961c are formed.

The elastic pieces 962, the distal-end-side projection portion 963, the proximal-end-side projection portion 964, the additional portion 965, the seat portion 966, and the operation portion 967 are formed in the same shapes as the distal-end-side projection portion 10, the proximal-end-side projection portion 11, the additional portion 12, the seat portion 4, and the operation portion 5 of the first embodiment, and have the same functions as the distal-end-side projection portion 10, the proximal-end-side projection portion 11, the additional portion 12, the seat portion 4, and the operation portion 5. A base (not shown) to which the fixing member 960 is assembled and a fixing target member (not shown) which is assembled to the base may be formed in the same manner as the base 200 and the fixing target member 300 of the first embodiment.

According to this embodiment, the same effects as those of the first embodiment are obtained, and the fixing member 960 and the fixing target member (not shown) can be more firmly engaged with each other since the shaft portion 961 is formed wider. In addition, an increase in the weight of the fixing member 960 can be suppressed by the recesses 961a, 961b, and 961c for thinning.

(Modification of Crisp Feeling-Giving Structure)

In the above sixth embodiment, the example in which a crisp feeling is given when the fixing member 910 is operated is shown, but a crisp feeling may be given by a structure other than the structure shown in the sixth embodiment. Hereinafter, various modifications of the crisp feeling-giving structure will be described. In the following description, the same members as those of the above embodiments are denoted by the same reference characters.

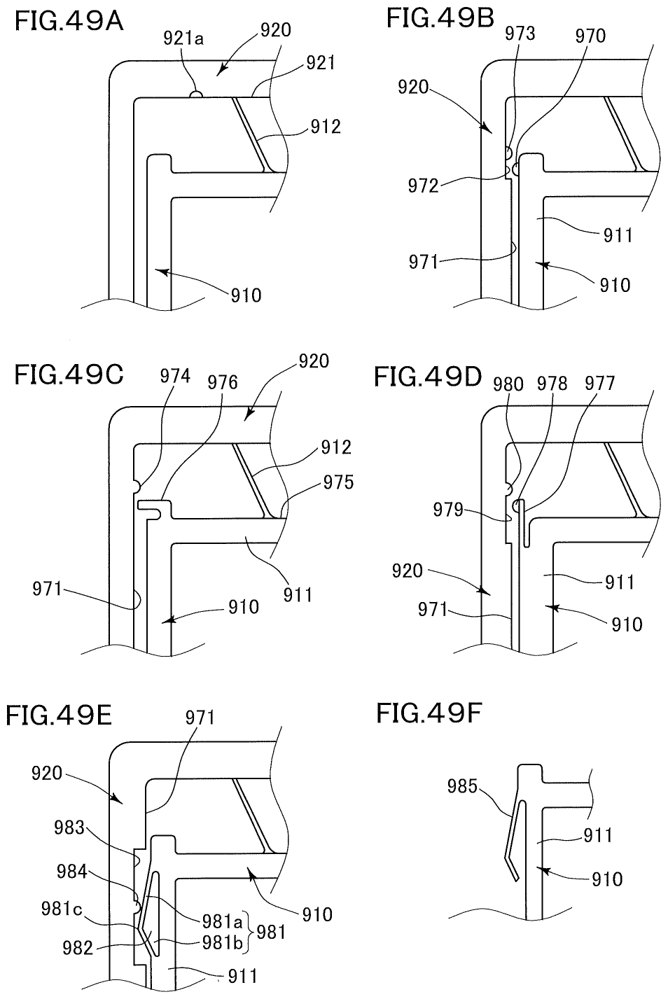

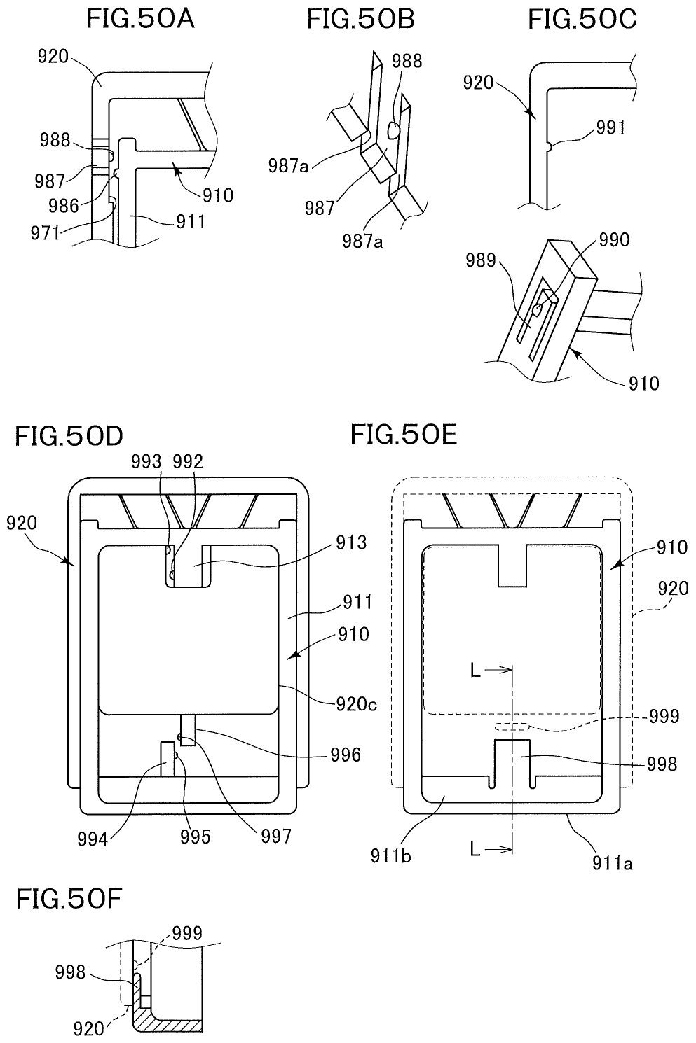

FIG. 49 to FIG. 52 and FIG. 59 show modifications of the sixth embodiment. In the example of FIG. 49A, a groove 921a (recess) is formed on the surface 921 of the base 920 with which the distal end of each elastic piece 912 of the fixing member 910 comes into contact. The groove 921a is provided on a movement path of the distal end of the elastic piece 912. When the fixing member 910 is operated, the distal end of the elastic piece 912 enters the groove 921a, and then exits from the groove 921a, thereby generating a crisp feeling and sound due to a load fall. In this case, the groove 921a serves as a gone-over portion over which the elastic piece 912 is caused to go.

In the example of FIG. 49B, a projection 970 is formed on a surface, of the body portion 911 of the fixing member 910, facing an inner surface 971 of the recess-like space on the back side of the base 920. The projection 970 is formed on the left side portion or the right side portion of the body portion 911. The projection 970 projects in a direction perpendicular to both the operating direction of the fixing member 910 and the attachment/detachment direction of the fixing target member (not shown) (in the leftward direction in the drawing sheet of FIG. 49B). A recess 972 is formed partially on the inner surface 971, of the base 920, facing the left side portion or the right side portion of the body portion 911. A projection 973 is formed in the recess 972. The projection 970 of the fixing member 910 is located at the recess 972, and moves in the operating direction of the fixing member 910 when the fixing member 910 is operated. The projection 973 of the base 920 is located on a movement path of the projection 970 of the fixing member 910. When the fixing member 910 is operated, the projection 970 interferes with and goes over the projection 973. When the projection 970 goes over the projection 973, a crisp feeling and sound can be generated. Since the projection 973 is formed in the recess 972, the gap between the inner surface 971 of the base 920 and the left side portion or the right side portion of the body portion 911 can be decreased.

In the example of FIG. 49C, a projection 974 is formed on the inner surface 971, of the base 920, facing the left side portion or the right side portion of the fixing member 910. The body portion 911 of the fixing member 910 has an extension portion 976 which extends from a surface 975 other than the surface facing the inner surface 971 of the base 920 toward the inner surface 971. The surface 975 is, for example, the surface on which the elastic pieces 912 are formed. The projection 974 is provided on a path on which the distal end of the extension portion 976 moves during operation. When the fixing member 910 is operated, the distal end of the extension portion 976 interferes with and goes over the projection 974. When the distal end of the extension portion 976 goes over the projection 974, a crisp feeling and sound can be generated. Since the extension portion 976 extends from the surface 975 other than the surface facing the inner surface 971, the gap between the inner surface 971 and the left side portion or the right side portion of the body portion 911 can be decreased. The extension portion 976 may be formed such that the extension portion 976 bends when interfering with the projection 974.

In the example of FIG. 49D, the fixing member 910 has an extension portion 977 which extends from the body portion 911 in a direction parallel to the operating direction of the fixing member 910. The extension portion 977 extends from an end portion, in the direction parallel to the operating direction, of the left side portion or the right side portion of the body portion 911. The extension portion 977 is formed in a cantilevered shape in which a proximal end thereof is supported by the body portion 911 and a distal end thereof is a free end. The extension portion 977 is formed so as to be flexurally deformable in a direction in which the extension portion 977 faces the inner surface 971 of the base 920 (the right-left direction in the drawing sheet of FIG. 49D). The extension portion 977 has a projection 978 which projects toward the inner surface 971.

A recess 979 is formed partially on the inner surface 971. A projection 980 is formed in the recess 979. The projection 978 of the fixing member 910 is located at the recess 979. The projection 980 of the base 920 is located on a movement path of the projection 978 of the fixing member 910. When the fixing member 910 is operated, the projection 978 interferes with and goes over the projection 980. In this case, the extension portion 977 bends. When the projection 978 goes over the projection 980, a crisp feeling and sound can be generated. Since the projection 978 is formed on the flexurally deformable extension portion 977, it is easier for the projection 978 and the projection 980 to go over each other.

In the example of FIG. 49E, the fixing member 910 has a flexural deformation portion 981. The flexural deformation portion 981 is formed on the left side portion or the right side portion of the body portion 911, and both ends thereof in the direction parallel to the operating direction of the fixing member 910 (in the up-down direction in the drawing sheet of FIG. 49E) are supported by the body portion 911. The flexural deformation portion 981 is formed so as to be raised toward the inner surface 971 of the base 920. Specifically, the flexural deformation portion 981 includes a first portion 981a which gradually approaches the inner surface 971 side as advancing in the direction opposite to the operating direction (downward in the drawing sheet of FIG. 49E), and a second portion 981b which gradually becomes farther away from the inner surface 971 as advancing in the direction opposite to the operating direction. A space 982 is formed on the side, of the flexural deformation portion 981, which does not face the inner surface 971. The first portion 981a and the second portion 981b are formed so as to be flexurally deformable in the rightward direction in the drawing sheet of FIG. 49E (toward the space 982 side).

A recess 983 is formed partially on the inner surface 971 of the base 920. A projection 984 is formed in the recess 983. Atop portion 981c (a boundary portion between the first portion 981a and the second portion 981b) of the flexural deformation portion 981 is located in the recess 983. The projection 984 is located on a movement path of the top portion 981c. When the fixing member 910 is operated, the first portion 981a interferes with the projection 984. At this time, the top portion 981c goes over the projection 984 while the first portion 981a is bending. When the top portion 981c goes over the projection 984, a crisp feeling and sound can be generated. Then, when the operation of the fixing member 910 is released, the fixing member 910 moves to return to the original position by the elastic repulsive force of each elastic piece 912. During the return movement, the second portion 981b interferes with the projection 984, whereby the second portion 981b bends, and the top portion 981c goes over the projection 984.

A portion corresponding to the flexural deformation portion 981 may be formed on the base 920 side, and portions corresponding to the recess 983 and the projection 984 may be formed on the fixing member 910 side.

In the example of FIG. 49F, the fixing member 910 has a flexural deformation portion 985. The flexural deformation portion 985 is formed in a cantilevered shape in which one end thereof in the direction parallel to the operating direction of the fixing member 910 is supported by the body portion 911 and another end thereof is a free end. The flexural deformation portion 985 is the same as the flexural deformation portion 981 in FIG. 49E, except that the flexural deformation portion 985 is formed in a cantilevered shape. In FIG. 49F, a base is not shown, but is formed in the same manner as the base 920 in FIG. 49E. According to this, the same effects as those in FIG. 49E are obtained.

In the example of FIG. 50A and FIG. 50B, the fixing member 910 has a projection 986. The projection 986 is formed so as to project from the left side portion or the right side portion of the body portion 911 toward the inner surface 971 of the base 920. The base 920 has a flexural deformation portion 987 in the inner surface 971. As shown in FIG. 50B, the flexural deformation portion 987 is formed in a cantilevered shape in which one end thereof is supported and another end thereof is a free end. Slits 987a are formed on both sides of the flexural deformation portion 987 in a direction perpendicular to the direction from the proximal end to the distal end of the flexural deformation portion 987. The flexural deformation portion 987 is formed so as to be flexurally deformable in the leftward direction in FIG. 50A (direction perpendicular to both the operating direction of the fixing member 910 and the attachment/detachment direction of the fixing target member). A projection 988 is formed on the flexural deformation portion 987. The projection 988 is located on a movement path of the projection 986 of the fixing member 910. When the fixing member 910 is operated, the projection 986 interferes with and goes over the projection 988. At this time, the flexural deformation portion 987 bends. When the projection 986 goes over the projection 988, a crisp feeling and sound can be generated.

As shown in FIG. 50C, a flexural deformation portion 989 and a projection 990 corresponding to the flexural deformation portion 987 and the projection 988 in FIG. 50A and FIG. 50B may be formed on the fixing member 910 side, and a projection 991 corresponding to the projection 986 in FIG. 50A may be formed on the base 920 side.

Furthermore, the above-described structures in FIG. 49B to FIG. 50C may be formed at portions other than those shown in FIG. 49B to FIG. 50C. Specifically, for example, as shown in FIG. 50D, a going-over portion 992 similar to those in FIG. 49B to FIG. 50C may be provided on the projecting portion 913 (portion that prevents the fixing target member from being pulled out from the base 920) of the fixing member 910, and a gone-over portion 993 similar to those in FIG. 49B to FIG. 50C over which the going-over portion 992 is caused to go may be provided on a portion, of the base 920, facing the projecting portion 913.

As shown in FIG. 50D, the fixing member 910 may have a projecting portion 994 which projects into the inner space of the fixing member 910, and a going-over portion 995 formed on the projecting portion 994 and having the same shape as those in FIG. 49B to FIG. 50C. The projecting portion 994 is provided separately from the projecting portion 913 for preventing the fixing target member from being pulled out from the base 920. FIG. 50D shows an example in which the projecting portion 994 projects from a portion of the body portion 911 on the side opposite to the side where the projecting portion 913 is provided, in a direction opposite to the projecting direction of the projecting portion 913. The base 920 may have a projecting portion 996 which projects from a portion 920c fitted into the inner space of the fixing member 910, and a gone-over portion 997 formed on the projecting portion 996 and having the same shape as those in FIG. 49B to FIG. 50C.

Furthermore, the crisp feeling-giving structure may be configured as shown in FIG. 50E and FIG. 50F. In the example of FIG. 50E and FIG. 50F, the fixing member 910 has a flexural deformation portion 998. The flexural deformation portion 998 is provided on the wall portion 911b which rises from the operation portion 911a. Specifically, the flexural deformation portion 998 is formed in a shape in which the flexural deformation portion 998 projects from the wall portion 911b in the operating direction of the fixing member 910 (upward direction in the drawing sheet of FIG. 50E). The flexural deformation portion 998 is formed in the same shape as the second projecting portion 69 (see FIG. 20) of the third embodiment, that is, in a thin plate shape in which the flexural deformation portion 998 is flexurally deformable in the attachment/detachment direction of the fixing target member (not shown) (the direction perpendicular to the drawing sheet of FIG. 50E, the right-left direction in the drawing sheet of FIG. 50F).

The base 920 has a projection 999 over which the flexural deformation portion 998 is caused to go when the fixing member 910 is operated. During operation, the flexural deformation portion 998 interferes with the projection 999, thus becomes flexurally deformed, and goes onto the projection 999. By the interference between the flexural deformation portion 998 and the projection 999, a crisp feeling and sound can be generated.

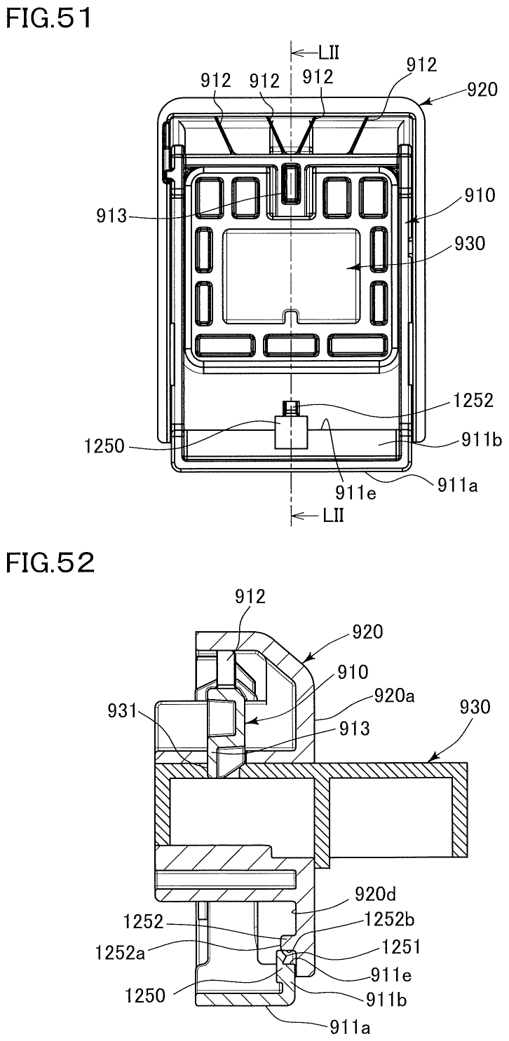

The crisp feeling-giving structure may be configured as shown in FIG. 51 and FIG. 52. In the example of FIG. 51 and FIG. 52, the fixing member 910 has a projecting piece 1250 on the operation portion a side in a direction parallel to the operating direction of the operation portion 911a (in the up-down direction in FIG. 51 and FIG. 52). The projecting piece 1250 is provided on the wall portion 911b which rises from the operation portion 911a. Specifically, the projecting piece 1250 is formed in a projection shape from the back surface of the wall portion 911b in the direction perpendicular to the operating direction of the operation portion 911a (in the leftward direction in the drawing sheet of FIG. 52). Furthermore, the projecting piece 1250 is formed in a shape projecting on the operating direction side with respect to a distal end 911e of the wall portion 911b.

The projecting piece 1250 has a projection 1251. The projection 1251 is formed on an opposing surface, of the projecting piece 1250, opposing a back surface 920d (surface on the side opposite to the front surface 920a) of the base 920. The projecting piece 1250 may be formed so as to be flexurally deformable in the direction perpendicular to the operating direction (in the leftward direction in the drawing sheet of FIG. 52).

The base 920 has a projection portion 1252 on the back surface 920d. The projection portion 1252 has an interval between the projection portion 1252 and the wall portion 911b of the fixing member 910 in the direction parallel to the operating direction in a state where the operation portion 911a is not operated (state in FIG. 51 and FIG. 52). The projection portion 1252 is located on a movement path of the projection 1251 which moves when the operation portion 911a is operated.

When the operation portion 911a is operated, the projection 1251 interferes with the projection portion 1252 and goes over or onto a distal end 1252a of the projection portion 1252. At this time, a crisp feeling and sound can be generated. In addition, when the operation of the operation portion 911a is advanced, the distal end 911e of the wall portion 911b and a side surface 1252b of the projection portion 1252 interfere with each other. Accordingly, excessive movement of the fixing member 910 is prevented, and excessive deformation of each elastic piece 912 is prevented. In addition, when the distal end 911e and the projection portion 1252 interfere with each other, the projecting portion 913 of the fixing member 910 is detached from the hole 931 of the fixing target member 930, so that the fixing target member 930 can be pulled out from the base 920. The projection portion 1252 serves as a gone-over portion or a gone-onto portion over or onto which the projection 1251 is caused to go, and also serves as an excessive movement prevention portion that prevents excessive movement of the fixing member 910 during operation.

The crisp feeling-giving structure may be configured as shown in FIG. 59. In the example of FIG. 59, the fixing member 910 includes an elastic piece 1254 as a flexural deformation portion in addition to the above-described elastic pieces 912. The elastic piece 1254 is formed in a cantilevered shape in which one end thereof is supported by a portion 1253 of the fixing member 910 and another end thereof is a free end. The portion 1253 which supports the elastic piece 1254 is provided on the wall portion 911b which rises from the operation portion 911a. Specifically, the portion 1253 is provided so as to project from the center in the right-left direction (right-left direction in the drawing sheet of FIG. 59A) of the wall portion 911b toward the back side of the fixing member 910.

The elastic piece 1254 extends straight from the proximal end toward the distal end thereof. The distal end (free end) of the elastic piece 1254 is located on the upper side (operating direction side) with respect to the proximal end thereof, and is located on the side in the direction perpendicular to the operating direction (right side in the example of FIG. 59B and FIG. 59C) with respect to the proximal end thereof. As described above, the direction from the proximal end to the distal end of the elastic piece 1254 is oblique to the operating direction of the fixing member 910.

The distal end of the elastic piece 1254 is in contact with a portion 1255a (see FIG. 59C) of the base 920. The distal end of the elastic piece 1254 slides on the portion 1255a (sliding surface) of the base 920 when the fixing member 910 is operated and when the operation of the fixing member 910 is released. The movement direction (sliding direction) of the distal end of the elastic piece 1254 is a direction (up-down direction in FIG. 59) parallel to the operating direction. The elastic piece 1254 is formed so as to be flexurally deformable in the direction perpendicular to the operating direction (in the leftward direction in the drawing sheets of FIG. 59B and FIG. 59C).

The base 920 has the sliding surface 1255a on which the distal end of the elastic piece 1254 is caused to slide when the fixing member 910 is operated. The sliding surface 1255a is formed as a surface parallel to the operating direction of the fixing member 910. The base 920 has a projection portion 1255 on the back surface 920d. The projection portion 1255 is provided so as to project from the center in the right-left direction (right-left direction in the drawing sheet of FIG. 59A) of the base 920 toward the back side of the base 920. The sliding surface 1255a is an end surface, in the projecting direction from the back surface 920d, of the projection portion 1255.

The base 920 has a projection 1256 on the sliding surface 1255a (see FIG. 59C). The projection 1256 is provided on a movement path of the distal end of the elastic piece 1254. The projection 1256 is formed in a mountain shape when viewed in a cross-section in FIG. 59C. Specifically, the projection 1256 has a first inclined portion 1256a which is gradually displaced in a direction that is a direction perpendicular to the sliding surface 1255a and away from the sliding surface 1255a (leftward direction in the drawing sheet of FIG. 59C), as advancing toward the operating direction of the fixing member 910 (upward direction in the drawing sheet of FIG. 59C). The projection 1256 has a second inclined portion 1256c which is gradually displaced in a direction that is a direction perpendicular to the sliding surface 1255a and approaching the sliding surface 1255a (rightward direction in the drawing sheet of FIG. 59C), as advancing from a top portion 1256b, which is an end portion of the first inclined portion 1256a, toward the operating direction of the fixing member 910 (upward direction in the drawing sheet of FIG. 59C).

When the operation portion 911a is operated, the distal end of the elastic piece 1254 interferes with the first inclined portion 1256a of the projection 1256. At that interference, the elastic piece 1254 bends leftward in FIG. 59C. Then, the distal end of the elastic piece 1254 goes over the top portion 1256b of the projection 1256. When the distal end of the elastic piece 1254 goes over the top portion 1256b, a crisp feeling and sound can be generated. In addition, when the operation of the operation portion 911a is advanced, the distal end 911e (see FIG. 59C) of the wall portion 911b and a side surface 1255b (see FIG. 59C) of the projection portion 1255 interfere with each other. Accordingly, excessive movement of the fixing member 910 is prevented, and excessive deformation of each elastic piece 912 is prevented.

Then, when the operation of the operation portion 911a is released, the distal end of the elastic piece 1254 interferes with the projection 1256 from the second inclined portion 1256c side and goes over the projection 1256. A groove may be formed on the sliding surface 1255a instead of the projection 1256.

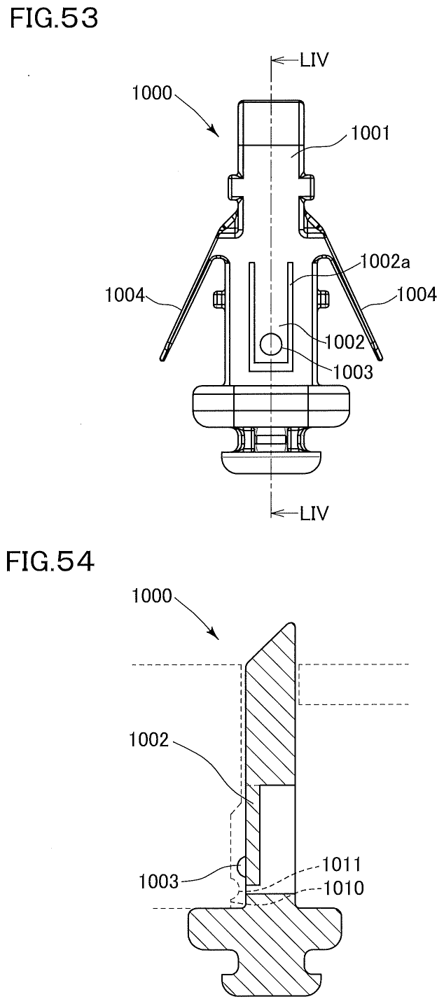

A fixing structure including a pull-operated type fixing member similar to the fixing member 1 or 960 of the first embodiment or the seventh embodiment may be provided with a crisp feeling-giving structure. For example, as shown in FIG. 53 and FIG. 54, a fixing member 1000 has a flexural deformation portion 1002 in addition to elastic pieces 1004 which return to the original positions when the operation of the fixing member 1000 is released. The flexural deformation portion 1002 is formed in a cantilevered shape on a shaft portion 1001. A slit 1002a is formed around the flexural deformation portion 1002. The flexural deformation portion 1002 is formed so as to be flexurally deformable in a direction perpendicular to the operating direction of the fixing member 1000 (in the right-left direction in the drawing sheet of FIG. 54). A projection 1003 is formed on the flexural deformation portion 1002. The fixing member 1000 is formed in the same manner as the fixing members 1 and 960 of the first and seventh embodiments except for the above. A projection 1011 is formed on a counterpart member 1010 to which the fixing member 1000 is assembled. When the fixing member 1000 is operated, the projection 1003 interferes with the projection 1011, whereby the flexural deformation portion 1002 bends, and the projection 1003 goes over the projection 1011. When the projection 1003 goes over the projection 1011, a crisp feeling and sound can be generated.

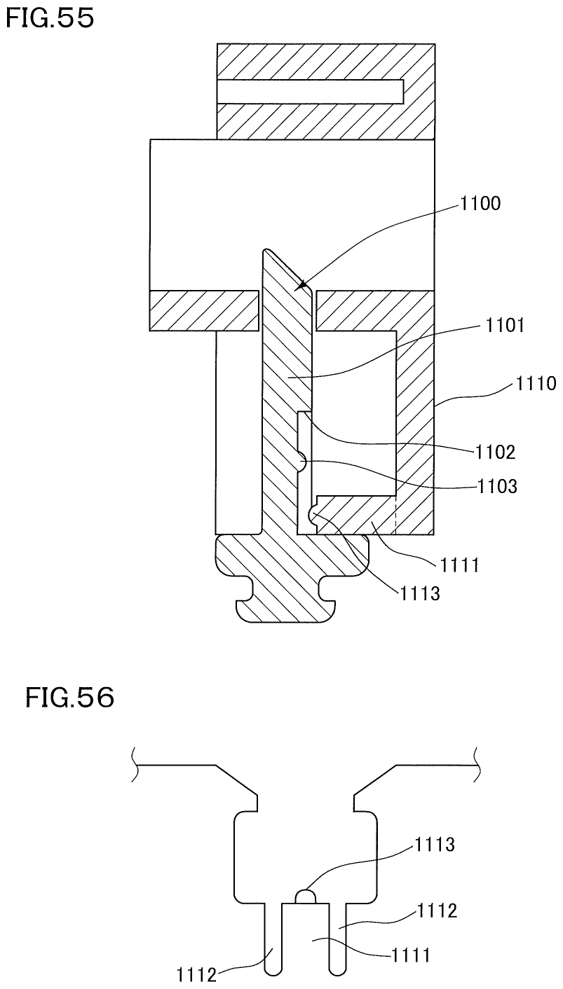

The crisp feeling-giving structure may be configured as shown in FIG. 55 and FIG. 56. In the example of FIG. 55 and FIG. 56, a recess 1002 is formed on a shaft portion 1101 of a fixing member 1100. The fixing member 1100 has a projection 1103 in the recess 1002. The fixing member 1100 is formed in the same manner as the fixing members 1 and 960 of the first and seventh embodiments except for the above. A counterpart member 1110 to which the fixing member 1100 is assembled has a flexural deformation portion 1111. A slit 1112 is formed around the flexural deformation portion 1111. Accordingly, the flexural deformation portion 1111 is flexurally deformable in a direction parallel to the operating direction of the fixing member 1100 (in the up-down direction in the drawing sheet of FIG. 55, in a direction perpendicular to the drawing sheet of FIG. 56). A projection 1113 is formed at the distal end of the flexural deformation portion 1111. When the fixing member 1100 is operated, the projection 1103 interferes with the projection 1113, whereby the flexural deformation portion 1111 bends, and the projection 1103 goes over the projection 1113. When the projection 1103 goes over the projection 1113, a crisp feeling and sound can be generated.

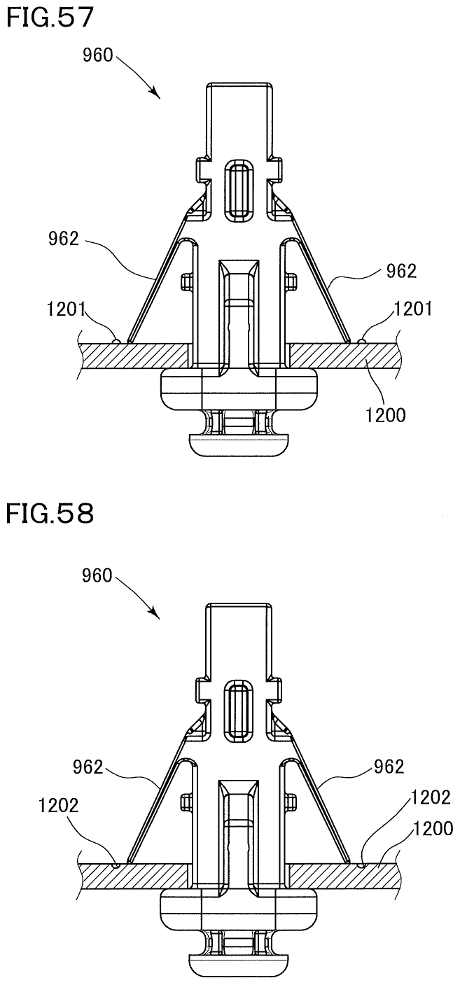

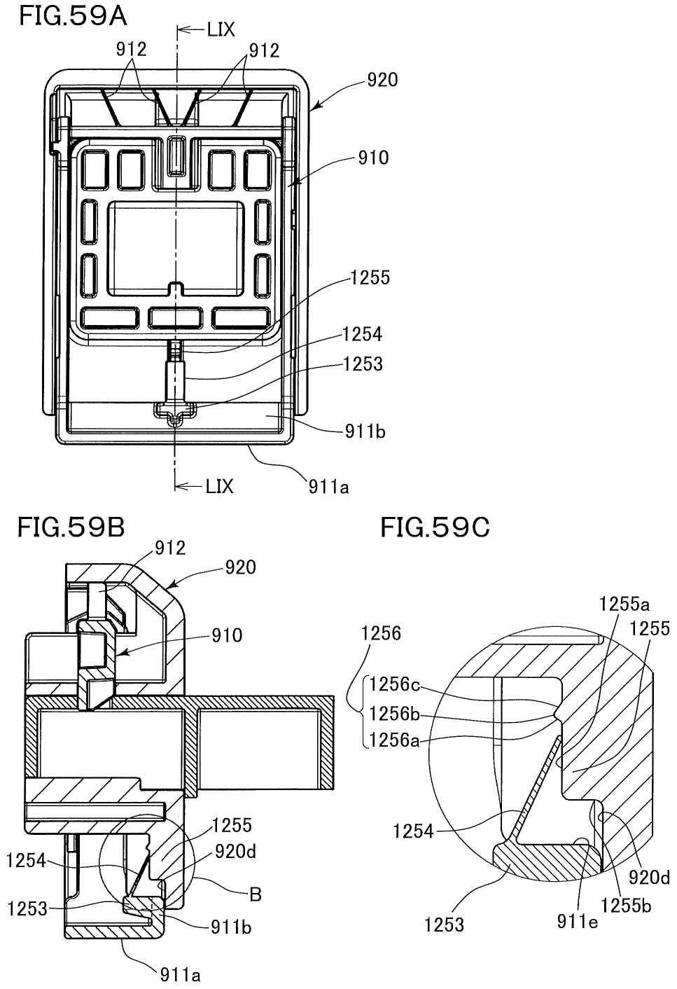

Furthermore, a crisp feeling-giving structure may be configured as shown in FIG. 57 and FIG. 58. A fixing member 960 in each of FIG. 57 and FIG. 58 is the same as the fixing member 960 of the seventh embodiment. In the example of FIG. 57 or FIG. 58, projections 1201 or grooves 1202 are formed on a surface, on which the distal ends of the elastic pieces 962 come into contact, of a counterpart member 1200 to which the fixing member 960 is assembled. When the fixing member 960 is operated, the distal ends of the elastic pieces 962 interfere with and go over the projections 1201 or the grooves 1202. When the distal ends of the elastic pieces 962 go over the projections 1201 or the grooves 1202, a crisp feeling and sound can be generated.

This disclosure is not limited to the above embodiments and may be modified variously. For example, in the above first embodiment, the fixing member including both the seat portion and the distal-end-side projection portion as the advance pull-out prevention portion is exemplified, but a fixing member not including either one of a seat portion and a distal-end-side projection portion may be adopted. In this case, a fixing member not including a seat portion may be adopted.

In the above embodiments, the hook member is exemplified as the fixing target member, but any type may be used as the fixing target member. For example, a leg of a table, a chair, or the like may be used as the fixing target member. According to this, the table, the chair, or the like can be detachably fixed.

In the above embodiments, the stabilizer-shaped elastic deformation portion is exemplified, but the elastic deformation portion may have any shape as long as the elastic deformation portion can be molded integrally with the fixing member or the assembly counterpart member.

In each of the above first to seventh embodiments, the example in which two or four elastic deformation portions (elastic pieces) are provided to the fixing member or the counterpart member to which the fixing member is assembled, is shown. However, the number of elastic deformation portions may be one, three, or five or more.

As shown in the sixth embodiment and FIG. 49 to FIG. 59, the fixing member may include an interference portion that interferes with a portion of the assembly counterpart member (base or fixing target member) to which the fixing member is assembled, and goes over or onto the portion when the operation portion is operated. The assembly counterpart member may include an interference target portion with which the interference portion of the fixing member is caused to interfere to go thereover or thereonto when the fixing member is operated. In this case, the interference portion and the interference target portion may each have a projection shape (projection) or a recess shape (groove), or may each be a flexural deformation portion. In addition, in the case where the interference portion or the interference target portion is formed in a projection shape (as a projection), the projection shape may be formed on the flexural deformation portion.

### DESCRIPTION OF THE REFERENCE CHARACTERS

1, 20, 60, 80, 90, 910, 960, 1000, 1100 fixing member
3, 23, 68, 87, 853, 912, 962, 1004 elastic piece (elastic deformation portion)
9, 22 distal end portion (prevention portion) of shaft portion
67, 88, 93, 913 first projecting portion (prevention portion)
5, 25, 64a, 83a, 94a, 911a, 967 operation portion
100, 150, 400, 700, 800, 900 fixing structure
200, 220, 500, 750, 850, 920 base
207, 322, 502, 751, 851, 926 fitting hole
300, 310, 320, 600, 930 fixing target member
302, 222, 602 portion which is fitted into fitting hole
303, 223, 603, 931 mounting hole (recess) into which prevention portion is fitted

What is claimed is:

1. A fixing structure comprising:
a base;
a fixing target member fitted to the base; and
a fixing member, wherein
one of the base and the fixing target member has a fitting hole, and another of the base and the fixing target member has a portion fitted into the fitting hole,
the one, of the base and the fixing target member, having the fitting hole is defined as an assembly counterpart member, and the fixing member is assembled to the assembly counterpart member,
the fixing member includes
a prevention portion configured to project into the fitting hole in a fitting perpendicular direction which is a direction perpendicular to a fitting direction of the base and the fixing target member, to prevent the fixing target member from being pulled out from the base, and
an operation portion which is formed integrally with the prevention portion and on which an operation of moving the prevention portion from a projection position at which the prevention portion projects into the fitting hole to a withdrawn position at which the prevention portion is withdrawn from the fitting hole is performed, an operating direction of the operation being defined as the fitting perpendicular direction,
the other, of the base and the fixing target member, which is not the assembly counterpart member has a recess into which the prevention portion at the projection position is fitted, and
the fixing structure comprises an elastic deformation portion formed integrally with the fixing member or the assembly counterpart member, and configured to become elastically deformed so as to permit movement of the fixing member to the withdrawn position when the operation is performed, and to return the fixing member to the projection position by a repulsive force of the elastic deformation of the elastic deformation portion when the operation is released.

2. The fixing structure according to claim 1, wherein
the elastic deformation portion is an elastic piece having one end connected to the fixing member or the assembly counterpart member and having another end as a free end,
the free end is provided so as to come into contact with a portion of the assembly counterpart member or a portion of the fixing member,
the elastic piece is provided such that a direction from the one end to the other end thereof is oblique to the operating direction, and
when the operation is performed, the elastic piece becomes elastically deformed while causing the free end to slide on a surface of the portion of the assembly counterpart member or the portion of the fixing member in a direction perpendicular to the operating direction.

3. The fixing structure according to claim 1, wherein
the fixing member has a shaft portion extending along the operating direction,
the prevention portion is provided at one end in an axial direction of the shaft portion, and the operation portion is provided at another end in the axial direction of the shaft portion, and
the operating direction is defined as a direction in which the operation portion is pulled.

4. The fixing structure according to claim 3, wherein
the elastic deformation portion is an elastic piece having one end connected to the shaft portion at a position between the prevention portion and the operation portion and having another end as a free end,
the free end is provided so as to come into contact with a portion of the assembly counterpart member, and
the elastic piece is provided so as to gradually become farther away from the shaft portion as advancing toward the operating direction, and becomes elastically deformed such that an interval between the free end and the shaft portion increases, while causing the free end to slide on a surface of the portion of the assembly counterpart member, when the operation is performed.

5. The fixing structure according to claim 4, wherein the shaft portion has a projection portion configured to prevent further movement of the shaft portion in the operating direction from the withdrawn position, at a position between the one end and the free end of the elastic piece in a state where the elastic piece is not elastically deformed among positions along the axial direction.

6. The fixing structure according to claim 3, wherein
the shaft portion has, on a distal end side thereof, a distal-end-side projection portion projecting laterally,
the prevention portion is provided on the distal end side with respect to the distal-end-side projection portion of the shaft portion,
a hole into which the distal end side with respect to the distal-end-side projection portion of the shaft portion is fitted is formed in the assembly counterpart member, and
the hole is formed such that the distal end side with respect to the distal-end-side projection portion of the shaft portion can be inserted into the hole in a direction oblique to the fitting perpendicular direction and the distal-end-side projection portion cannot be inserted into the hole.

7. The fixing structure according to claim 1, wherein
the fixing member has a body portion forming a cavity between the prevention portion and the operation portion,
the prevention portion projects from the body portion toward the cavity side,
the fixing member is assembled to the assembly counterpart member such that a hole-forming portion, forming the fitting hole, of the assembly counterpart member is fitted into the cavity, and
the operating direction is defined as a direction in which the operation portion is pushed.

8. The fixing structure according to claim 7, wherein the elastic deformation portion is provided so as to project from a portion of the body portion on the same side as the prevention portion when viewed from the cavity, toward a side opposite to the cavity, or is provided so as to project from a portion of the body portion on the same side as the operation portion when viewed from the cavity, toward the cavity side.

9. The fixing structure according to claim 7, wherein the fixing member and the assembly counterpart member include interference portions configured to interfere with each other so as to prevent excessive movement of the fixing member during operation.

10. The fixing structure according to claim 1, wherein
the prevention portion is provided at a section in a circumferential direction around a projecting direction of the prevention portion into the fitting hole, and
the fixing member includes
an insertion permission portion configured to generate a force which moves the fixing member to the withdrawn position, as the fixing target member or the base is inserted into the fitting hole, on a side opposite to the prevention portion in the circumferential direction, and
a reverse assembly prevention portion configured to permit the fixing member to be assembled to the base so as to be directed in a forward direction in which functions of the prevention portion and the insertion permission portion are enabled, and to prevent the fixing member from being assembled to the base so as to be directed in a wrong direction opposite to the forward direction.

11. The fixing structure according to claim 1, wherein the fixing member and the assembly counterpart member include guide portions configured to guide movement of the fixing member when the fixing member is assembled so as to be rotated in the fitting perpendicular direction while being inserted into the assembly counterpart member in a direction oblique to the fitting perpendicular direction.

12. A fixing member for fixing a fixing target member to a base, wherein
one of the base and the fixing target member has a fitting hole, and another of the base and the fixing target member has a portion fitted into the fitting hole,
the one, of the base and the fixing target member, having the fitting hole is defined as an assembly counterpart member, and the fixing member is assembled to the assembly counterpart member, and
the fixing member comprises
a prevention portion configured to project into the fitting hole in a fitting perpendicular direction which is a direction perpendicular to a fitting direction of the base and the fixing target member, and be fitted into a recess formed on the other, of the base and the fixing target member, which is not the assembly counterpart member, to prevent the fixing target member from being pulled out from the base,
an operation portion which is formed integrally with the prevention portion and on which an operation of moving the prevention portion from a projection position at which the prevention portion projects into the fitting hole to a withdrawn position at which the prevention portion is withdrawn from the fitting hole is performed, an operating direction of the operation being defined as the fitting perpendicular direction, and
an elastic deformation portion formed integrally with the prevention portion and the operation portion, and configured to become elastically deformed so as to permit movement of the prevention portion to the withdrawn position when the operation is performed, and to return the prevention portion to the projection position by a repulsive force of the elastic deformation of the elastic deformation portion when the operation is released.

13. A method for assembling the fixing member to the assembly counterpart member in the fixing structure according to claim 6, the method comprising:
a positioning step of positioning the distal-end-side projection portion of the shaft portion at a portion surrounding the hole of the assembly counterpart member, while inserting the distal end side with respect to the distal-end-side projection portion of the shaft portion into the hole in a direction oblique to the fitting perpendicular direction; and
a rotation step of rotating the fixing member such that the axial direction of the shaft portion is the same as the fitting perpendicular direction, in a state where the distal-end-side projection portion is positioned at the portion surrounding the hole.

14. A method for assembling the fixing member to the assembly counterpart member in the fixing structure according to claim 7, wherein
the assembly counterpart member has an engagement projection configured to engage the fixing member in an assembled state to prevent the fixing member from being detached from the assembly counterpart member,
a recess is formed on the body portion, and
the method comprises
assembling the fixing member so as to rotate the fixing member in the fitting perpendicular direction while inserting the fixing member into the assembly counterpart member in a direction oblique to the fitting perpendicular direction, and fitting the engagement projection into the recess of the body portion during the rotation to cause the recess and the engagement projection to guide the rotation.
